(19) United States
(12) Patent Application Publication
(10) Pub. No.: US 2025/0278731 A1
(43) Pub. Date: Sep. 4, 2025

(54) PROCESSING TRANSACTION DATA USING ARTIFICIAL INTELLIGENCE

(71) Applicant: Block, Inc., Oakland, CA (US)

(72) Inventors: Victor Lei, Boston, MA (US); Alexander Gude, Concord, CA (US)

(21) Appl. No.: 18/592,275

(22) Filed: Feb. 29, 2024

(51) Int. Cl. G06Q 20/40; G06Q 20/02; G06Q 20/34

(52) U.S. Cl. CPC G06Q 20/4014; G06Q 20/023; G06Q 20/34

(57) ABSTRACT

Processing transaction data using artificial intelligence (AI) is described. A payment service computing platform may receive transaction data associated with users of a payment application, wherein the transaction data is received in a computer-readable format, and the payment service computing platform may provide a prompt to a trained AI model, wherein the prompt includes a portion of the transaction data that represents a transaction associated with a user of the users. The payment service computing platform may determine, based at least in part on the trained AI model processing the prompt, one or more attributes of the transaction, and cause information indicative of the one or more attributes to be presented via the payment application executing on a user device of the user, wherein the information is presented (i) in a graphical user interface and (ii) in a user-readable format instead of the computer-readable format.

### TECHNICAL FIELD

Applications, which are downloadable and executable on user devices, enable users to interact with other users. Such applications are provided by service providers and utilize one or more network connections to transmit data among and between user devices to facilitate such interactions. Such data may include transaction data that is formatted in a computer-readable format.

### BRIEF DESCRIPTION OF THE DRAWINGS

Features of the present disclosure, its nature and various advantages, will be more apparent upon consideration of the following detailed description, taken in conjunction with the accompanying drawings.

FIG. 1 is an example environment for processing transaction data using artificial intelligence (AI), according to an implementation of the present subject matter.

FIG. 2A is an example user interface of a payment application, the user interface presenting information associated with a transaction in a computer-readable format.

FIG. 2B is an example user interface of a payment application, the user interface associated with a statement or a receipt and presenting information associated with the transaction in a user-readable format, according to an implementation of the present subject matter.

FIG. 3 is an example user interface of a payment application, the user interface associated with an activity feed and presenting information associated with transactions in a user-readable format, according to an implementation of the present subject matter.

FIG. 4 is an example diagram illustrating an example prompt that may be provided to a trained AI model(s) to determine an entity associated with a transaction, and example output generated by the trained AI model(s) based on the prompt, according to an implementation of the present subject matter.

FIG. 5 is an example of validating output generated by a trained AI model(s), according to an implementation of the present subject matter.

FIG. 6 is an example process for presenting information indicative of one or more attributes of a transaction in a user-readable format, according to an implementation of the present subject matter.

FIG. 7 is an example process for processing transaction data based at least in part on validating AI output as part of a multi-stage filtering approach, according to an implementation of the present subject matter.

FIG. 8 is an example process for using AI to detect potentially fraudulent transactions and/or transactions that are noncompliant with terms of use of a payment application, according to an implementation of the present subject matter.

FIG. 9 is an example process for implementing an in-app dynamic checkout experience for a user of a payment application, according to an implementation of the present subject matter.

FIG. 10 is an example environment for performing techniques described herein.

FIG. 11 is an example environment for performing techniques described herein.

FIG. 12 is an example data store used for performing techniques described herein.

In the figures, the left-most digit(s) of a reference number identifies the figure in which the reference number first appears. The use of the same reference numbers in different figures indicates similar or identical items or features. The drawings are not to scale.

### DETAILED DESCRIPTION

Described herein are, among other things, techniques, devices, and systems for processing transaction data using AI. For example, a computing platform associated with a payment service (hereinafter, a “payment service computing platform”) may receive transaction data associated with users of a payment application. At least some of the transaction data may be received from external networks and/or systems, such as the automated clearing house (ACH) network, card issuer networks, point of sale (POS) systems, and/or the like. Such transaction data is typically received in a structured, computer-readable format that includes strings of alphanumeric characters that are meaningless to users of the payment application because the transaction data is not formatted for the users to understand. If words are included in the transaction data, the words are oftentimes heavily abbreviated (e.g., with several vowels omitted), concatenated, obscured, and/or the like. Most users are unable to decipher such transaction data, which leads to many users not recognizing their own transactions. User confusion regarding transactions, in turn, leads to a high volume of transaction inquiries, disputes, and chargebacks, which is burdensome for the payment service computing platform to process on an ongoing basis. The techniques, devices, and systems described herein utilize a trained AI model(s) to process transaction data that is received in the structured, computer-readable format to determine one or more attributes of a transaction associated with a user. The AI-generated transaction attribute(s) can include an entity, other than the user, associated with the transaction, a type of the transaction, and/or other attributes of the transaction. Based at least in part on the AI-generated transaction attribute(s), the payment service computing platform may cause information indicative of the transaction attribute(s) to be presented via the payment application executing on a user device of the user. The information can be presented (i) in a graphical user interface and (ii) in a user-readable format instead of the structured, computer-readable format, thereby “cleansing” the transaction data so that the user associated with the transaction can readily understand the attribute(s) of the transaction. This, in turn, reduces chargebacks, disputes, and/or other inquiries about transactions, which leads to a reduction in the processing load that would otherwise be placed upon the payment service computing platform.

Instances of the aforementioned payment application execute on electronic devices of users (sometimes referred to herein as “user devices”) to facilitate transactions and other operations as described herein. In some examples, each user of the payment application has an account (e.g., a spending account, savings account, investing account, cryptocurrency account, etc.) with the payment service. The user can add funds to a stored balance associated with the account and/or funds can be added to the stored balance automatically whenever payments are received (e.g., from other users of the payment service, from direct deposits (e.g., paychecks, tax refunds, etc.). In some examples, the user can access the funds on-demand in order to make payments (e.g., to other users and/or to merchants (e.g., in stores, online, etc.)). In some examples, a service provider of the payment service issues a payment instrument (e.g., a debit card, a credit card, etc.) to qualifying users, and this payment instrument can be used in association with the payment service, whereby funds available in a user's account (e.g., spending account, savings account, investing account, cryptocurrency account, etc.) can be used to facilitate transactions that are conducted using that payment instrument. Such transactions are sometimes referred to herein as “card transactions”. As various types of transactions occur, the payment service computing platform receives corresponding transaction data that is formatted in the aforementioned computer-readable format. Although compatible computers can process this transaction data to facilitate these transactions, when such transaction data is received by conventional systems that are incompatible with the transaction data, the systems are unable to read and/or understand the transaction data. Further, when such transaction data is presented to users in its native, structured computer-readable format, the viewing users can be confused by the transaction data and can begin to question whether the associated transactions are legitimate.

The techniques, devices, and systems described herein provide a technical solution to a computer-centric problem. To illustrate, ACH transaction data (e.g., metadata associated with ACH transactions) is typically set by the Originating Depository Financial Institution (ODFI). In its native, computer-readable format, ACH transaction data includes strings of alphanumeric characters (e.g., words, names, etc.) that are heavily abbreviated, concatenated, obscured, and/or the like, due to the fixed-width nature of the ACH specification, and/or the strings of alphanumeric characters may include additional descriptive data that is unintelligible. Conventional systems that are incompatible with ACH transaction data are unable to read and/or understand the ACH transaction data, which means that conventional systems are unable to use the ACH transaction data in any meaningful way, such as to generate rich receipts associated with ACH transactions. The technical solutions to this computer-centric problem, as described herein, provide advantages over conventional systems by structuring or cleansing messy and convoluted ACH transaction data so that it can be utilized by a payment service computing platform for one or more practical applications, which are described throughout this disclosure. Further, the technical solutions described herein provide advantages over conventional systems by standardizing the presentation of information indicative of transaction attribute(s), by improving the accuracy of transaction data, by classifying transactions with improved accuracy, and/or by detecting potentially fraudulent and/or noncompliant transactions.

In some examples, the techniques, devices, and systems described herein allow for processing transaction data associated with various types of transactions, such as ACH transactions, card transactions, and/or other types of transactions. For example, ACH transaction data, when it is received at the payment service computing platform, may be formatted in a different computer-readable format than the computer-readable format in which card transaction data is formatted. The trained AI model(s) described herein may be configured to process prompts that include transaction data in either of these computer-readable formats, and/or multiple different trained AI models can be utilized to process transaction data in the respective computer-readable formats. This ability to process transaction data that is formatted in a variety of different computer-readable formats can provide uniformity in the AI-generated output, which is leveraged in the various ways described herein, such as to present information indicative of transaction attributes to users in a graphical user interface and in a user-readable format, as described herein.

In some examples, the techniques, devices, and systems described herein provide intelligently crafted prompts to the trained AI model(s), which improves AI model performance and helps to ensure that the AI-generated output is suitable for a computer-centric environment. In this manner, the payment service computing platform can readily process AI-generated output to provide the technical benefits described herein. For example, a prompt generator component of the payment service computing platform may be configured to generate prompts that include a request for the trained AI model(s) to provide a computer-readable object as output, such as a JavaScript Object Notation (JSON) object, or another suitable type(s) of computer-readable object(s). By crafting prompts in such a way, the output generated by the trained AI model(s) is suitable for a computer-centric environment, and the payment service computing platform can readily process the AI-generated output to provide the various technical benefits described herein. In some examples, the prompt generator component may be configured to generate prompts that include a request for the trained AI model to explain steps performed and/or reasoning for determining one or more attributes of a transaction from a prompt that includes transaction data in the computer-readable format. In some examples, the prompt generator component is configured to dynamically insert, into the prompts, examples of past prompts and AI-generated answers to those past prompts as a guide for the trained AI model to determine how to provide a correct answer and/or how to avoid answering incorrectly. These and other technical solutions described herein can improve AI model performance, as compared to conventional AI model performance.

In some examples, the techniques, devices, and systems described herein reduce fraud on the payment service computing platform. In conventional systems, fraudulent transactions may avoid detection, or may be detected after it is too late to take any meaningful remedial action with respect to the fraudsters behind the illegitimate transactions. This may be due, at least in part, to the obfuscated nature of transaction data that is received in the computer-readable format, as described above. The techniques, devices, and systems described herein can utilize a trained AI model(s) to process transaction data that is received in the computer-readable format to determine whether a transaction is potentially fraudulent and/or noncompliant with terms of use of the payment application. In some examples, a potentially fraudulent transaction may be detected by the trained AI model(s) determining that a deposit of funds to an account (e.g., spending account, savings account, investing account, cryptocurrency account, etc.) associated with a user is anomalous or otherwise out-of-the-ordinary. When a potentially fraudulent and/or noncompliant transaction is detected using AI, as described herein, a remedial action(s) can be performed, such as flagging the transaction for review by an authorized user, suspending an account of the user suspected of fraud and/or noncompliance, and/or prohibiting completion of the transaction in real-time. Thus, fraud on the payment service computing platform can be mitigated and/or compliance with terms of use of the payment application can be improved, providing additional technical benefits because the payment service computing platform is not burdened with processing as many transactions that are fraudulent, noncompliant, or otherwise illegitimate, thereby conserving resources for processing more legitimate transactions.

In some examples, the techniques, devices, and systems described herein allow for one or more devices to conserve resources with respect to processing resources, memory resources, networking resources, power resources, etc., in the various ways described herein. For example, as noted above, a trained AI model(s) can be utilized to process transaction data that is received in a computer-readable format, which can provide the various technical benefits described herein. Nevertheless, running a trained AI model(s) consumes valuable resources, such as those mentioned above. Accordingly, the techniques, devices, and systems described herein may run the trained AI model(s) selectively, and/or on an as-needed basis. For example, a data store(s) can be used to store associations (or mappings) between transaction data and attributes of transactions, such as entities, types of transactions, and/or other transaction attributes. In some examples, after the trained AI model(s) determines one or more attributes of a transaction based on processing a prompt that includes a portion of transaction data in the computer-readable format, an association between the portion of the transaction data and the AI-generated attribute(s) can be stored in the data store(s) to create a new association (or mapping), and these associations (or mappings) can be subsequently looked-up at a lower cost than the cost of running the trained AI model(s), in terms of the resources that are utilized to determine the transaction attribute(s). In other words, if transaction data is received by the payment service computing platform in the computer-readable format, the platform may initially access the data store(s) using the transaction data to determine if an association between the transaction data and an attribute(s) of a transaction can be quickly and/or cheaply determined without running the trained AI model(s). However, if an association between the received transaction data and an attribute(s) of a transaction is not stored in the data store(s), the trained AI model(s) can be leveraged at that point in order to determine the transaction attribute(s).

In addition to conventional systems being unable to read and/or understand transaction data, such as ACH transaction data, the average user cannot understand what ACH transaction data means in its native, computer-readable format because many strings of alphanumeric characters (e.g., words, names, etc.) in the ACH transaction data are heavily abbreviated or concatenated due to the fixed-width nature of the ACH specification, and/or the strings of alphanumeric characters may include obscure payment type descriptions, additional descriptive data that is unintelligible, and/or the like. Such information is not helpful to users when it is presented in receipts or in activity feeds because users cannot identify what the transactions are for, where funds for incoming transactions came from, where funds for outgoing transactions were delivered, and the like. Further, the abbreviated and non-standardized use of ACH transaction data makes it challenging for a payment service computing platform to leverage the transaction data in a consistent way. The techniques, devices, and systems described herein provide a technical solution to the aforementioned computer-centric problem through the utilization of an AI model(s) that has been trained to understand transaction data in a computer-readable format, and to determine transaction attribute(s) therefrom. For instance, the trained AI model(s) can be used to classify transactions accurately, and/or to present information indicative of the transaction attribute(s) to users in a user-readable format that is easy for the users to understand. In some examples, the trained AI model(s) can be used to detect fraudulent and/or noncompliant transactions, among other things. In some examples, the techniques, devices, and systems described herein use an embedding approach that transforms received transaction data (e.g., a string of alphanumeric characters) into an embedding suitable for the trained AI model(s) to process, which may lead to better AI model performance, as compared to conventional AI model performance. In some examples, the techniques, devices, and systems described herein enable the direct representation of transactions using generative AI endpoints. In some examples, the trained AI model(s) described herein is used to translate transaction data into information that is presented to users and/or used to customize receipts, statements, and/or activity feeds presented to users via the payment application.

Consider an example where a user has setup a monthly subscription payment for a content streaming service that is provided by “Entity C,” a third-party content streaming service provider. In this example, the user might use their account (e.g., spending account, savings account, investing account, cryptocurrency account, etc.) with the payment service to make the monthly subscription payments to Entity C. Whenever a monthly subscription payment is made to Entity C, the payment service computing platform may deduct funds in the amount of the monthly subscription payment from the stored balance associated with the user's account (e.g., spending account, savings account, investing account, cryptocurrency account, etc.) with the payment service in order to facilitate the transaction. When the payment service computing platform receives transaction data corresponding to the monthly subscription payment described above, the transaction data may be received in a computer-readable format with the name of Entity C heavily abbreviated, a payment type description that is obscure, additional descriptive data, etc. Even if the user could decipher the heavily abbreviated name in the transaction data to determine that Entity C is associated with the transaction, the user may still be confused by this transaction data. Accordingly, without the techniques, devices, and systems described herein, the user might dispute the transaction with the service provider of the payment service, and the payment service computing platform may issue a chargeback to the user in order to replenish the funds that were withdrawn from their account (e.g., spending account, savings account, investing account, cryptocurrency account, etc.), even though the transaction was a legitimate transaction. In this example, the techniques, devices, and systems described herein can utilize a trained AI model(s) to process the transaction data that is received in the computer-readable format to determine, among other things, that the transaction data relates to a recurring, monthly payment to Entity C for a particular service. Based at least in part on this AI-generated attribute(s) of the transaction, the payment service computing platform causes this information to be presented in association with the transaction via the payment application executing on a user device of the user. In this example, the information may be presented (i) in a graphical user interface and (ii) in a user-readable format instead of the computer-readable format. Accordingly, the user can readily understand that the transaction is associated with Entity C, which the user recognizes as their content streaming service provider, thereby eliminating an instance where the user might otherwise deny their involvement in a legitimate transaction, which spares the payment service computing platform from needlessly issuing a chargeback to the user.

While several examples presented herein are directed to utilizing AI to process transaction data in the context of a payment service where users install and execute instances of a payment application on their electronic devices, the techniques described herein are also applicable to other types of services such as electronic commerce (ecommerce) services, social networking services, gaming services, a merchant service, a loyalty program service, a loan service (e.g., capital loan, buy now pay later loan, etc.), a music, podcast and/or video streaming service, or the like.

The preceding summary is provided for the purposes of summarizing some example embodiments to provide a basic understanding of aspects of the subject matter described herein. Accordingly, the above-described features are merely examples and should not be construed as limiting in any way. Other features, aspects, and advantages of the subject matter described herein will become apparent from the following description of Figures and Claims.

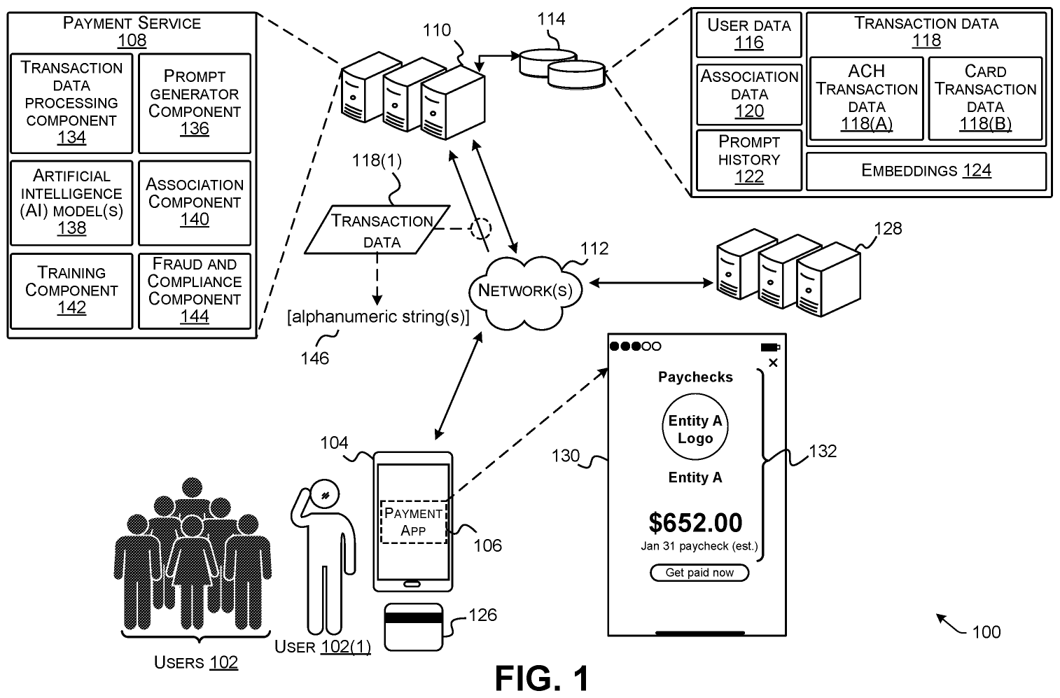

FIG. 1 is an example environment 100 for processing transaction data using AI, according to an implementation of the present subject matter. As depicted, the example environment 100 may include users 102, such as the user 102(1). The users 102 may be associated with respective electronic devices (sometimes referred to herein as “user devices”), such as the user device 104 shown in FIG. 1. The user devices (e.g., the user device 104) are configured to execute respective applications, such as a payment application 106. The payment applications (e.g., the payment application 106), when executing on the respective user devices (e.g., the user device 104), may allow the respective users 102 to navigate to the various user interfaces described herein, to interact with or access services, such as a payment service 108. In at least one example, the payment application 106 allows for the efficient transfer of funds (e.g., fiat currency, securities (e.g., stocks, bonds, mutual funds), cryptocurrencies, gift cards, etc.) between users 102 of the payment service 108. Such transfers can be “efficient” in that they can happen electronically, in real-time or near real-time, due to a complex integration of software and hardware components configured to facilitate such transfers. In some examples, the respective users 102 can interact with user interfaces of the payment application 106 to, among other things, facilitate transactions (e.g., electronic payments), view receipts, statements, and/or activity feeds regarding their transactions, or the like. In some examples, the payment application 106 allows two users who are “peers” to transfer funds in a “peer-to-peer (P2P)” transaction. In some examples, the payment application 106 allows a merchant and a customer of the merchant to transfer funds between each other, such as when the customer is purchasing an item(s) from the merchant. In some examples, the payment application 106 installed on respective user devices (e.g., the user device 104) can be different instances of a same payment application 106, which can be provided by a payment service computing platform that implements the payment service 108. For example, the users 102 may download and install a particular version of the payment application 106 on their user devices (e.g., the user device 104), either via a first time installation, a software update, or the like.

As depicted by FIG. 1, the user device 104 of the user 102(1) may be coupled to one or more servers 110 of the payment service computing platform via one or more network(s) 112, such as a wide area network (WAN) (e.g., the Internet, a cellular network, etc.). Other user devices of other users 102 may be coupled to the server(s) 110 in a similar fashion. In some examples, the payment service computing platform may include a cloud-based computing architecture suitable for hosting and servicing the respective payment applications (e.g., the payment application 106) executing on the respective user devices (e.g., the user device 104). In particular examples, the payment service computing platform may include a Platform as a Service (PaaS) architecture, a Software as a Service (SaaS) architecture, an Infrastructure as a Service (IaaS) architecture, a Data as a Service (DaaS) architecture, a Compute as a Service (CaaS) architecture, or other similar cloud-based computing architecture (e.g., “X” as a Service (XaaS)). The payment service computing platform may be used to implement the aforementioned payment service 108, as described herein.

A service provider may operate the payment service computing platform, which may include one or more processing devices, such as the aforementioned server(s) 110, and one or more data stores 114. The server(s) 110 (or other types of processing devices) may be configured to provide processing or computing support for the respective payment applications (e.g., the payment application 106) executing on the respective user devices (e.g., the user device 104). The data store(s) 114 may include, for example, one or more internal data stores that may be utilized to store various types of data including user data 116, transaction data 118, and/or association data 120. In some examples, the data store(s) 114 may be utilized to maintain a prompt history 122 and/or embeddings 124, which will be described in more detail below with reference to the following examples.

The user data 116 is associated with the respective users 102 and may include user transaction history data, user purchase history data, user interaction data, user attribute data, user demographic data, user contextual data, user preference data, and so forth. The user data 116 can be organized by user identifiers (IDs) that uniquely identify each user 102 of the payment service 108. The user data 116 can be collected by the payment service computing platform at any suitable time, such as when new users 102 are onboarded to the payment service 108, and/or as many of those users 102 continue to use the payment service 108 to, among other things, complete transactions using the payment application 106 executing on their user devices (e.g., the user device 104) and/or using a payment instrument 126.

The transaction data 118 may represent transactions associated with the users 102. As noted above, in some examples, each user 102 has an account (e.g., a spending account, savings account, investing account, cryptocurrency account, etc.) with the payment service 108. A user 102 can add funds to a stored balance associated with their account and/or funds can be added to the stored balance automatically whenever payments are received (e.g., from other users 102 of the payment service 108, from direct deposits (e.g., paychecks, tax refunds, etc.), etc.), and the user 102 can access the funds on-demand in order to make payments (e.g., to other users 102 and/or to merchants (e.g., in stores, online, etc.)). In some examples, a service provider of the payment service 108 issues a payment instrument(s) 126 (e.g., a debit card, a credit card, etc.) to the users 102 who qualify for the payment instrument(s) 126, and the payment instrument(s) 126 can be used in association with the payment service 108. In the example of FIG. 1, the user 102(1) has been issued the payment instrument(s) 126, and funds available in the user's 102(1) account (e.g., spending account, savings account, investing account, cryptocurrency account, etc.) can be used to facilitate transactions that are conducted using that payment instrument(s) 126 (sometimes referred to herein as “card transactions”). As various types of transactions occur, the payment service computing platform (e.g., the server(s) 110) receives corresponding transaction data 118 that is formatted in the aforementioned computer-readable format.

In some examples, the transaction data 118 includes ACH transaction data 118(A) that represents ACH transactions associated with the users 102. The ACH transaction data 118(A) may be received by the payment service computing platform (e.g., the server(s) 110) from an external network(s) and/or system(s), such as the ACH network. In one example, the server(s) 128 depicted in FIG. 1 may represent at least part of the ACH network. ACH transactions, and/or the ACH transaction data 118(A), may represent, or include, inflow transactions, such as income, direct deposits, paychecks, tax refunds, annuities, social security payments, unemployment insurance payments, other government deposits, and/or the like. Additionally, or alternatively, ACH transactions, and/or the ACH transaction data 118(A), may represent, or include, outflow transactions, such as bill pay transactions, child care payments, mortgage payments, subscription payments, and/or the like.

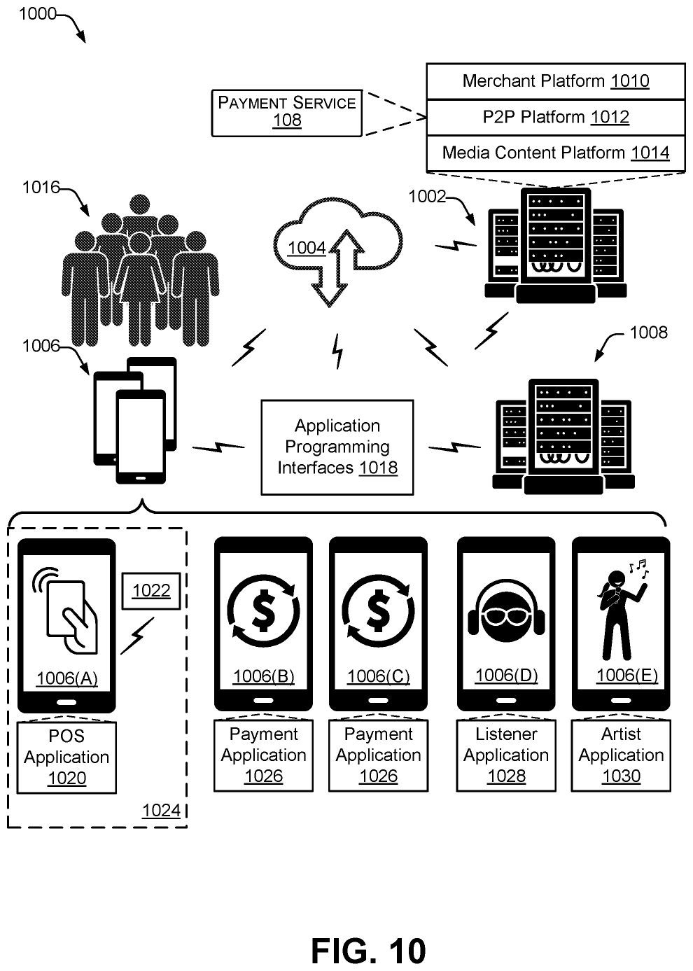

In some examples, the transaction data 118 includes card transaction data 118(B) that represents card transactions associated with the users 102. The card transaction data 118(B) may be received by the payment service computing platform (e.g., the server(s) 110) from an external network(s) and/or system(s), such as a card issuer network(s), POS systems, etc. In one example, the server(s) 128 depicted in FIG. 1 may represent at least part of one or more card issuer network(s), POS systems, and/or the like. Card transactions, and/or the card transaction data 118(B), may represent, or include, debit card transactions, credit card transactions, gift card transactions, and/or transactions conducted using the payment instrument(s) 126. Card transactions and associated transaction data are discussed in more detail below with reference to FIG. 10. In some examples, the transaction data 118 is associated with use of the payment application 106 to conduct the transactions, such as to complete a payment to a merchant for an item(s) (e.g., a product and/or service provided by the merchant) via an in-app checkout experience that is facilitated via the payment application 106.

Although examples of electronic funds transfers (EFTs) in the form of ACH transactions and card transaction are described herein, it is to be appreciated that the transaction data 118 described herein may be received by the payment service computing platform (e.g., the server(s) 110) from any suitable external network(s) and/or system(s) associated with EFTs. EFTs are transactions that move funds electronically between different financial institutions, bank accounts, or individuals, and EFTs are sometimes referred to as “electronic bank transfers,” “e-checks,” and/or “electronic payments.” For example, the server(s) 128 depicted in FIG. 1 may represent an external network(s) and/or system(s) associated with any suitable type of EFTs, such as ACH transfers, wire transfers (e.g., payments sent by a business to credit a receiving party), Automated Teller Machine (ATM) transactions (e.g., withdrawals, deposits, transfers, etc.), debit card transactions, P2P payments, and/or the like. In some examples, the server(s) 128 depicted in FIG. 1 may represent an external network(s) and/or system(s) associated with instant transfers, which are nearly immediate methods of payment sent by a business to credit a receiving party. Instant transfers can be facilitated by mobile applications, Real Time Payments (RTP®), and/or FedNow®.

In some examples, the ACH transaction data 118(A) and the card transaction data 118(B), when received at the server(s) 110, may be formatted differently. For example, the ACH transaction data 118(A) may be formatted in a first computer-readable format and the card transaction data 118(B) may be formatted in a second computer-readable format that is different than the first computer-readable format. Examples of ACH transaction data 118(A) formatted in the first computer-readable format are shown in Table 1, below:

TABLE 1

| company_name | entry_description | discretionary_data |
|---|---|---|
| OTC - TAX REFUND | TAX REFUND | AUTO-TAX REFUND |
| MEB Inc. | EFT | |
| TEAM MEMBERS | TEAMMEMBER | 0000000000000000 |
| RAISER 6795 | EDI PAYMNT | 0HM7QR1M2WL85H4 |
| MPLS USPS PDC MN | FED SALARY | |
| WF HOME MTG | RETRY PYMT | ACH (R) oi |

As shown in Table 1, the ACH transaction data 118(A) is formatted as strings 146 of alphanumeric characters, and with words, if any, heavily abbreviated (e.g., with several vowels omitted), concatenated, obscured, and/or the like, and/or the strings 146 of alphanumeric characters may include additional descriptive data that is unintelligible. Moreover, while the ACH transaction data 118(A) may be structured (e.g., according to the ACH specification), the ACH transaction data 118(A) is non-standardized. For example, the word “Payment” is sometimes abbreviated as “PAYMNT” in the ACH transaction data 118(A), and other times abbreviated as “PYMT” in the ACH transaction data 118(A). Card transaction data 118(B) may be formatted differently (e.g., in accordance with International Standards Organization (ISO) 8583), yet the card transaction data 118(B) may include similar data fields, such as merchant name (which may be similar to the “company_name” field of the ACH transaction data 118(A), as shown in Table 1). The card transaction data 118(B) may also be obfuscated (from a human user's perspective) in similar ways to that of the ACH transaction data 118(A), such as by omitting vowels to abbreviate words, names, etc., by concatenating words, by specifying the merchant names using the name of a parent company that is unbeknownst to the average user, and/or the like.

The association data 120 may include associations (or mappings) between portions of the transaction data 118 in the computer-readable format and attributes of transactions. Such transaction attributes may include entities, other than the users 102, associated with the transactions, types of the transactions, and/or other transaction attributes. Initially, the association data 120 may be populated by associating known transaction data 118 with one or more transaction attributes. For example, if a particular name of a limited liability company (LLC) is included in the transaction data 118 (whether in an abbreviated form or the full name of the LLC), and if the name of the LLC is known to be a LLC that handles paychecks for employees of a famous entity of another name (e.g., a famous brand name), an association between the name of the LLC and the name of the famous entity can be created and stored in the association data 120 so that the mapping from the name of the LLC (in the computer-readable-formatted transaction data 118) to the name of the famous entity (in a user-readable format) can be subsequently looked up by accessing the data store(s) 114 using the transaction data 118 in the computer-readable format that includes the name of the LLC. In some examples, the association data 120 includes regular expressions (regexes) that are used to identify transaction attributes from the transaction data 118. For example, the transaction data 118 may include the following regex: “Sa?lar[y|ies]”, which may be indicative of a particular type of transaction (e.g., a paycheck). Accordingly, the association data 120 can indicate this association so that a transaction attribute(s) (e.g., a type of transaction) can be determined using the regex “Sa?lar[y|ies]=>paycheck,” and this transaction attribute(s) (e.g., a paycheck) can be determined at runtime relatively quickly and/or cheaply, as compared to running a trained AI model(s) to determine the same transaction attribute(s) from the same portion of transaction data 118. In some examples, after a trained AI model(s) is used to determine one or more attributes of a transaction based on processing a prompt that includes a portion of the transaction data 118 in the computer-readable format, an association between the portion of the transaction data 118 in the computer-readable format and the AI-generated attribute(s) can be stored in the data store(s) 114 to create a new mapping in the association data 120, and new mappings can be subsequently looked up at a lower cost than running the trained AI model(s), in terms of the resources that are utilized to determine the transaction attribute(s). As depicted by FIG. 1, the payment application 106 may include, for example, a user interface(s) 130 (e.g., a graphical user interface) for displaying, among other things, information 132 indicative of one or more attributes of a transaction associated with the user 102(1), wherein the information 132 is presented in a user-readable format instead of the computer-readable format of the transaction data 118.

In the example of FIG. 1, the payment service 108 is shown as including a transaction data processing component 134, a prompt generator component 136, one or more AI models 138, an association component 140, a training component 142, and/or a fraud and compliance component 144. The components 134, 136, 140, 142, and 144, and the payment service 108 itself, may represent computer-executable instructions that, when executed by a processor(s) (e.g., a processor(s) of the server(s) 110) cause performance of one or more operations described herein. In some examples, one or more of these components may utilize the AI model(s) 138 to perform their respective tasks.

The transaction data processing component 134, for example, may use a trained AI model(s) 138 to process transaction data 118 that is received in a computer-readable format to determine one or more attributes of a transaction associated with a user 102(1). The AI-generated transaction attribute(s) can include an entity, other than the user 102(1), associated with the transaction, a type of the transaction, and/or other attributes of the transaction. Based at least in part on the AI-generated transaction attribute(s), the payment service computing platform (e.g., the server(s) 110) may cause information 132 indicative of the transaction attribute(s) to be presented via the payment application 106 executing on a user device 104 of the user 102(1), wherein the information 132 is presented (i) in a user interface 130 (e.g., a graphical user interface) and (ii) in a user-readable format instead of the computer-readable format, thereby improving the transaction data 118 so that the user 102(1) associated with the transaction can readily understand the attribute(s) of the transaction. In the example of FIG. 1, the information 132 presented in the user interface 130 indicates that the type of the transaction is a paycheck, and that the entity, other than the user 102(1), associated with the transaction is Entity A, which is a generic placeholder for a name of a real entity, such as a company that employs the user 102(1).

In some examples, the AI models 138 described herein can be, or include, machine learning models. Machine learning generally involves processing a set of examples (called “training data” or a “training dataset”) in order to train the model(s). In some examples, the AI model(s) 138 (e.g., machine learning model(s)) described herein is/are pre-trained (e.g., an off-the-shelf AI model(s) 138 trained on a large corpus of data and obtained by the server(s) 110). In some examples, the AI model(s) 138 is/are trained “in house” by the training component 142 and using a training dataset. In some examples, the training dataset used to train the AI model(s) 138 can include features and labels. However, the training dataset may be unlabeled, in some examples. Accordingly, the AI model(s) 138 (e.g., machine learning model(s)) may be trained using any suitable learning technique, such as supervised learning, unsupervised learning, semi-supervised learning, reinforcement learning, and so on. The training dataset can be represented by a set of features, such as in the form of an n-dimensional feature vector of quantifiable information about an attribute of the training dataset. In some examples, the training dataset may include at least some of the transaction data 118. Various features of the transaction data 118 can be used to train the AI model(s) 138 to output one or more attributes of a transaction associated with a user 102 of the payment service 108, to classify transactions as one of multiple predefined types of transactions, as potentially fraudulent, and/or as noncompliant with terms of use of the payment application 106. Example features of the transaction data 118 used in the training dataset may include transaction times, transaction days, transaction amounts, parties to the transactions, transaction methods and/or instruments (e.g., card based transactions, P2P transactions, POS transactions, online transactions, etc.), alphanumeric string patterns, and/or the like. As the AI model(s) 138 is/are trained, the AI model(s) 138 learns how the features of the training dataset translate to the desired output (e.g., attributes of transactions, representations of transactions, etc.). For example, the AI model(s) 138 can learn how the features of the transaction data 118 translate to transaction attributes, such as entities (e.g., companies, merchants, other users 102, etc.), types of transactions (e.g., paychecks, tax refunds, mortgage payments, card transactions, transactions using the payment application 106, etc.), and/or the like. In some examples, the training component 142 may use machine learning to train the AI model(s) 138, which may utilize statistical techniques, as well as techniques to generate and/or modify the layers and/or models describes herein. Those techniques may include, for example, decision tree learning, association rule learning, artificial neural networks (including, in examples, deep learning), inductive logic programming, support vector machines, clustering, Bayesian networks, reinforcement learning, representation learning, similarity and metric learning, sparse dictionary learning, and/or rules-based machine learning. In the context of generative AI models, such models can be trained on visual data, text data, audio data, or the like, to generate transaction attributes. During training of the models 138, a discriminator may be used to evaluate the performance of the model in generating transaction attributes. In some examples, the features of the training dataset may be utilized to predict trends and behavior patterns. The predictive analytic techniques may be utilized to determine associations and/or relationships between explanatory variables and predicted variables from past occurrences and utilizing these variables to predict the unknown outcome. The predictive analytic techniques may include defining the outcome and data sets used to predict the outcome. Data analysis may include using one or more models, including for example one or more algorithms, to inspect the data with the goal of identifying useful information and arriving at one or more determinations that assist in predicting the outcome of interest. One or more validation operations may be performed, such as using statistical analysis techniques, to validate accuracy of the models. In some examples, the training dataset may be formatted into input vectors and/or signals for the AI model(s) 138 (e.g., machine learning model(s)) to intake, as well as associating the various data with the outcomes.

An AI model(s) 138 (e.g., machine learning model(s)), once trained, is a learned mechanism that can receive new data as input and estimate or predict a result as output. For example, a trained machine learning model can comprise a classifier that is tasked with classifying unknown input (e.g., an unknown image) as one of multiple class labels (e.g., labeling the image as a cat or a dog). In some cases, a trained machine learning model is configured to implement a multi-label classification task (e.g., labeling images as “cat,” “dog,” “duck,” “penguin,” and so on). Additionally, or alternatively, a trained AI model can be trained to infer a probability, or a set of probabilities, for a classification task based on unknown data received as input. In some examples, the AI models 138 described herein can be, or include, generative AI models, such as large language models (LLMs), neural networks (e.g., generative adversarial networks (GANs)), and/or the like, which may be configured to generate text, images, and/or other media as output. In the context of the present disclosure, the trained AI model(s) 138 may generate transaction attributes as text, images, and/or other media, which is usable to present the information 132 in the user-readable format, as described herein.

In some examples, the transaction data processing component 134 utilizes the prompt generator component 136 to generate a prompt(s) that includes a portion(s) of the transaction data 118 representing a transaction associated with the user 102(1), and this prompt(s) may be provided to the trained AI model(s) 138 to determine the one or more transaction attribute(s). For example, FIG. 1 shows that the payment service computing platform (e.g., the server(s) 110) may receive transaction data 118(1) in a computer-readable format, wherein the transaction data 118(1) represents a transaction associated with the user 102(1), and, therefore, the transaction data 118(1) represents a portion of a more comprehensive collection of transaction data 118. In some examples, this portion of transaction data 118(1) is formatted in the computer-readable format. As such, the portion of the transaction data 118(1) may include a string 146 of alphanumeric characters (e.g., a string of letters, a string of numbers, a string of letters and numbers, etc.). For instance, the transaction data 118(1) may represent ACH transaction data 118(A) that includes the string 146 “RAISER 6795,” which is shown in Table 1, above. In this example, the prompt generator component 136 may generate a prompt(s) that includes at least the string 146 “RAISER 6795.” In some examples, the prompt generator component 136 may generate a prompt(s) by including in the prompt(s) a request for the trained AI model(s) 138 to determine one or more attributes of the transaction from this portion of the transaction data 118(1) (e.g., from the string 146 “RAISER 6795”). For example, the prompt generator component 136 may generate the following prompt: “What company is ‘RAISER 6795’?” When the trained AI model(s) 138 (e.g., a LLM) processes this prompt, the trained AI model(s) 138 may generate the following output: “The company name ‘RAISER 6795’ represents ‘Entity A’,” where Entity A is a generic placeholder for a name of a real entity, such as a company that employs the user 102(1) Accordingly, the transaction data processing component 134 can determine, based at least in part on the trained AI model(s) 138 processing the prompt, that Entity A is an entity, other than the user 102(1), associated with the transaction, the entity being one example attribute of the transaction that the trained AI model(s) 138 may be used to determine.

Another example attribute of the transaction that the trained AI model(s) 138 may be used to determine is a type of the transaction. For example, if the portion of the transaction data 118(1) includes the string 146 “EDI PAYMNT,” which is also shown in Table 1, above, the prompt generator component 136 may generate a prompt(s) that includes at least the string 146 “EDI PAYMNT.” In some examples, the prompt generator component 136 may generate a prompt(s) by including in the prompt(s) a request for the trained AI model(s) 138 to determine one or more attributes of the transaction from this portion of the transaction data 118(1) (e.g., from the string 146 “EDI PAYMNT”). For example, the prompt generator component 136 may generate the following prompt: “What type of transaction is ‘EDI PAYMNT’?” When the trained AI model(s) 138 (e.g., a LLM) processes this prompt, the trained AI model(s) 138 may generate the following output: “‘EDI PAYMNT’ represents a paycheck.” Accordingly, the transaction data processing component 134 can determine, based at least in part on the trained AI model(s) 138 processing the prompt(s), that the type of the transaction is a paycheck, where the type of the transaction is another example attribute of the transaction that the trained AI model(s) 138 may be used to determine.

In some examples, the trained AI model(s) 138 used by the transaction data processing component 134 is a classifier that is tasked with classifying the transaction as a type among multiple predefined types of transactions. In these examples, the unknown input provided by the transaction data processing component 134 to the trained AI model(s) 138 may be the portion of the transaction data 118(1) (e.g., the string 146 “Raiser EDI”), and the trained AI model(s) 138 may be tasked with labeling the associated transaction as one of the predefined types of transactions, such as a paycheck, a tax refund, a mortgage payment, a card transaction, a transaction using the payment application 106, etc. In this example, the transaction may be classified as a paycheck based on the string 146 “Raiser EDI,” which is provided as the unknown input to the trained AI model(s) 138.

In some examples, the unknown input provided by the transaction data processing component 134 to the trained AI model(s) 138 may be numeric transaction data 118, such as a number of transactions associated with an entity (e.g., a company, a merchant, etc.), a number of users who receive the transaction (e.g., a large number of users that receive a transaction from an entity on the same day may be indicative of paycheck transactions), the average size of the transactions in terms of the transaction amount, dates of the transactions, a cadence of the transactions (e.g., how often and/or on what day of the week do the transactions occur), etc. For example, if the transaction data processing component 134 provides the trained AI model(s) 138 with numeric transaction data 118 indicating multiple, recurring Friday deposits, the trained AI model(s) 138 may classify the associated transactions as paychecks based on this numeric transaction data 118 provided as the unknown input to the trained AI model(s) 138. In some examples, generative AI (e.g., trained AI model(s) 138) is used to determine transaction types/categories that are missing from the predefined types of transactions. In these examples, the missing type(s)/category(ies) of transactions identified using generative AI can be added to the existing predefined types of transactions to create a new set of predefined types of transactions that is more comprehensive and/or robust than before the missing type(s)/category(ies) of transactions was/were identified.

Although classifiers may be used to determine certain transaction attributes, generative AI models may be utilized where the classification task is to classify the unknown input as one of a large number of class labels. For example, there may be upwards of 500,000 to one million entities (e.g., companies) that may be associated with any given transaction, and new companies may be formed frequently (e.g., on a weekly basis). Accordingly, it may be challenging to train a classifier to classify unknown transaction data 118 as one of multiple entities associated with the transaction, for example, seeing as how such a classifier may become obsolete shortly after it is trained, and it may be computationally expensive to frequently retrain such a classifier. Accordingly, generative AI models may be well-suited for determining particular transaction attributes (e.g., entities, other than the users 102, associated with transactions), and AI model performance may, therefore, be improved through the use of a generative AI model(s) 138 to determine the particular transaction attribute(s). Nevertheless, the AI model(s) 138 (e.g., machine learning model(s)) described herein may represent a single model or an ensemble of base-level AI models, and may be implemented as any type of AI model. For example, suitable AI models 138 for use by the techniques and systems described herein include, without limitation, LLMs, neural networks (e.g., GANs, deep neural networks (DNNs), recurrent neural networks (RNNs), etc.), tree-based models (e.g., eXtreme Gradient Boosting (XGBoost) models), support vector machines (SVMs), kernel methods, random forests, splines (e.g., multivariate adaptive regression splines), hidden Markov model (HMMs), Kalman filters (or enhanced Kalman filters), Bayesian networks (or Bayesian belief networks), multilayer perceptrons (MLPs), expectation maximization, genetic algorithms, linear regression algorithms, nonlinear regression algorithms, logistic regression-based classification models, or an ensemble thereof. An “ensemble” can comprise a collection of AI models 138 whose outputs (predictions) are combined, such as by using weighted averaging or voting. The individual AI models of an ensemble can differ in their expertise, and the ensemble can operate as a committee of individual AI models that is collectively “smarter” than any individual AI model of the ensemble.

FIG. 1 illustrates example information 132 that may be presented via the payment application 106 executing on the user device 104 of the user 102(1). The information 132 is indicative of one or more attributes of a transaction associated with the user 102(1), including an AI-generated attribute of the transaction determined using the trained AI model(s) 138, as described herein. For instance, the transaction data processing component 134 may have determined, based at least in part on the trained AI model(s) 138 processing a prompt(s) including a portion(s) of the transaction data 118(1) representing the transaction, that “Entity A” is an entity, other than the user 102(1), associated with the transaction, and/or that the type of the transaction is a paycheck. Accordingly, the information 132 indicates that a transaction in the amount of $652.00 is a paycheck received from Entity A, which the user 102(1) may recognize as their employer. In some examples, the information 132 presented via the payment application 106 includes a logo (e.g., trademark or other source identifier) associated with the determined entity (e.g., “Entity A” in the example of FIG. 1). The information 132 can be presented (i) in the user interface 130 (e.g., a graphical user interface) and (ii) in a user-readable format instead of the computer-readable format of the received portion of the transaction data 118(1), thereby improving the transaction data 118(1) so that the user 102(1) can readily understand the attribute(s) of the transaction (e.g., the entity associated with the transaction is “Entity A,” the type of the transaction is a paycheck, etc.). As noted above, this reduces chargebacks, disputes, and other inquiries about transactions, which leads to a reduction in the processing load that would otherwise be placed upon the payment service computing platform (e.g., the server(s) 110).

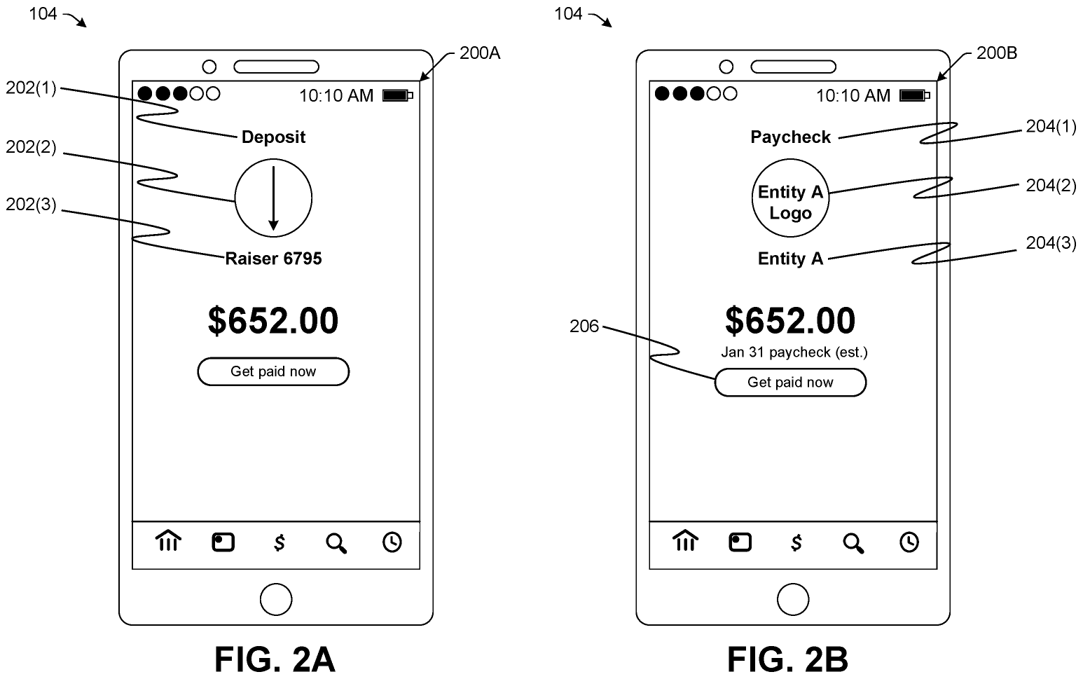

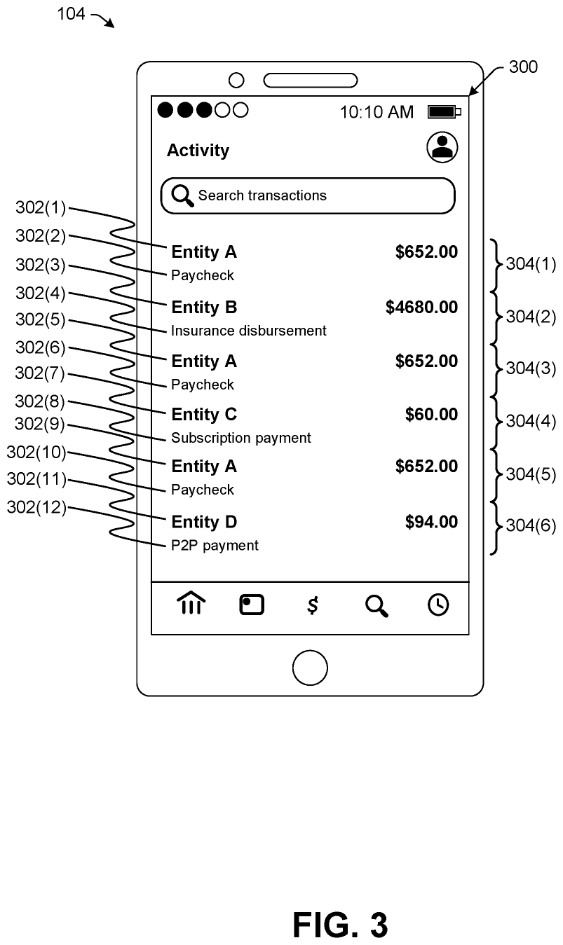

Example user interfaces will now be described with reference to FIGS. 2A, 2B, and 3.

FIG. 2A is an example user interface 200A of a payment application, the user interface 200A presenting information 202 associated with a transaction in a computer-readable format. Meanwhile, FIG. 2B is an example user interface 200B (e.g., a graphical user interface) of the payment application 106 introduced in FIG. 1, the user interface 200B presenting information 204 associated with the transaction in a user-readable format instead of the computer-readable format. By comparing and contrasting the user interfaces 200A and 200B in FIGS. 2A and 2B, respectively, it can be appreciated how the user interface 200B improves the transaction data 118 so that the corresponding information 204 is suitable for presentation to users 102, such as the user 102(1) of FIG. 1. For example, the information 202(1) presented in the user interface 200A indicates the type of transaction as a “deposit,” whereas the information 204(1) presented in the user interface 200B indicates the type of transaction as a “paycheck,” which is a more accurate and understandable representation of the transaction. As another example, the information 202(2) presented in the user interface 200A is a generic graphic that is indicative of an incoming deposit, whereas the information 204(2) presented in the user interface 200B is a logo of an entity (e.g., “Entity A”), other than the user 102(1), associated with the transaction, which is a more meaningful to the user 102(1) than the generic graphic presented in the user interface 200A. As yet another example, the information 202(3) presented in the user interface 200A indicates an entity associated with the transaction as “Raiser 6795,” whereas the information 204(3) presented in the user interface 200B indicates the entity associated with the transaction as “Entity A,” which is a generic placeholder for a name of a real company, and which the user 102(1) may readily recognize as their employer, for example.

The user interface 200B may be the same as, or similar to, the user interface 130 depicted in FIG. 1. In some examples, the user interface 200B is associated with a statement or a receipt. For example, after the transaction is completed (e.g., after the paycheck is received and corresponding funds are added to the account (e.g., spending account, savings account, investing account, cryptocurrency account, etc.) of the user 102(1)), the user interface 200B may be displayed via the payment application 106 executing on an user device 104 of the user 102(1) as a statement and/or a receipt associated with the transaction. The user interface 200B may be displayed at any suitable time after the transaction is completed, such as in response to the user 102(1) opening the payment application 106 and interacting with (e.g., selecting) an interactive element to view a statement and/or a receipt associated with the transaction. In some examples, the user interface 200B may further present an interactive element 206 (e.g., a “get paid now” button) that, when interacted with (e.g., selected), causes funds in the amount of the transaction (e.g., $652.00) to be deposited into an account specified by the user 102(1) so that the user 102(1) can spend or save the funds, as desired.

FIG. 3 is an example user interface 300 (e.g., a graphical user interface) of the payment application 106, the user interface 300 being associated with an activity feed and presenting information 302 associated with transactions 304 in a user-readable format, according to an implementation of the present subject matter. The user interface 300 may be displayed via the payment application 106 at any suitable time. For example, the user interface 300 may be displayed in response to a user 102 interacting with (e.g., selecting) an interactive element associated with viewing the user's 102 recent or past transaction activity. In the example of FIG. 3, six example transactions 304(1)-(6) are listed in the user's 102 activity feed. Information indicating the respective transaction amounts is presented on the right side of the user interface 300. On the left side of the user interface 300, information 302 indicative of attributes of the respective transactions 304 is presented in a user-readable format that can be readily understood by the user 102 of the user device 104. For example, the user interface 300 may present information 302(1) indicative of an entity (e.g., “Entity A”), other than the user 102, associated with a first transaction 304(1) and/or information 302(2) indicative of the type of the first transaction 304(1) (e.g., a paycheck). Additionally, or alternatively, the user interface 300 may present information 302(3) indicative of an entity (e.g., “Entity B”), other than the user 102, associated with a second transaction 304(2) and/or information 302(4) indicative of the type of the second transaction 304(2) (e.g., an insurance disbursement). Additionally, or alternatively, the user interface 300 may present information 302(5) indicative of an entity (e.g., “Entity A”), other than the user 102, associated with a third transaction 304(3) and/or information 302(6) indicative of the type of the third transaction 304(3) (e.g., a paycheck). Additionally, or alternatively, the user interface 300 may present information 302(7) indicative of an entity (e.g., “Entity C”), other than the user 102, associated with a fourth transaction 304(4) and/or information 302(8) indicative of the type of the fourth transaction 304(4) (e.g., a subscription payment). Additionally, or alternatively, the user interface 300 may present information 302(9) indicative of an entity (e.g., “Entity A”), other than the user 102, associated with a fifth transaction 304(5) and/or information 302(10) indicative of the type of the fifth transaction 304(5) (e.g., a paycheck). Additionally, or alternatively, the user interface 300 may present information 302(11) indicative of an entity (e.g., “Entity D”), other than the user 102, associated with a sixth transaction 304(6) and/or information 302(12) indicative of the type of the sixth transaction 304(6) (e.g., a PAP payment).

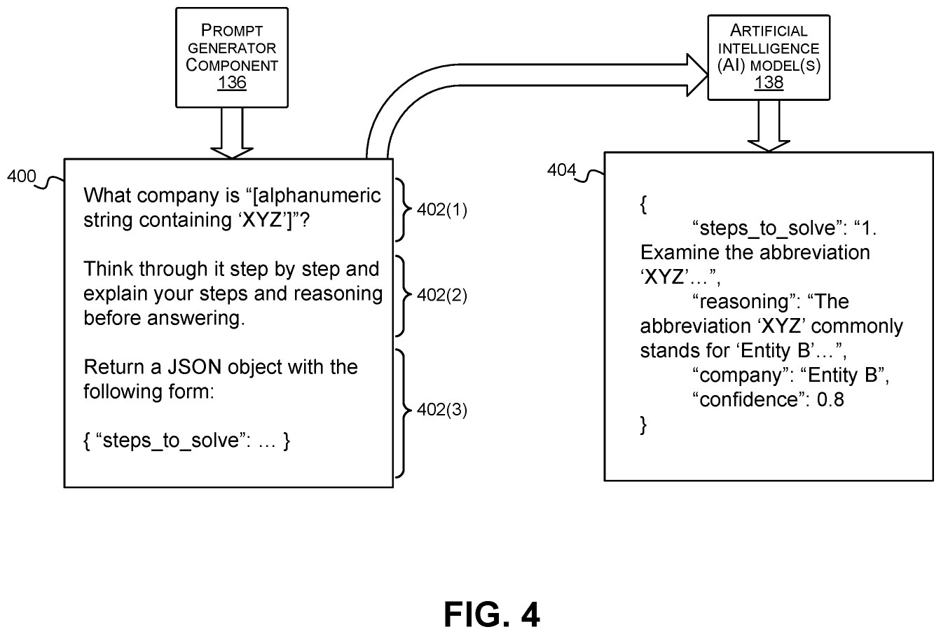

FIG. 4 is an example diagram illustrating an example prompt 400 that may be provided to a trained AI model(s) 138 to determine an entity associated with a transaction, according to an implementation of the present subject matter. As shown in FIG. 4, the prompt generator component 136 may generate the prompt 400 by including in the prompt 400 one or more requests 402 (or commands). For example, the prompt generator component 136 may include in the prompt 400 a request 402(1) for the trained AI model(s) 138 to determine one or more attributes of a transaction from a portion of the transaction data 118 that represents a transaction associated with a user 102. In the example of FIG. 4, the request 402(1) is for the trained AI model(s) 138 to determine an entity, other than the user 102, associated with the transaction. This request 402(1) for the trained AI model(s) 138 to determine an entity may be based at least in part on the portion of the transaction data 118 having been extracted from the “company name” field of ACH transaction data 118(A) or the merchant name field of card transaction data 118(B). For example, the portion of the transaction data 118 may be an alphanumeric string 146 containing the abbreviation “XYZ,” and the request 402(1) may be the following request: “What company is ‘[alphanumeric string containing ‘XYZ’]?” In this example, “XYZ” is a fictitious abbreviation that is used herein to aid in the description of generating the prompt 400. It is also to be appreciated that other transaction attributes may be requested in the prompt 400, such as the type of the transaction, and/or other transaction attributes. For example, the prompt 400 may additionally, or alternatively, include a request for the trained AI model(s) 138 to determine a type of the transaction from a portion of the transaction data 118, such as the alphanumeric string 146: “preauth dr.” Such a request for the trained AI model(s) 138 to determine a type of the transaction may be based at least in part on the portion of the transaction data 118 having been extracted from the “entry description” field of ACH transaction data 118(A) or a similar field of card transaction data 118(B).

In some examples, the prompt generator component 136 may include in the prompt 400 a request 402(2) for the trained AI model(s) 138 to explain steps performed and/or reasoning for determining the attribute(s) of the transaction from the portion of the transaction data 118. In the example of FIG. 4, the request 402(2) is for the trained AI model(s) 138 to explain steps performed and/or reasoning for determining the entity from the portion of the transaction data 118 “[alphanumeric string containing ‘XYZ’].” For example, the request 402(2) may be the following request: “Think through it step by step and explain your steps and reasoning before answering.” Including the request 402(2) for the trained AI model(s) 138 to explain steps performed and/or reasoning for determining the attribute(s) of the transaction may improve AI model performance because the trained AI model(s) 138 (e.g., a LLM) may produce better answers when asked to reason through its process before responding.

In some examples, the prompt generator component 136 may include in the prompt 400 a request 402(3) for the trained AI model(s) 138 to provide a computer-readable object as output, such as a JSON object, or any other suitable type of computer-readable object. For example, the request 402(3) may be the following request: “Return a JSON object with the following form: {“steps_to_solve”: . . . }. By generating the prompt 400 in this way, the output 404 generated by the trained AI model(s) 138 is suitable for a computer-centric environment, and the payment service computing platform can readily process the AI-generated output 404 to provide the various technical benefits described herein. For example, the payment service computing platform (e.g., the server(s) 110) may be configured to parse JSON objects to determine the transaction attribute(s) that are to be indicated by the information presented to the user 102 associated with the transaction, and the trained AI model(s) 138 may be configured to follow the example template that the prompt generator component 136 includes in the request 402(3).

In some examples, the prompt generator component 136 is configured to dynamically insert, into the prompt 400, one or more examples of past prompts and AI-generated answers to those past prompts as a guide for the trained AI model(s) 138 to determine how to provide a correct answer and/or how to avoid answering incorrectly. These past prompts may be retrieved from the prompt history 122 maintained in the data store(s) 114, as depicted in FIG. 1. For example, the prompt history 122 may include examples of past prompts where the trained AI model(s) 138 determined correct answers to those prompts. These are sometimes referred to herein as “positive examples.” Additionally, or alternatively, the prompt history 122 may include examples of past prompts where the trained AI model(s) 138 determined incorrect answers to those prompts. These are sometimes referred to herein as “negative examples.” To illustrate, the prompt generator component 136 may retrieve from the prompt history 122, and include in the prompt 400, a first example prompt(s) and a correct AI-generated answer(s) to the first example prompt(s) (e.g., one or more positive examples). For example, the first example prompt that is inserted into the prompt 400 may be the following prompt: “What company is [alphanumeric string]?” In this example, a correct AI-generated answer to the first example prompt may be the following AI-generated answer: “Entity C.” Additionally, or alternatively, the prompt generator component 136 may retrieve from the prompt history 122, and include in the prompt 400, a second example prompt(s) and an incorrect AI-generated answer(s) to the second example prompt(s) (e.g., one or more negative examples). For example, the second example prompt may be the following prompt: “What company is “[alphanumeric string]?” In this example, the incorrect AI-generated answer to the second example prompt may be the following AI-generated answer: “Entity D.” In examples where the prompt generator component 136 dynamically inserts a negative example(s) of a past prompt(s) into the prompt 400, the prompt generator component 136 may include, in the prompt 400, a correct answer(s) to the example prompt(s) in order to show (e.g., retrain) the trained AI model(s) 138 how the prompt(s) could have been answered correctly. The determination, by the prompt generator component 136 of which positive and/or negative example(s) to retrieve from the prompt history 122 and to include in the prompt 400 may be based at least in part on a recency of the prompt (e.g., how long ago the past prompt was provided to the trained AI model(s) 138), a frequency and/or a number of times that the past prompt has been provided to the trained AI model(s) 138, a similarity between the transaction data 118 included in the past prompt and the transaction data 118 that is to be included in the current prompt 400 being generated, and/or the like. In some examples, generative AI (e.g., the trained AI model(s) 138) can be used to iterate on the verbiage used in past prompts to determine which prompt verbiage works better than other prompt verbiage, and the prompt generator component 136 may gravitate towards using the better prompt verbiage in future prompts over time. These and other technical solutions described herein can improve AI model performance, as compared to conventional AI model performance.

As shown in FIG. 4, the output 404 generated by the trained AI model(s) 138 based at least in part on the trained AI model(s) 138 processing the prompt 400 is in the form of a computer-readable object; namely, a JSON object. The JSON object included in the AI-generated output 404 includes the requested steps performed and/or reasoning for determining the attribute(s) of the transaction (e.g., the entity) from the portion of the transaction data 118. For example, the JSON object included in the AI-generated output 404 explains that a step performed by the trained AI model(s) 138 is to examine the abbreviation “XYZ” in the transaction data 118 (where “XYZ” is a generic placeholder for a real abbreviation), and that the reasoning is as follows: “The abbreviation ‘XYZ’ commonly stands a name of a company, which is a subsidiary of ‘Entity B’ . . . ” (where “Entity B” is a generic placeholder for a name of a real entity, such as a parent/holding company that provides insurance services to the user 102(1)). The JSON object included in the AI-generated output 404 further includes the AI-generated answer to the request 402(1), which, in the example of FIG. 4, is the following AI-generated answer: “‘company’: ‘Entity B.” In some examples, the AI-generated output 404 includes a confidence score to indicate how confident the trained AI model(s) 138 is in its answer to the request 402(1). In the example of FIG. 4, the trained AI model(s) is 80% confident that “Entity B” is the entity, other than the user 102, associated with the transaction.

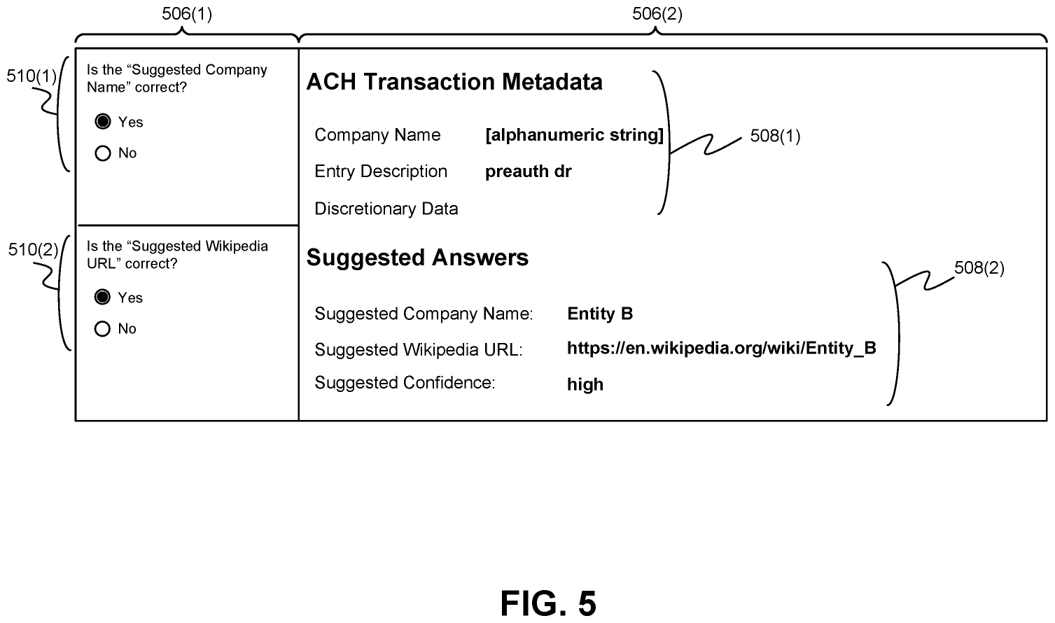

FIG. 5 is an example of validating output generated by a trained AI model(s) 138, according to an implementation of the present subject matter. In some examples, a user(s) and/or a software component(s) may be tasked with validating the output generated by a trained AI model(s) 138 as the trained AI model(s) 138 is used to process transaction data 118 that is received in a computer-readable format to determine one or more attributes of a transaction associated with a user 102 of the payment service 108, as described herein. This validation of AI-generated output may be part of a multi-stage filtering approach where, in a first stage, the transaction data processing component 134 determines the attribute(s) of the transaction based at least in part on the trained AI model(s) 138 processing a prompt(s) (e.g., the prompt 400) that includes a portion of the transaction data 118 received in the computer-readable format, and, in a second stage, the AI-generated attribute(s) is/are validated by the user(s) and/or the software component(s). This validation of AI-generated output may occur prior to the information indicative of the attribute(s) being presented via the payment application 106 executing on a user device 104 of the user 102 associated with the transaction. In this manner, oversight can be provided via the second stage of the multi-stage filtering approach to ensure that transaction attribute(s) is/are vetted, and that the information presented to the user 102 is accurate, thereby providing an accuracy boost.

In the example of FIG. 5, a prompt(s) (e.g., the prompt 400) may have been provided to the trained AI model(s) 138, the prompt(s) including a portion(s) of the transaction data 118 that represents a transaction associated with a user 102(1) of the users 102, and the transaction data processing component 134 may have determined an attribute(s) of the transaction based at least in part on the trained AI model(s) 138 processing the prompt(s). FIG. 5 illustrates information 508 indicative of the attribute(s) in both the computer-readable format and a user-readable format. For example, a second section 506(2) of FIG. 5 includes first information 508(1) indicative of the attribute(s) in the computer-readable format. In the example of FIG. 5, the first information 508(1) indicates that ACH transaction data 118(A) (e.g., ACH transaction metadata) includes a “company name” field with a first alphanumeric string 146, and an “entry description” field with a second alphanumeric string 146, such as: “preauth dr.” In other words, the first information 508(1) shows the transaction data 118 that was provided as input to the trained AI model(s) 138, wherein the input transaction data 118 is in the computer-readable format. The second section 506(2) of FIG. 5 includes second information 508(2) indicative of the transaction attribute(s) in the user-readable format. In the example of FIG. 5, the second information 508(2) indicates that the suggested answers determined using the trained AI model(s) 138 include the following “suggested company name”: Entity B, as well as the following “suggested Wikipedia URL”: https://en.wikipedia.org/wiki/Entity_B, which may be useful for retrieving a logo(s), graphics, colors, themes, etc. associated with the entity (e.g., Entity B, which is a generic placeholder for a name of a real entity, such as a company). In other words, the second information 508(2) shows the output generated by the trained AI model(s) 138, wherein the output is generated in a user-readable format. In some examples, the second information 508(2) further indicates a “suggested confidence” of the suggested answers determined using the trained AI model(s) 138. In the example of FIG. 5, the second information 508(2) indicates the following “suggested confidence”: high, which means that the trained AI model(s) 138 is fairly confident in its answers.

A user(s) and/or a software program(s) can analyze the first information 508(1) indicative of the transaction attribute(s) in the computer-readable format, and compare the first information 508(1) to the second information 508(2) indicative of the transaction attribute(s) in the user-readable format to validate the output generated by the trained AI model(s) 138. In some examples, a software program(s) may have access to reference data (e.g., data regarding past determinations of transaction attributes, etc.) and/or the software program(s) may be configured to scrape websites and/or other databases for information that can be used for automated validation of the transaction attribute(s) output by the trained AI model(s) 138. A first section 506(1) of indicates that the user(s) and/or software program(s) validated the output generated by the trained AI model(s) 138. That is, the first section 506(1) may indicate whether the user(s) and/or software program(s) confirmed that the attribute(s) determined using the trained AI model(s) 138 is/are correct, or to denied that the attribute(s) determined using the trained AI model(s) 138 is/are correct. In the example of FIG. 5, the first section 506(1) includes a first question 510(1) (e.g., a Yes or No question, such as the following question: “Is the ‘Suggested Company Name’ correct?”). In the example of FIG. 5, this first question 510(1) is provided with one of two answers: (i) a “Yes” answer, or (ii) a “No” answer. A “Yes” answer indicates that the user(s) and/or software program(s) confirmed that the transaction attribute(s) referenced in the first question 510(1) and determined using the trained AI model(s) 138 is/are correct. On the other hand, a “No” answer indicates that the user(s) and/or software program(s) denied that the transaction attribute(s) referenced in the first question 510(1) and determined using the trained AI model(s) 138 is/are correct.

If the user(s) and/or software program denies that the transaction attribute(s) determined using the trained AI model(s) 138 is/are correct, this denial may trigger a process to correct the error in the AI-generated output. For example, a “No” answer to the first question 510(1) may cause the user(s) and/or software program(s) to be prompted for the correct company name. In some examples, if the user(s) and/or software program(s) provides the correct company name in response to the prompt, the association component 140 may store, in the data store(s) 114, an association between the portion(s) of the transaction data 118 (e.g., the alphanumeric string 146 in the “company name” field in the second section 506(2) of FIG. 5) and the correct company name to create a new mapping in the data store(s) 114 that can be subsequently looked-up if the same transaction data 118 is received by the payment service computing platform (e.g., the server(s) 110) in the future. Additionally, or alternatively, the training component 142 may retrain the trained AI model(s) 138 based at least in part on the association stored in the data store(s) 114 and/or based on the incorrect answer generated by the trained AI model(s) 138 (e.g., so that the trained AI model(s) 138 learns how to avoid providing an incorrect answer in the future). If the user(s) and/or software program confirms that the transaction attribute(s) determined using the trained AI model(s) 138 is/are correct, similar operations can be performed. For example, the association component 140 may store, in the data store(s) 114, an association between the portion of the transaction data 118 (e.g., the alphanumeric string 146 in the “company name” field in the second section 506(2) of FIG. 5) and the company name determined using the trained AI model(s) 138 (e.g., “Entity B”) to create a new mapping in the data store(s) 114 that can be subsequently looked-up if the same transaction data 118 is received by the payment service computing platform (e.g., the server(s) 110) in the future. Additionally, or alternatively, the training component 142 may retrain the trained AI model(s) 138 based at least in part on the association stored in the data store(s) 114 and/or based on the correct answer generated by the trained AI model(s) 138 (e.g., to reinforce the ability of the trained AI model(s) 138 to provide correct answers in the future).

In the example of FIG. 5, the first section 506(1) also includes a second question 510(2) (e.g., a Yes or No question, such as the following question: “Is the ‘Suggested Wikipedia URL’ correct?”). In the example of FIG. 5, this second question 510(2) is also provided with one of two answers: (i) a “Yes” answer, or (ii) a “No” answer. A “Yes” answer indicates that the user(s) and/or software program confirmed that the transaction attribute(s) referenced in the second question 510(2) and determined using the trained AI model(s) 138 is/are correct. On the other hand, a “No” answer indicates that the user(s) and/or software program denied that the transaction attribute(s) referenced in the second question 510(2) and determined using the trained AI model(s) 138 is/are correct. Similar operations to those described above can be performed depending on whether the user(s) and/or software program confirmed or denied that the transaction attribute(s) referenced in the second question 510(2) is/are correct. For example, the association component 140 may store an association in the data store(s) 114 and/or the training component 142 may retrain the trained AI model(s) 138 based at least in part on answer to the second question 510(2).

Additionally, or alternatively, if the user(s) and/or software program confirms that the transaction attribute(s) determined using the trained AI model(s) 138 is/are correct, the payment service computing platform (e.g., the server(s) 110) may cause information (e.g., the information 132 shown in FIG. 1, the information 204 shown in FIG. 2B, the information 302 shown in FIG. 3, etc.) to be presented via the payment application 106 executing on a user device 104 of the user 102(1) associated with the transaction. In other words, the payment service computing platform (e.g., the server(s) 110) may wait to receive confirmation that the transaction attribute(s) determined using the trained AI model(s) 138 is/are correct before presenting information indicative of the transaction attribute(s) to the user 102(1) of the payment application 106, thereby increasing the likelihood that the information presented to the user 102(1) is accurate.

The user interfaces 130, 200B, and 300 are provided as examples of user interfaces that can be presented to facilitate techniques described herein. User interfaces can present additional or alternative data in additional or alternative configurations. That is, user interfaces 130, 200B, and 300 should not be construed as limiting.

The processes described herein are illustrated as a collection of blocks in a logical flow graph, which represent a sequence of operations that can be implemented in hardware, software, or a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes.

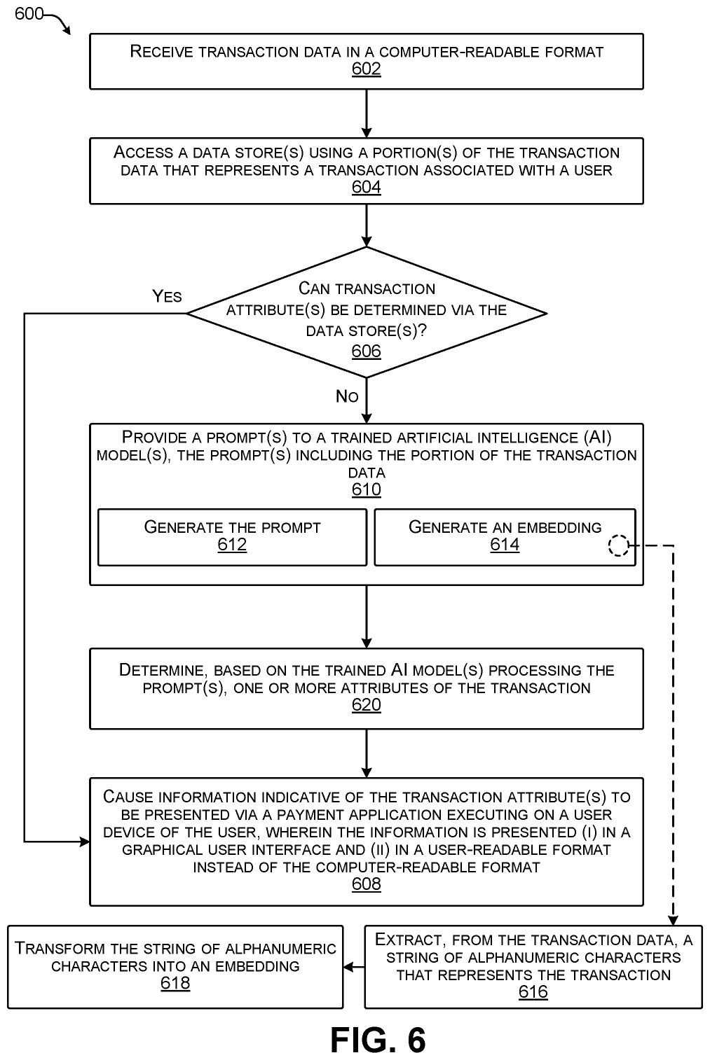

FIG. 6 is an example process 600 for presenting information indicative of one or more attributes of a transaction in a user-readable format, according to an implementation of the present subject matter. The process 600 is illustrated as a collection of blocks in a logical flow graph, which represent a sequence of operations that can be implemented in hardware, software, or a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process 600. The process 600 can be implemented by a system including one or more processors and memory storing computer-executable instructions to cause the one or more processors to perform the process 600. In some examples, the process 600 can be implemented by a processing device(s) (e.g., a computing system and/or a server(s) 110 of the payment service computing platform). For discussion purposes, the process 600 is described with reference to the previous figures.

At 602, transaction data 118 associated with users 102 of a payment application 106 is received in a computer-readable format. In some examples, the payment service computing platform (e.g., a server(s) 110) may receive the transaction data 118 in the computer-readable format at block 602. In some examples, the transaction data 118 received at block 602 includes ACH transaction data 118(A) that represents ACH transactions associated with the users 102, card transaction data 118(B) that represents card transactions associated with the users 102, a combination thereof, and/or another type of transaction data 118. In some examples, the payment service computing platform (e.g., the server(s) 110) may receive, at block 602, ACH transaction data 118(A) in a first computer-readable format and/or card transaction data 118(B) in a second computer-readable format different than the first computer-readable format. In other words, the ACH transaction data 118(A) and the card transaction data 118(B) may be formatted differently, and either or both types of transaction data 118 may be received at block 602. Accordingly, the transaction data 118 may be received at block 602 in at least one of a first computer-readable format and/or a second computer-readable format different than the first computer-readable format. In some examples, the transaction data 118 received at block 602 may include one or more strings 146 of alphanumeric characters, such as one or more of the example strings 146 shown in Table 1, above, with respect to the ACH transaction data 118(A). Such strings 146 may be heavily abbreviated (e.g., with several vowels omitted), concatenated, obscured, and/or the like, and/or the strings 146 of alphanumeric characters may include additional descriptive data that is unintelligible, as described herein.

At 604, in some examples, a data store(s) 114 is accessed using a portion(s) of the transaction data 118(1) received at block 602, the portion(s) of the transaction data 118(1) representing a transaction associated with a user 102(1) of the users 102. In some examples, the payment service computing platform (e.g., the server(s) 110) may access the data store(s) 114 at block 604. In an example, the portion(s) of the transaction data 118(1) may represent, or include, a string(s) 146 of alphanumeric characters. This string(s) 146 may represent the transaction associated with the user 102(1). For example, the portion(s) of the transaction data 118(1) may represent, or include, the string 146 “RAISER 6795.” In this example, the data store(s) 114 may be accessed at block 604 using the string 146 (e.g., “RAISER 6795”) to lookup transaction attribute(s) that are associated with this portion of the transaction data 118(1), if the association data 120 in the data store(s) 114 even includes such an association(s). In some examples, the association data 120 stores associations between transaction data 118 and various transaction attributes, such as types of transactions (e.g. a paycheck, a tax refund, a mortgage payment, a card transaction, a transaction using the payment application 106, etc.), entities, other than the user 102(1), associated with the transaction, such as companies, merchants, and/or other users associated with P2P payments to/from the user 102(1), etc.

Accordingly, at 606, a determination is made as to whether an association(s) between the portion(s) of the transaction data 118(1) and one or more transaction attributes is stored in the data store(s) 114. In some examples, the payment service computing platform (e.g., the server(s) 110) may determine whether the association(s) is stored in the data store(s) 114 at block 606. If it is determined that an association(s) between the portion(s) of the transaction data 118(1) and one or more transaction attributes is stored in the data store(s) 114, the process 600 may follow the YES route from block 606 to block 608.

At 608, information indicative of the transaction attribute(s) is caused to be presented via the payment application 106 executing on a user device 104 of the user 102(1), wherein the information is presented (i) in a graphical user interface and (ii) in a user-readable format instead of the computer-readable format. In some examples, the payment service computing platform (e.g., the server(s) 110) may cause the information to be presented via the payment application 106 at block 608. An example of the information that may be presented at block 608 is the information 132 presented in the user interface 130 (e.g., a graphical user interface) depicted in FIG. 1. Another example of the information that may be presented at block 608 is the information 204 presented in the user interface 200B (e.g., a graphical user interface) depicted in FIG. 2B. Yet another example of the information that may be presented at block 608 is the information 302 presented in the user interface 300 (e.g., a graphical user interface) depicted in FIG. 3. In these examples, the information is presented in the user-readable format, which is easy for the user 102(1) to understand.

In some examples, if the process 600 follow the YES route from block 606 to block 608 (e.g., if it is determined that an association(s) between the portion(s) of the transaction data 118(1) and one or more transaction attributes is stored in the data store(s) 114), the process 600 may utilize generative AI (e.g., a trained AI model(s) 138) process (e.g., enhance) the data retrieved from the data store(s) 114, such as by generating other (e.g., updated) transaction attributes, such as when the data retrieved from the data store(s) 114 becomes “stale” or outdated. For instance, an entity (e.g., company) may rebrand their logo, their color scheme, and/or the like, and/or new types of transactions may be determined based on the output of a trained AI model(s) 138 processing a prompt that includes the portion(s) of the transaction data 118(1). Additionally, or alternatively, some of the transaction data 118(1) may be stored in the data store(s) 114, while a remainder of the transaction data 118(1) may not be stored in the data store(s) 114. In these examples, any transaction data 118(1) that is not already stored in the data store(s) 114 may be processed (e.g., analyzed) using the trained AI model(s) 138, as described herein (e.g., by performing blocks 610 and 620 on the transaction data 118(1) that is not already stored in the data store(s) 114, as described below).

Returning to block 606, if it is determined that an association(s) between the portion(s) of the transaction data 118(1) and one or more transaction attributes is not stored in the data store(s) 114, the process 600 may follow the NO route from block 606 to block 610 where a prompt(s) is provided to a trained AI model(s) 138, the prompt(s) including the portion(s) of the transaction data 118(1) that represents the transaction associated with the user 102(1). In some examples, the payment service computing platform (e.g., the server(s) 110) may provide the prompt(s) to the trained AI model(s) 138 at block 610. For instance, in the running example, the prompt(s) may include the string 146 “RAISER 6795.” In some examples, the trained AI model(s) 138 may be configured to process prompts that include transaction data 118 in a first computer-readable format (e.g., ACH transaction data 118(A)) and prompts that include transaction data 118 in a second computer-readable format (e.g., card transaction data 118(B)), wherein the first and second computer-readable formats are different. In other words, the trained AI model(s) 138 may be “multi-lingual” in its ability to interpret transaction data in multiple different computer-readable formats. In some examples, multiple different trained AI model(s) 138 are utilized to process transaction data 118 in each of the respective computer-readable formats.

At 612, in some examples, the prompt(s) may be generated by including in the prompt(s) particular requests and/or examples of past prompts for the trained AI model(s) 138. For example, the prompt generator component 136 may generate the prompt(s) at block 612 by including in the prompt(s) one or more requests for the trained AI model(s) 138. As an example, a request 402(1) for the trained AI model(s) 138 to determine the transaction attribute(s) from the portion(s) of the transaction data 118(1) may be included in the prompt(s) at block 612. This request 402(1), for example, may be a request 402(1) for the trained AI model(s) 138 to determine an entity, other than the user 102(1), associated with the transaction, such as the following request 402(1): “What company is ‘RAISER 6795’ ?” It is to be appreciated, however, that the request 402(1) included in the prompt(s) may be a request 402(1) for the trained AI model(s) 138 to determine any other suitable transaction attribute(s), such as the type of the transaction. As another example, a request 402(2) for the trained AI model(s) 138 to explain steps performed and/or reasoning for determining the transaction attribute(s) from the portion(s) of the transaction data 118(1) may be included in the prompt(s) at block 612. Including such a request 402(2) in the prompt(s) can improve AI model performance. As yet another example, a request 402(3) for the trained AI model(s) 138 to provide a computer-readable object as output may be included in the prompt(s) at block 612. In this example, the computer-readable object may be a JSON object, or any other suitable type of computer-readable object. An example prompt 400 with these requests 402(1)-(3) is shown in FIG. 4. In some examples, the prompt generator component 136 may generate the prompt(s) at block 612 by including in the prompt(s) one or more examples of past prompts and AI-generated answers to those past prompts. For example, the prompt history 122 maintained in the data store(s) 144 may include examples of past prompts where the trained AI model(s) 138 determined correct answers to those prompts (sometimes referred to herein as “positive examples”) and/or examples of past prompts where the trained AI model(s) 138 determined incorrect answers to those prompts (sometimes referred to herein as “negative examples”). To illustrate, the prompt generator component 136 may retrieve from the prompt history 122, and include in the prompt(s) at block 612, a first example prompt(s) and a correct AI-generated answer(s) to the first example prompt(s) (e.g., one or more positive examples), and/or the prompt generator component 134 may retrieve from the prompt history 122, and include in the prompt(s) at block 612, a second example prompt(s) and an incorrect AI-generated answer(s) to the second example prompt(s) (e.g., one or more negative examples). This can also improve AI model performance, as compared to conventional AI model performance.

At 614, in some examples, an embedding(s) 124 may be generated for the trained AI model(s) 138 to process. In some examples, generating the embedding(s) 124 at block 614 may include, at block 616, extracting, from the transaction data 118 received at block 602, a string(s) 146 of alphanumeric characters that represents the transaction associated with the user 102(1), and, at block 618, transforming the string(s) 146 of alphanumeric characters into the portion(s) of the transaction data 118(1) as the embedding(s) 124. The embedding(s) 124 generated at block 614 may include a string of numbers, a vector of numbers, and/or an array of numbers, and/or the embedding(s) 124 may be derived from parameters and/or weights of the trained AI model(s) 138. This embedding approach may lead to better AI model performance, as compared to conventional AI model performance. In some examples, the embedding(s) 124 can be fed back into the trained AI model(s) 138 by the training component 142 for purposes of retraining the trained AI model(s) 138 to further enhance or otherwise improve the AI model performance.

At 620, one or more attributes of the transaction are determined based at least in part on the trained AI model(s) 138 processing the prompt(s). In some examples, the payment service computing platform (e.g., the server(s) 110) may determine the transaction attribute(s) at block 620 based at least in part on the output generated by the trained AI model(s) 138. The transaction attribute(s) determined at block 620 may include a type of the transaction (e.g., a paycheck, a tax refund, a mortgage payment, a card transaction, a transaction using the payment application 106, etc.), an entity, other than the user 102(1), associated with the transaction (e.g., a company, a merchant, another user 102 who received a P2P payment from the user 102(1) or who sent the P2P payment to the user 102(1), etc.), and/or any other suitable attribute of the transaction. In some examples, the AI-generated output (which is the basis for the determination of the transaction attribute(s) at block 620) may be suitable for a computer-centric environment. For example, the trained AI model(s) 138 may generate output, such as the output 404 shown in FIG. 4, or a similar type of output. In the running example, the trained AI model(s) 138 may generate a JSON object that includes “company”: Entity A. This AI-generated output (e.g., the computer-readable object, such as the JSON object) may be parsed by the payment service computing platform (e.g., the server(s) 110) to determine the transaction attribute(s) at block 620, which are to be presented to the user 102(1) associated with the transaction at block 608.

Following block 620, the process 600 may proceed to block 608 where information indicative of the transaction attribute(s) is caused to be presented via the payment application 106 executing on a user device 104 of the user 102(1), wherein the information is presented (i) in a graphical user interface and (ii) in a user-readable format instead of the computer-readable format, as described above. In some examples, the information is presented at block 608 in a graphical user interface that is associated with an activity feed, a statement, or a receipt. For example, the user interface 130 (e.g., a graphical user interface) depicted in FIG. 1, and/or the user interface 200B (e.g., a graphical user interface) depicted in FIG. 2B are examples of user interfaces associated with a statement or a receipt. As another example, the user interface 300 (e.g., a graphical user interface) depicted in FIG. 3 may represent a user interface associated with an activity feed. In some examples, the information that is presented at block 608 includes a logo(s) associated with the transaction attribute(s) (e.g., a logo(s) of an entity, other than the user 102(1), associated with the transaction, such as a company logo, a merchant logo, etc.), a background color(s) and/or a theme that is associated with the transaction attribute(s) (e.g., a trademark color scheme of an entity, other than the user 102(1), associated with the transaction). In some examples, at least some of this information (e.g., logo data, trademark data, color data, etc.) is stored in the data store(s) 114 and is retrieved in order to present at least some of the information at block 608.

It is to be appreciated that, in the process 600, one or more first attributes of the transaction may be determined by accessing the data store(s) 114 and one or more second attributes of the same transaction may be determined using the trained AI model(s) 138 at blocks 610 and 620 (and potentially the sub-blocks thereof). For example, a first portion of the transaction data 118 received at block 602 may be used to access the data store(s) 114 to determine a first attribute of the transaction, and a second portion of the transaction data 118 received at block 602 may be included in the prompt(s) provided to the trained AI model(s) 138 at block 610 to determine a second attribute of the transaction. In this example, both portions of the transaction data 118 are associated with the same transaction, but the first portion of the transaction data 118 is used to quickly and/or efficiently lookup the first transaction attribute(s), while the second portion of the transaction data 118 is used to determine the second transaction attribute(s) using the trained AI model(s) 138.

In some examples, multiple different attributes of the transaction may be determined using multiple different trained AI models 138 in the process 600. For example, a first portion of the transaction data 118 received at block 602 may be processed by a first trained AI model(s) 138 (e.g., a generative AI model, such as a LLM) to determine a first attribute(s) of the transaction, and a second portion of the transaction data 118 received at block 602 may be processed by a second trained AI model(s) 138 (e.g., a classifier) to determine a second attribute(s) of the transaction. In this example, both portions of the transaction data 118 are associated with the same transaction, but the first portion of the transaction data 118 is processed by the first trained AI model(s) 138 (e.g., a LLM) to determine the first transaction attribute(s) (e.g., an entity, other than the user 102(1), associated with the transaction), while the second portion of the transaction data 118 is processed by the second trained AI model(s) 138 (e.g., a classifier) to determine the second transaction attribute(s) (a type of the transaction).

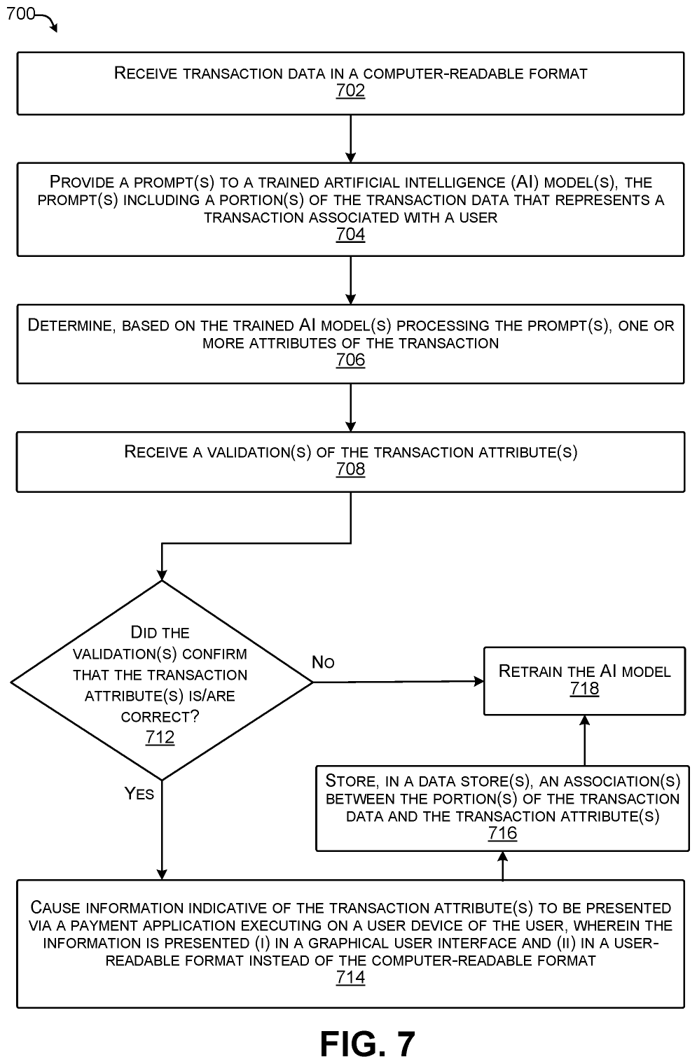

FIG. 7 is an example process 700 for processing transaction data based at least in part on validating AI output as part of a multi-stage filtering approach, according to an implementation of the present subject matter. The process 700 is illustrated as a collection of blocks in a logical flow graph, which represent a sequence of operations that can be implemented in hardware, software, or a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process 700. The process 700 can be implemented by a system including one or more processors and memory storing computer-executable instructions to cause the one or more processors to perform the process 700. In some examples, the process 700 can be implemented by a processing device(s) (e.g., a computing system and/or a server(s) 110 of the payment service computing platform). For discussion purposes, the process 700 is described with reference to the previous figures.

At 702, transaction data 118 associated with users 102 of a payment application 106 is received in a computer-readable format. In some examples, the payment service computing platform (e.g., a server(s) 110) may receive the transaction data 118 in the computer-readable format at block 702, and the operations performed at block 702 may be the same as, or similar to, the operations described above with reference to block 602 of the process 600.

At 704, a prompt(s) is provided to a trained AI model(s) 138, the prompt(s) including a portion of the transaction data 118(1) that represents a transaction associated with a user 102(1) of the users 102. In some examples, the payment service computing platform (e.g., the server(s) 110) may provide the prompt(s) to the trained AI model(s) 138 at block 704, and the operations performed at block 704 may be the same as, or similar to, the operations described above with reference to block 610 of the process 600.

At 706, one or more attributes of the transaction are determined based at least in part on the trained AI model(s) 138 processing the prompt(s). In some examples, the payment service computing platform (e.g., the server(s) 110) may determine the transaction attribute(s) at block 706 based at least in part on the output generated by the trained AI model(s) 138, and the operations performed at block 706 may be the same as, or similar to, the operations described above with reference to block 620 of the process 600. Blocks 702 to 706 of the process 700 may represent a first stage of a multi-stage filtering approach where, in the first stage, the attribute(s) of the transaction are determined based at least in part on the trained AI model(s) 138 processing a prompt(s) that includes a portion of the transaction data 118(1) received in the computer-readable format.

At 708, a validation(s) of the transaction attribute(s) determined using the trained AI model(s) 138 is/are received. In some examples, the payment service computing platform (e.g., the server(s) 110) may receive the validation(s) of the transaction attribute(s) at block 708. An example of the validation(s) received at block 708 is depicted in FIG. 5. For example, the validation(s) received at block 708 may be based at least in part on an answer(s) to the question(s) 510 shown in FIG. 5, as described above.

At 712, a determination is made as to whether the validation(s) confirm that the transaction attribute(s) determined using the trained AI model(s) 138 is/are correct. In some examples, the payment service computing platform (e.g., the server(s) 110) may make the determination at block 712 based at least in part on the validation(s) received at block 708. For example, the server(s) 110 may receive, at block 708, a confirmation that the transaction attribute(s) is/are correct based at least in part on a user(s) and/or software program answering yes to a question 510, as shown in FIG. 5, for example. If a confirmation that the transaction attribute(s) is/are correct is received at block 708, resulting in a determination in the affirmative at block 712, the process 700 may follow the YES route from block 712 to block 714.

At 714, information indicative of the transaction attribute(s) is caused to be presented via the payment application 106 executing on a user device 104 of the user 102(1) associated with the transaction, wherein the information is presented (i) in a graphical user interface and (ii) in a user-readable format instead of the computer-readable format, as described above. In some examples, the payment service computing platform (e.g., the server(s) 110) may cause the information to be presented via the payment application 106 at block 714, and the operations performed at block 714 may be the same as, or similar to, the operations described above with reference to block 608 of the process 600. Accordingly, blocks 708 to 712 of the process 700 may represent a second stage of a multi-stage filtering approach where, in the second stage, the AI-generated attribute(s) is/are validated by a user(s) and/or a software program(s). This validation of AI-generated output may occur prior to the information indicative of the transaction attribute(s) being presented at block 714 via the payment application 106 executing on a user device 104 of the user 102(1) associated with the transaction. In this manner, oversight can be provided to ensure that the information presented to the user 102 is accurate.

At 716, following the presentation of the information at block 714, an association(s) between the portion(s) of the transaction data 118(1) and the transaction attribute(s) (determined using the trained AI model(s) 138 and subsequently validated at blocks 708-712) is/are stored in a data store(s) 114. Alternatively, the association(s) may be stored in the data store(s) 114 prior to, or contemporaneously with, the presentation of the information at block 714. In some examples, the payment service computing platform (e.g., the server(s) 110) may store the association(s) in the data store(s) 114 as new association data 120 at block 716 to create a new mapping(s) between the portion(s) of the transaction data 118(1) and the transaction attribute(s) determined using the trained AI model(s) 138.

At 718, the trained AI model(s) 138 may be retrained based at least in part on the association(s) between the portion(s) of the transaction data 118(1) and the transaction attribute(s) (determined using the trained AI model(s) 138 and subsequently validated at blocks 708-712). For example, the training component 142 may retrain the trained AI model(s) 138 at block 718 by updating parameters and/or weightings and/or thresholds utilized by the trained AI model(s) 138. In some examples, reinforcement learning techniques are utilized at block 718.

Returning to block 712, if a denial that the transaction attribute(s) is/are correct is received at block 708, resulting in a determination in the negative at block 712, the process 700 may follow the NO route from block 712 to block 718 where the trained AI model(s) 138 can be retrained, as described above, except that the trained AI model(s) 138 may learn, from the denial received at block 708, how to avoid generating incorrect transaction attributes. In an example, the server(s) 110 may receive a denial that the transaction attribute(s) is/are correct based at least in part on a user(s) and/or software program(s) answering no to a question 510 shown in FIG. 5, for example, and this data can be used to retrain the AI model(s) 138 to improve AI model performance in the future. In some examples, if a denial that the transaction attribute(s) is/are correct is received at block 708, resulting in a determination in the negative at block 712, a process to correct the error in the AI-generated output may be triggered or may otherwise commence. For example, if a denial that the transaction attribute(s) is/are correct is received at block 708, resulting in a determination in the negative at block 712, a user and/or software program may be prompted to provide a correct answer(s) (e.g., a correct entity, such as a company name, a merchant name, etc.). If a correct answer(s) is provided in this scenario, the association component 140 may store, in the data store(s) 114, an association(s) between the portion(s) of the transaction data 118 and the correct information to create a new mapping(s) in the data store(s) 114 that can be subsequently looked-up if the same transaction data 118 is received by the payment service computing platform (e.g., the server(s) 110) in the future.

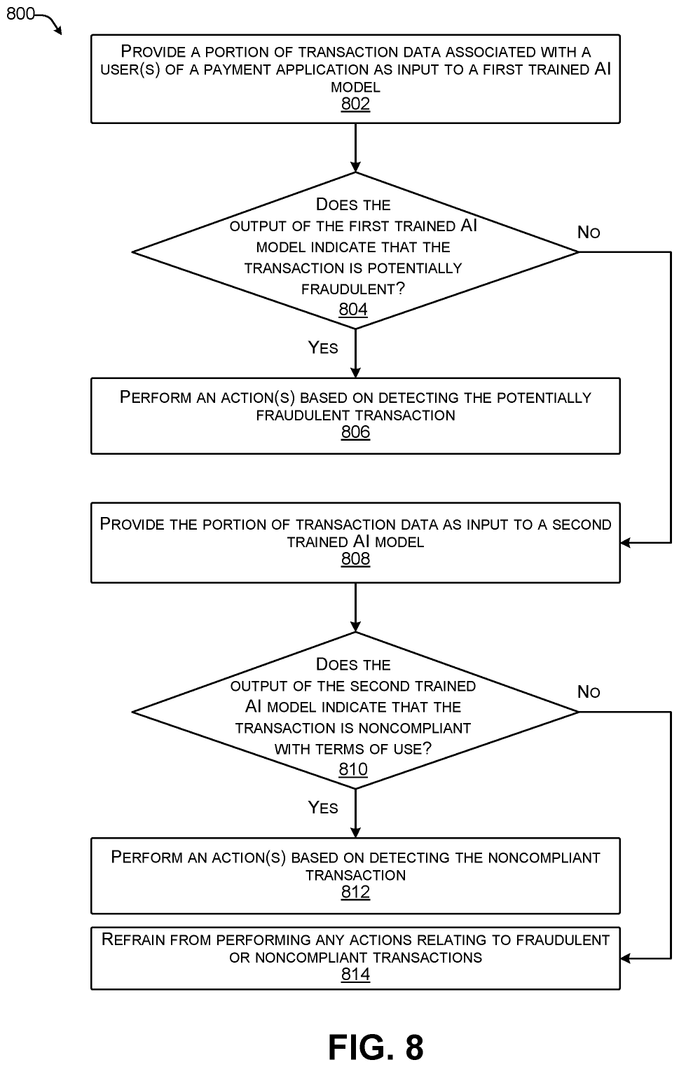

The examples described above relate, in part, to using a trained AI model(s) 138 to generate transaction attribute(s). The example process 800 of FIG. 8, described below, relates to using a trained AI model(s) 138 to detect fraudulent and/or noncompliant transactions. As noted above, in conventional systems, fraudulent transactions may avoid detection, or may be detected after it is too late to take any meaningful remedial action with respect to the fraudsters behind the illegitimate transactions. This may be due, at least in part, to the obfuscated nature of transaction data 118 that is received in the computer-readable format, as described above. The techniques, devices, and systems described herein can utilize a trained AI model(s) 138 to process transaction data 118 that is received in the computer-readable format to determine whether a transaction is potentially fraudulent and/or noncompliant. In some examples, a potentially fraudulent transaction may be detected by the trained AI model(s) 138 determining that a deposit(s) of funds to an account (e.g., spending account, savings account, investing account, cryptocurrency account, etc.) associated with a user 102 is anomalous or otherwise out-of-the-ordinary. When a potentially fraudulent and/or noncompliant transaction is detected using AI, as described herein, a remedial action(s) can be performed, such as flagging the transaction for review by an authorized user, suspending an account of the user 102 suspected of fraud, notifying the user 102 suspected of non-compliance with terms of use, and/or prohibiting completion of the transaction in real-time. Thus, fraud on the payment service computing platform can be mitigated, and/or compliance with terms of use of the payment application 106 can be improved, providing additional technical benefit because the payment service computing platform is not burdened with processing as many transactions that are fraudulent, non-compliant, or otherwise illegitimate, thereby conserving resources for processing more legitimate transactions.

FIG. 8 is an example process 800 for using AI to detect potentially fraudulent transactions and/or transactions that are noncompliant with terms of use of a payment application 106, according to an implementation of the present subject matter. The process 800 is illustrated as a collection of blocks in a logical flow graph, which represent a sequence of operations that can be implemented in hardware, software, or a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process 800. The process 800 can be implemented by a system including one or more processors and memory storing computer-executable instructions to cause the one or more processors to perform the process 800. In some examples, the process 800 can be implemented by a processing device(s) (e.g., a computing system and/or a server(s) 110 of the payment service computing platform). For discussion purposes, the process 800 is described with reference to the previous figures.

At 802, at least a portion of transaction data 118 associated with one or more users 102 of a payment application 106 is provided as input to a first trained AI model(s) 138. In some examples, the payment service computing platform (e.g., a server(s) 110) may provide the portion of the transaction data 118 as input to the first trained AI model(s) 138 at block 802. In some examples, the portion of the transaction data 118 is associated with a transaction(s) of the user(s) 102. For example, the portion of the transaction data 118 provided as input to the first trained AI model(s) 138 at block 802 may include ACH transaction data 118(A) that represents an ACH transaction(s) associated with the user(s) 102, card transaction data 118(B) that represents a card transaction(s) associated with the user(s) 102, a combination thereof, and/or another type of transaction data 118. In some examples, the portion of the transaction data 118 provided as input to the first trained AI model(s) 138 at block 802 is in a computer-readable format, as described above. For instance, the transaction data 118 provided as input to the first trained AI model(s) 138 at block 802 may include one or more strings 146 of alphanumeric characters, such as one or more of the example strings 146 shown in Table 1, above, with respect to the ACH transaction data 118(A). Such strings 146 may be heavily abbreviated (e.g., by omitting several vowels), concatenated, obscured, and/or the like, and/or the strings 146 of alphanumeric characters may include additional descriptive data that is unintelligible, as described herein.

At 804, based at least in part on the first trained AI model(s) 138 processing the portion of the transaction data 118, a determination is made as to whether the transaction is potentially fraudulent. In some examples, the payment service computing platform (e.g., the server(s) 110) may determine whether the transaction is potentially fraudulent at block 804, such as by executing the fraud and compliance component 144 depicted in FIG. 1. In some examples, a determination that the transaction is potentially fraudulent at block 804 includes determining that the transaction represents an anomalous deposit of funds to a spending account (or another type of account, such as a savings account, investing account, cryptocurrency account, etc.) associated with the user 102. For example, the deposit may be for an anomalous amount of funds, and/or the deposit may have been made on an anomalous day of the week, at an anomalous time of day, at an anomalous geographic location, from an anomalous user device 104, and/or the like. In some examples, the output of the first trained AI model(s) 138 may be a classification as one of multiple class labels (e.g., fraudulent or legitimate). In some examples, the output of the first trained AI model(s) 138 may be in the form of text that indicates whether the transaction is potentially fraudulent or legitimate. If, at block 804, it is determined that the transaction is potentially fraudulent, the process 800 may follow the YES route from block 804 to block 806.

At 806, an action(s) (e.g., a remedial action) is performed based at least in part on detecting the potentially fraudulent transaction using the first trained AI model(s) 138. In some examples, the payment service computing platform (e.g., the server(s) 110) may perform the action(s), or otherwise cause the action(s) to be performed, at block 806. In some examples, performing the action(s) at block 806 includes flagging the transaction for review by an authorized user, suspending an account of the user 102 suspected of fraud, notifying the user 102 suspected of fraud, and/or prohibiting completion of the transaction in real-time. In some examples, the payment service computing platform (e.g., the server(s) 110) may cause an alert to be presented via a display of a user device of an authorized user to review the transaction for fraud. In this way, the authorized user can provide oversight on transactions that are flagged as potentially fraudulent and mitigate fraud on the payment service computing platform.

If it is determined, at block 804, that the transaction is not potentially fraudulent, the process 800 may follow the NO route from block 804 to block 808. At 808, the portion of the transaction data 118 is provided as input to a second trained AI model(s) 138. In some examples, the payment service computing platform (e.g., the server(s) 110) may provide the portion of the transaction data 118 as input to the second trained AI model(s) 138 at block 808.

At 810, based at least in part on the second trained AI model(s) 138 processing the portion of the transaction data 118, a determination is made as to whether the transaction is noncompliant with terms of use of the payment application 106. In some examples, the payment service computing platform (e.g., the server(s) 110) may determine whether the transaction is noncompliant with terms of use of the payment application 106 at block 810, such as by executing the fraud and compliance component 144 depicted in FIG. 1. In some examples, the terms of use of the payment application 106 specify particular types of transactions as noncompliant, such as gambling transactions, transactions associated with illegal drugs and/or other types of transactions. In some examples, the output of the second trained AI model(s) 138 may be a classification as one of multiple class labels (e.g., noncompliant or compliant). In some examples, the output of the second trained AI model(s) 138 may be in the form of text that indicates whether the transaction is noncompliant or compliant with the terms of use of the payment application 106. If, at block 810, it is determined that the transaction is noncompliant with the terms of use of the payment application 106, the process 800 may follow the YES route from block 810 to block 812.

At 812, an action(s) (e.g., a remedial action) is performed based at least in part on detecting the noncompliant transaction using the second trained AI model(s) 138. In some examples, the payment service computing platform (e.g., the server(s) 110) may perform the action(s), or otherwise cause the action(s) to be performed, at block 812. In some examples, performing the action(s) at block 812 includes flagging the transaction for review by an authorized user, suspending an account of the user 102 suspected of not complying with the terms of use, notifying the user 102 suspected of not complying with the terms of use, and/or prohibiting completion of the transaction in real-time. In some examples, the payment service computing platform (e.g., the server(s) 110) may cause an alert to be presented via a display of a user device of an authorized user to review the transaction for noncompliance with the terms of use of the payment application 106. In this way, the authorized user can provide oversight on transactions that are flagged as noncompliant with the terms of use and improve compliance with the terms of use of the payment application 106 on the payment service computing platform.

If it is determined, at block 810, that the transaction is compliant with the terms of use of the payment application 106, the process 800 may follow the NO route from block 810 to block 814. At 814, the payment service computing platform (e.g., the server(s) 110) may refrain from performing any actions relating to fraudulent or noncompliant transactions. In some examples, refraining from performing such actions may be in the context of processing the portion of the transaction data 118 to generate transaction attribute(s) associated with the transaction, as described above (e.g., via implementing the process 600 of FIG. 6 and/or the process 700 of FIG. 7). It is also to be appreciated that blocks 802 to 806 and 814 may be performed independently of blocks 808 to 814, or vice versa. In other words, a transaction(s) can be evaluated for potential fraud without evaluating the transaction(s) for compliance with terms of use of the payment application 106, or vice versa. FIG. 8 is an example of evaluating a transaction(s) for both potential fraud and compliance with terms of use of the payment application 106.

It is also to be appreciated that a transaction(s) can be evaluated using generative AI (e.g., using a trained AI model(s) 138 to process transaction data 118) for other purposes. For example, generative AI may be used to generate budgeting labels, which can be output to a user(s) 102 associated with the transaction(s). For example, the payment application 106 may provide users 102 with budgeting tools to help them plan for future expenditures and/or achieve financial milestones. In this context, a trained AI model(s) 138 may be used to process transaction data 118 to generate a label associated with the transaction for budgeting purposes, such as indicating a remaining amount of funds allocated to a particular budget of a user 102 associated with the transaction. In some examples, the budgeting label(s) generated by the trained AI model(s) 138 based on the transaction data 118 may be customized for a particular user 102. For example, the trained AI model(s) 138 may process the transaction data 118 and budget data associated with a particular user 102 to generate custom budgeting labels for that particular user 102, which are unique to the user's 102 budget and/or financial goals. In some examples, generative AI may be used to generate expense classifications and/or expense codes for budgeting. For example, a user 102 may be conducting transactions in the scope of their work for an employer and may wish to expense the transactions so that the user 102 can be reimbursed by their employer. In these examples, the trained AI model(s) 138 may be configured to classify transactions as an expenses and/or generate expense codes so that a user can easily submit the AI-generated expense codes for getting reimbursed.

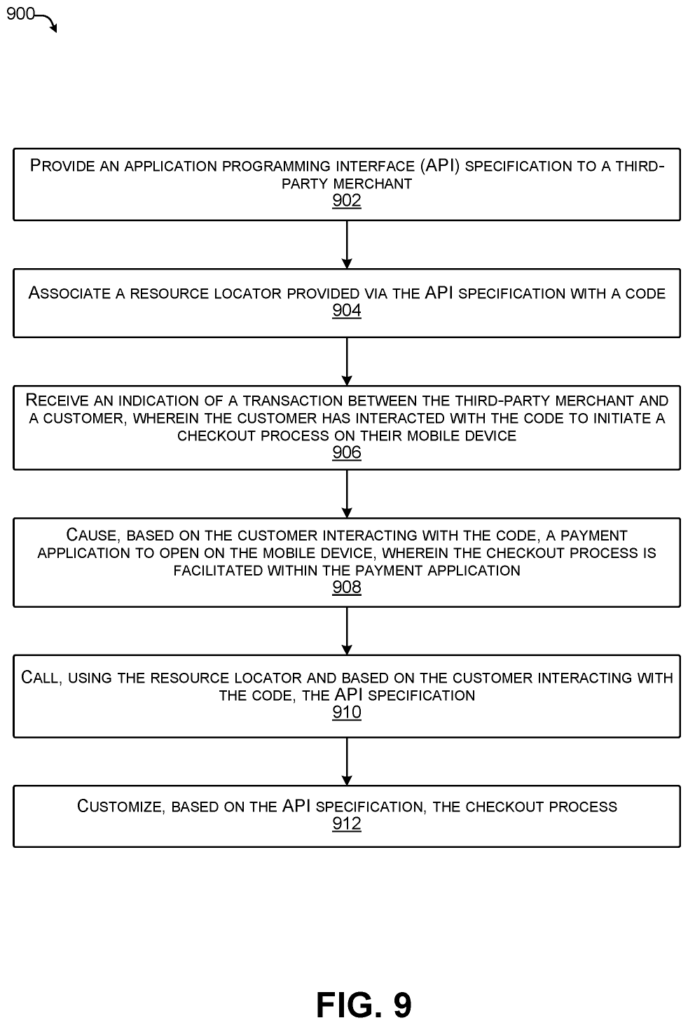

At least some of the examples described above relate, in part, to presenting information indicative of a transaction attribute(s) in a user-readable format instead of the computer-readable format, and via the payment application 106 executing on a user device 104 of a user 102, such as in a graphical user interface (e.g., a graphical user interface associated with an activity feed, a statement, a receipt, etc.). The example process 900 of FIG. 9, described below, relates to presenting other customized information via the payment application 106 executing on a user device 104 of a user 102, such as in a graphical user interface (e.g., a graphical user interface associated with an activity feed, a statement, a receipt, etc.). For example, in conventional systems that implement a payment service for users to purchase items from a merchant (e.g., in the merchant's brick-and-mortar store), all payment information associated with a user (e.g., customer) who is making the purchase is typically required to be registered in advance of the user entering the payment experience. This payment information is typically stored in a data store(s) of the system that implements the payment service, and is later referenceable by a token. This means that if the merchant sets a price on a payment experience, the price cannot be changed.

The techniques, devices, and systems described herein allow third-party merchants to build against an application programming interface (API) specification, which allows for consistency and provides the payment application 106 with control over the API definition. In some examples, the API specification includes a Uniform Resource Locator (URL) path, and the third-party merchant can provide the domain associated with the URL path. The payment service 108 may be configured to call the API, which provides the third-party merchant with a hook into a checkout experience for their individual customers (e.g., users 102 of the payment service 108). Because the third-party merchant can build against the API specification, expectations as to what data is in the response to the API call can be set in advance, via the API specification. The data returned to the payment service 108 in response to the API call can be used to surface one or more checkout features, as supported by a dynamic experience.

The example process 900 of FIG. 9, described below, can be used to create a deeply integrated checkout. In addition, more surface area in the payment application 106 can be made available for a third-party merchant to directly interact with a customer (e.g., user 102) during a checkout experience with features such as itemized receipts, stylized checkouts, third-party merchant control over merchant-funded discounts, and/or pricing determined after a tap of user device 104 on a code (e.g., a code embedded in a near-field communication (NFC) chip). In some examples, these example features can be enabled through a static Quick Response (QR) code printed on a piece of paper, a NFC tag with a static URL, and/or the like. In an illustrative example, the user 102(1) in FIG. 1 may shop at a merchant in person, and may pick out clothes they wish to purchase. At checkout, the user 102(1) may scan the QR codes on the clothes that they picked out, which triggers a customization of the checkout flow based on what the merchant has customized during checkout via the API specification mentioned above.

FIG. 9 is an example process 900 for implementing an in-app dynamic checkout experience for a user 102 of a payment application 106, according to an implementation of the present subject matter. The process 900 is illustrated as a collection of blocks in a logical flow graph, which represent a sequence of operations that can be implemented in hardware, software, or a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process 900. The process 900 can be implemented by a system including one or more processors and memory storing computer-executable instructions to cause the one or more processors to perform the process 900. In some examples, the process 900 can be implemented by a processing device(s) (e.g., a computing system and/or a server(s) 110 of the payment service computing platform). For discussion purposes, the process 900 is described with reference to the previous figures.

At 902, an API specification is provided to a third-party merchant. In some examples, the payment service computing platform (e.g., a server(s) 110) may provide the API specification to the third-party merchant at block 902. In some examples, the API specification enables the third-party merchant to customize features associated with a checkout process. In some examples, such features include itemized receipts, stylized checkouts, third-party merchant control over merchant-funded discounts, and/or pricing determined after a tap of user device 104 on a code (e.g., a code embedded in a NFC chip). In some examples, the API specification requires the third-party merchant to provide a resource locator, such as a domain associated with the URL path.

At 904, the resource locator (e.g., provided via the API specification) is associated with a code. In some examples, the payment service computing platform (e.g., the server(s) 110) may associate the resource locator with the code at block 904. In some examples, the code is embedded in NFC chip, printed on paper (e.g., a tag of an item in a store of the third-party merchant, and/or the like. In some examples, the code is a digital code, a QR code, a barcode, and/or the like.

At 906, an indication of a transaction between the third-party merchant and a customer (e.g., a user 102) is received. In some examples, the payment service computing platform (e.g., the server(s) 110) may receive the indication of the transaction at block 906. In some examples, the customer (e.g., user 102) has interacted with the code to initiate a checkout process on their user device 104 (e.g., a mobile device), which causes the indication of the transaction to be received at block 906. In some examples, the customer (e.g., user 102) taps the code with their user device 104, such as when the code is embedded in a NFC chip and attached to the item or otherwise provided at the checkout counter.

At 908, based on the customer (e.g., user 102) interacting with the code, a payment application 106 is caused to open on the user device 104 (e.g., mobile device). In some examples, the payment service computing platform (e.g., the server(s) 110) may cause the payment application 106 to open on the user device 104 at block 908. In some examples, the checkout process is facilitated within the payment application 106.

At 910, the API specification is called using the resource locator and based on the customer (e.g., user 102) interacting with the code. In some examples, the payment service computing platform (e.g., the server(s) 110) may call the API specification at block 910. In some examples, a domain associated with a URL path is used to call the API specification based on the customer (e.g., user 102) interacting with the code, such as tapping their user device 104 (e.g., mobile device) on an NFC chip, scanning the code (e.g., QR code, barcode, etc.), and/or the like.

At 912, the checkout process is customized within the payment application 106 based on the API specification called at block 910. In some examples, the payment service computing platform (e.g., the server(s) 110) may customize the checkout process within the payment application 106 at block 912. In some examples, customizing the checkout process at block 912 includes customizing one or more features associated with the checkout process, such as customizing itemized receipts, stylized checkouts, third-party merchant control over merchant-funded discounts, and/or pricing determined after the tap (e.g., the tap of the user device 104 on the code (e.g., when the code is embedded in a NFC chip)).

FIG. 10 illustrates an example environment 1000. The environment 1000 includes server(s) 1002 that can communicate over a network 1004 with end user devices 1006 and/or server(s) 1008 associated with third-party service provider(s). In various examples, the end user devices 1006 may comprise one or more seller devices 1006(A), one or more user devices 1006(B) and/or 1006(C) in a peer network, one or more content consumption devices 1006(D), one or more artist user devices 1006(E), combinations of these examples, or other categories of user devices. The server(s) 1002 can be associated with one or more service providers that can provide one or more services for the benefit of users 1016, as described below. For example, the server(s) 1002 may enable services of service providers such as in association with a merchant platform 1010 (which may further include a buyer platform), a peer-to-peer (P2P) payment platform 1012, a media content platform 1014, a combination of these platforms, or other platforms associated with other service providers. While services and features are referenced throughout in connection with a particular one of the merchant platform 1010, the P2P payment platform 1012, or the media content platform 1014, it should be understood that any of these platforms may perform the functionality described in relation to any of the other platforms. Actions attributed to the service provider(s) can be performed by the server(s) 1002.

In some examples, the server(s) 1002 may be the same as or similar to the server(s) 110 introduced in FIG. 1, and the server(s) 1002 may implement the payment service 108. Accordingly, the server(s) 1002 may include the transaction data processing component 134, the prompt generator component 136, the AI model(s) 138, the association component 140, the training component 142, and/or the fraud and compliance component 144, as described herein. Furthermore, the server(s) 1008 may be the same as or similar to the server(s) 128 introduced in FIG. 1, the end user device(s) 1006 may be the same as or similar to the user device 104 introduced in FIG. 1, the users 1016 may be the same as or similar to the users 102 introduced in FIG. 1, and the network(s) 1004 may be the same as or similar to the network(s) 112 introduced in FIG. 1. In addition, the application(s) 1026 may be the same as or similar to the payment application 106 introduced in FIG. 1.

In accordance with the examples described herein, the server(s) 1002 may process transaction data using AI. For instance, the server(s) 1002 may receive transaction data associated with users 1016 of a payment application 1026, wherein the transaction data is received in a computer-readable format, and the server(s) 1002 may provide a prompt to a trained AI model, wherein the prompt includes a portion of the transaction data that represents a transaction associated with a user of the users 1016. The server(s) 1002 may determine, based at least in part on the trained AI model processing the prompt, one or more attributes of the transaction, and cause information indicative of the one or more attributes to be presented via the payment application 1026 executing on a user device 1006 of the user, wherein the information is presented (i) in a graphical user interface and (ii) in a user-readable format instead of the computer-readable format.

In some examples, individual ones of the end user devices 1006 can be operable by users 1016. The users 1016 (individually referred to herein as “user 1016”) can be referred to as customers, buyers, merchants, sellers, borrowers, employees, employers, payors, payees, couriers, artists, musicians, listeners, fans, supervisors, hosts, audience members, and so on. The users 1016 can interact with the end user devices 1006 via user interfaces presented via the end user devices 1006. In at least one example, a user interface can be presented via a web browser, or the like. Alternatively or additionally, a user interface can be presented via an application, such as a mobile application or desktop application, which can be provided by the merchant platform 1010, the P2P payment platform 1012, and/or the media content platform 1014, or which can be an otherwise dedicated application. In some examples, individual end user devices 1006 can have an instance or versioned instance of an application, which can be downloaded from an application store, for example, which can present the user interface(s) described herein.

In at least one example, the users 1016 can include merchants that can operate the seller device(s) 1006(A) that are configured for use by merchants. For the purpose of this discussion, a “merchant” can be any entity that offers items (e.g., goods or services) for purchase or other means of acquisition (e.g., rent, borrow, barter, etc.). The merchants can offer items for purchase or other means of acquisition via brick-and-mortar stores, mobile stores (e.g., pop-up shops, food trucks, etc.), online stores, event venues, combinations of the foregoing, and so forth. In some examples, at least some of the merchants can be associated with the same entity but can have different merchant locations and/or can have franchise/franchisee relationships.

In additional or alternative examples, the merchants can be different merchants. For the purpose of this discussion, “different merchants” can refer to two or more unrelated merchants. “Different merchants” therefore can refer to two or more merchants that are different legal entities (e.g., natural persons and/or corporate persons) that do not share accounting, employees, branding, etc. “Different merchants,” as used herein, have different names, employer identification numbers (EIN)s, lines of business (in some examples), inventories (or at least portions thereof), and/or the like. Thus, the use of the term “different merchants” does not refer to a merchant with various merchant locations or franchise/franchisee relationships. Such merchants—with various merchant locations or franchise/franchisee relationships—can be referred to as merchants having different merchant locations and/or different commerce channels.

The seller device 1006(A) can have an instance of a point of sale (“POS”) application 1020 stored thereon. The POS application 1020 can configure the seller device 1006(A) as a POS terminal, which enables the merchant to interact with one or more customers. In at least one example, interactions between the customers and the merchants that involve the exchange of funds (from the customers) for items or services (from the merchants) can be referred to as “transactions.” In at least one example, the POS application 1020 can determine transaction data associated with the POS transactions. Transaction data can include payment information, which can be obtained from a reader device 1022 associated with the seller device 1006(A), user authentication data, purchase amount information, point-of-purchase information (e.g., item(s) purchased, date of purchase, time of purchase, subscription type, etc.), etc. The POS application 1020 can send transaction data to the server(s) 1002 such that the server(s) 1002 can track transactions of the customers, merchants, and/or the users 1016 over time. Furthermore, the POS application 1020 can present a UI to enable the merchant to interact with the POS application 1020 and/or the merchant platform 1010 via the POS application 1020.

In at least one example, the seller device 1006(A) can be a special-purpose computing device configured as a POS terminal (via the execution of the POS application 1020). In at least one example, the POS terminal may be connected to a reader device 1022, which is capable of accepting a variety of payment instruments, such as credit cards, debit cards, gift cards, short-range communication based payment instruments, and the like, as described below. In at least one example, the reader device 1022 can plug in to a port in the seller device 1006(A), such as a microphone port, a headphone port, an audio-jack, a data port, or other suitable port. In additional or alternative examples, the reader device 1022 can be coupled to the seller device 1006(A) via another wired or wireless connection, such as via Bluetooth®, BLE, and so on. In some examples, the reader device 1022 can be a software solution executing on the POS terminal, e.g., a mobile phone. In some examples, the reader device 1022 can read information from alternative payment instruments including, but not limited to, wristbands and the like.

In some examples, the reader device 1022 may physically interact with payment instruments such as magnetic stripe payment cards, EMV payment cards, and/or short-range communication (e.g., near field communication (NFC), radio frequency identification (RFID), Bluetooth®, Bluetooth® low energy (BLE), etc.) payment instruments (e.g., cards, hardware wallets, fobs, or devices configured for tapping). The POS terminal may provide a rich user interface, communicate with the reader device 1022, and communicate with the merchant platform 1010, which can provide, among other services, a payment processing service. The server(s) 1002 associated with the merchant platform 1010 can communicate with server(s) 1008, as described below. In this manner, the POS terminal and reader device 1022 may collectively process transaction(s) between the merchants and customers. In some examples, multiple POS terminal(s) may be connected to a number of other devices, such as “secondary” terminals, e.g., back-of-the-house systems, printers, line-buster devices, reader devices, speakers, and the like, to allow for information from the secondary terminal to be shared between the primary POS terminal(s) and secondary terminal(s), for example via short-range communication technology. This kind of arrangement may continue operation in an offline-online scenario to allow one device (e.g., secondary terminal) to continue taking user input, and synchronize data with another device (e.g., primary terminal) when the primary or secondary terminal switches to online mode. In other examples, such data synchronization may happen periodically or at randomly selected time intervals.

While the POS terminal and the reader device 1022 of the POS system 1024 are shown as separate devices, in additional or alternative examples, the POS terminal and the reader device 1022 can be part of a single device. In some examples, the reader device 1022 can have a display integrated therein for presenting information to customers of a merchant. In additional or alternative examples, the POS terminal can have a display integrated therein for presenting information to the customers of the merchant. POS systems, such as the POS system 1024, may be mobile, such that POS terminals and reader devices may process transactions in disparate locations across the world. POS systems can be used for processing card-present transactions and card-not-present (CNP) transactions.

A card-present transaction is a transaction where both a customer and the customer's payment instrument are physically present at the time of the transaction. Card-present transactions may be contact or contactless transactions processed by swipes (e.g., by sliding a magnetic strip through a reader device), dips (e.g., by inserting an embedded microchip into a reader device), taps (e.g., by wirelessly, through Bluetooth, NFC or other short range technology hover or tap a payment instrument into a reader device), or any other interaction between a physical payment instrument (e.g., a card), or otherwise present payment instrument, and a reader device 1022, whereby the reader device 1022 is able to obtain payment data from the payment instrument.

A CNP transaction is a transaction where a card, or other payment instrument, is not physically present at the POS such that payment data is manually keyed in (e.g., by a merchant, customer, etc.), or payment data is required to be recalled from a card-on-file data store, to complete the transaction.

The POS system 1024, the server(s) 1002, and/or the server(s) 1008 may exchange payment information and transaction data to determine whether transactions are authorized. For example, the POS system 1024 may provide encrypted payment data, user authentication data, purchase amount information, point-of-purchase information, etc. (collectively, transaction data) to server(s) 1002 over the network(s) 1004. The server(s) 1002 may send the transaction data to the server(s) 1008.

For the purpose of this discussion, the “payment service providers” can be acquiring banks (“acquirer”), issuing banks (“issuer”), card payment networks, and the like. In an example, an acquirer is a bank or financial institution that processes payments (e.g., credit or debit card payments) and can assume risk on behalf of merchants(s). An acquirer can be a registered member of a card association (e.g., Visa®, MasterCard®), and can be part of a card payment network. In at least one example, the service provider can serve as an acquirer and connect directly with the card payment network.

The card payment network (e.g., the server(s) 1008 associated therewith) can forward the fund transfer request to an issuing bank (e.g., “issuer”). The issuer is a bank or financial institution that offers a financial account (e.g., credit or debit card account) to a user. The issuer (e.g., the server(s) 1008 associated therewith) can make a determination as to whether the customer has the capacity to absorb the relevant charge associated with the payment transaction. In at least one example, the merchant platform 1010 can serve as an issuer and/or can partner with an issuer. The transaction is either approved or rejected by the issuer and/or the card payment network (e.g., the server(s) 1008 associated therewith), and a payment authorization message is communicated from the issuer to the POS device via a path opposite of that described above, or via an alternate path.

The server(s) 1008 may send an authorization notification over the network(s) 1004 to the server(s) 1002, which may send the authorization notification to the POS system 1024 over the network(s) 1004 to indicate whether the transaction is authorized. The server(s) 1002 may also transmit additional information such as transaction identifiers to the POS system 1024. In one example, the server(s) 1002 may include a merchant application and/or other functional components for communicating with the POS system 1024 and/or the server(s) 1008 to authorize or decline transactions (e.g., the API 1018). In examples, the merchant platform 1010 can enable the merchants to receive cash payments, payment card payments, and/or electronic payments from customers for POS transactions and the service provider can process transactions on behalf of the merchants.

Based on the authentication notification that is received by the POS system 1024 from server(s) 1002, the merchant may indicate to the customer whether the transaction has been approved. In some examples, approval may be indicated at the POS system 1024, for example, at a display of the POS system 1024. In some cases, such as with a smart phone or watch operating as a short-range communication payment instrument, information about the approved transaction may be provided to the short-range communication payment instrument for presentation via a display of the smart phone or watch. In some examples, additional or alternative information can additionally be presented with the approved transaction notification including, but not limited to, receipts, special offers, coupons, or loyalty program information.

The merchant platform 1010 can provide, among other services, payment processing services, inventory management services, catalog management services, business banking services, financing services, lending services, reservation management services, web-development services, payroll services, employee management services, appointment services, loyalty tracking services, restaurant management services, order management services, fulfillment services, onboarding services, identity verification (IDV) services, media content (e.g., music, videos, etc.) management and/or subscription services, and so on. In some examples, the users 1016 can access all of the services. In some cases, the users 1016 can have gradated access to the services, which can be based on risk tolerance, IDV outputs, subscriptions, and so on. In at least one example, access to such services can be availed to the merchants via the POS application 1020. In additional or alternative examples, each service can be associated with its own access point (e.g., application, web browser, etc.).

As the merchant platform 1010 processes transactions on behalf of the merchants, the merchant platform 1010 can maintain accounts or balances for the merchants in one or more ledgers. For example, the merchant platform 1010 can analyze transaction data received for a transaction to determine an amount of funds owed to a merchant for the transaction and deposit funds into an account of the merchant. The account can have a stored balance, which can be managed by the merchant platform 1010. The account can be different from a conventional bank account at least because the stored balance is managed by a ledger of the merchant platform 1010 and the associated funds are accessible via various withdrawal channels including, but not limited to, scheduled deposit, same-day deposit, instant deposit, and a linked payment instrument.

A scheduled deposit can occur when the merchant platform 1010 transfers funds associated with a stored balance of the merchant to a bank account of the merchant that is held at a bank or other financial institution (e.g., associated with the server(s) 1008). Scheduled deposits can occur at a prearranged time after a POS transaction is funded, which can be a business day after the POS transaction occurred, or sooner or later. In some examples, the merchant can access funds prior to a scheduled deposit (e.g., same-day deposits and/or real-time deposits). Further, in at least one example, the merchant can have a payment instrument that is linked to the stored balance that enables the merchant to access the funds without first transferring the funds from the account managed by the merchant platform 1010 to the bank account of the merchant.

In at least one example, the merchant platform 1010 may provide inventory management services. That is, the merchant platform 1010 may provide inventory tracking and reporting. Inventory management services may enable the merchant to access and manage a database storing data associated with a quantity of each item that the merchant has available (i.e., an inventory). Furthermore, in at least one example, the merchant platform 1010 can provide catalog management services to enable the merchant to maintain a catalog, which can be a database storing data associated with items that the merchant has available for acquisition (i.e., catalog management services). The merchant platform 1010 can offer recommendations related to pricing of the items, placement of items on the catalog, and multi-party fulfillment of the inventory, to name a few examples.

In at least one example, the merchant platform 1010 can provide business banking services, which allow the merchant to track deposits (from payment processing and/or other sources of funds) into an account of the merchant, payroll payments from the account (e.g., payments to employees of the merchant), payments to other merchants (e.g., business-to-business) directly from the account or from a linked debit card, withdrawals made via scheduled deposit and/or real-time deposit, configure allocations among multiple balances or accounts (e.g., spending, saving, taxes, etc.), etc. Furthermore, the business banking services can enable the merchant to obtain a customized payment instrument (e.g., credit card), check how much money the merchant is earning (e.g., via presentation of available earned balance), understand where the money of the merchant is going (e.g., via deposit reports (which can include a breakdown of fees), spend reports, etc.), access/use earned money (e.g., via scheduled deposit, real-time deposit, linked payment instrument, etc.), have improved control of the money of the merchant (e.g., via management of deposit schedule, deposit speed, linked instruments, etc.), etc. Moreover, the business banking services can enable the merchants to visualize their cash flow to track their financial health, set aside money for upcoming obligations (e.g., savings), organize money around goals, etc.

In at least one example, the merchant platform 1010 can provide financing services and products, such as via business loans, consumer loans, fixed term loans, flexible term loans, and the like. In at least one example, the service provider can utilize one or more risk signals to determine whether to extend financing offers and/or terms associated with such financing offers. Such risk signals can be particular to an individual platform or service, as described herein, or can be based on aggregated data associated with multiple of the platforms or services. In at least one example, the merchant platform 1010 can provide financing services for offering and/or lending a loan to a borrower that is to be used for, in some instances, financing the borrower's short-term operational needs (e.g., a capital loan). Additionally or alternatively, the merchant platform 1010 can provide financing services for offering and/or lending a loan to a borrower that is to be used for, in some instances, financing the borrower's consumer purchase (e.g., a consumer loan). In at least one example, a borrower can submit a request for a loan to enable the borrower to purchase an item from a merchant. The merchant platform 1010 can generate the loan based at least in part on determining that the borrower purchased or intends to purchase the item from the merchant. Advances, loans, or other funds provided to a merchant or other user can be repaid via a variety of mechanisms. In some examples, loans can be repaid in installments (e.g., multiple payments over time), at a particular date, from a portion of incoming funds (e.g., payments processed for the merchant, tax refunds, direct deposits, etc.), or the like.

The merchant platform 1010 can provide web-development services, which enable users 1016 who are unfamiliar with HTML, XML, Javascript, CSS, or other web design tools to create and maintain functional websites. Further, in addition to websites, the web-development services can create and maintain other online omni-channel presences, such as social media posts for example. In some examples, the resulting web page(s) and/or other content items can be used for offering item(s) for sale via an online/e-commerce platform. In at least one example, the merchant platform 1010 can recommend and/or generate content items to supplement omni-channel presences of the merchants.

Furthermore, the merchant platform 1010 can provide payroll services to enable employers to pay employees for work performed on behalf of employers. In at least one example, the merchant platform 1010 can receive data that includes time worked by an employee (e.g., through imported timecards and/or POS interactions), sales made by the employee, gratuities received by the employee, and so forth. Based on such data, the merchant platform 1010 can make payroll payments to employee(s) on behalf of an employer via the payroll service. For instance, the merchant platform 1010 can facilitate the transfer of a total amount to be paid out for the payroll of an employee from the bank of the employer to the bank of the merchant platform 1010 to be used to make payroll payments. In at least one example, when the funds have been received at the bank of the merchant platform 1010, the merchant platform 1010 can pay the employee, such as by check or direct deposit.

Moreover, in at least one example, the merchant platform 1010 can provide employee management services for managing schedules of employees. Further, the merchant platform 1010 can provide appointment services for enabling users 1016 to set schedules for scheduling appointments and/or users 1016 to schedule appointments.

In some examples, the merchant platform 1010 can provide restaurant management services to enable users 1016 to make and/or manage reservations, to monitor front-of-house and/or back-of-house operations, and so on. In such examples, the seller device(s) 1006(A) and/or server(s) 1002 can be configured to communicate with one or more other computing devices, which can be located in the front-of-house (e.g., POS device(s)) and/or back-of-house (e.g., kitchen display system(s) (KDS)). In at least one example, the merchant platform 1010 can provide order management services and/or fulfillment services to enable restaurants (or other merchant types) to manage open tickets, split tickets, and so on and/or manage fulfillment services.

In some examples, the merchant platform 1010 can provide omni-channel fulfillment services. A fulfillment service includes item ordering and delivery services, such as via a courier. In some examples, the courier can be an unmanned aerial vehicle (e.g., a drone), an autonomous vehicle, or any other type of vehicle capable of receiving instructions for traveling between locations. For instance, if a customer places an order with a merchant and the merchant cannot fulfill the order because one or more items are out of stock or otherwise unavailable, the merchant platform 1010 can leverage other merchants and/or sales channels that are part of the merchant platform 1010 to fulfill the customer's order. That is, another merchant can provide the one or more items to fulfill the order of the customer. Furthermore, in some examples, another sales channel (e.g., online, brick-and-mortar, etc.) can be used to fulfill the order of the customer.

In some examples, the merchant platform 1010 can enable conversational commerce via conversational commerce services, which can use one or more machine learning mechanisms to analyze messages exchanged between two or more users 1016, voice inputs into a virtual assistant or the like, to determine intents of user(s) 1016. In some examples, the merchant platform 1010 can utilize determined intents to automate customer service, offer promotions, provide recommendations, or otherwise interact with customers in real-time. In at least one example, the merchant platform 1010 can integrate products and services, and payment mechanisms into a communication platform (e.g., messaging, etc.) to enable customers to make purchases, or otherwise transact, without having to call, email, or visit a web page or other channel of a merchant. That is, conversational commerce alleviates the need for customers to toggle back and forth between conversations and web pages to gather information and make purchases.

In at least one example, a user 1016 may be new to the merchant platform 1010 such that the user 1016 that has not registered (e.g., subscribed to receive access to one or more services offered by the merchant platform 1010) with the merchant platform 1010. The merchant platform 1010 can offer onboarding services for registering a potential user 1016 with the merchant platform 1010. In some examples, onboarding can involve presenting various questions, prompts, and the like to a potential user 1016 to obtain information that can be used to generate a profile for the potential user 1016. In at least one example, the merchant platform 1010 can provide limited or short-term access to its services prior to, or during, onboarding (e.g., a user of a peer-to-peer payment service can transfer and/or receive funds prior to being fully onboarded, a merchant can process payments prior to being fully onboarded, a user of a music streaming service can listen to music having advertisement breaks prior to being fully onboarded, etc.). In response to full or partial completion of onboarding, any limited or short-term access to services of the merchant platform 1010 can be transitioned to more permissive (e.g., less limited) or longer-term access to such services.

The merchant platform 1010 can be associated with IDV services, which can be used by the merchant platform 1010 for compliance purposes and/or can be offered as a service, for instance to third-party service providers (e.g., associated with the server(s) 1008). That is, the merchant platform 1010 can offer IDV services to verify the identity of users 1016 seeking to use or using their services. Identity verification may involve requesting a customer (or potential customer) to provide information that is used by compliance departments to prove that the information is associated with an identity of a real person or entity (e.g., an artist). In at least one example, the merchant platform 1010 can perform services for determining whether identifying information provided by a user 1016 accurately identifies the customer (or potential customer).

Techniques described herein can be configured to operate in both real-time/online and offline modes. “Online” modes refer to modes when devices are capable of communicating with the merchant platform 1010 while offline mode refers to modes when devices are unable to communicate with the server(s) 1008 due to network connectivity issue, for example. In such examples, devices may operate in “offline” mode where at least some payment data is stored (e.g., on the seller device(s) 1006(A)) and/or the server(s) 1002 until connectivity is restored and the payment data can be transmitted to the server(s) 1002 and/or the server(s) 1008 for processing.

In at least one example, the merchant platform 1010 can be associated with a hub, such as an order hub, an inventory hub, a fulfillment hub and so on, which can enable integration with one or more additional service providers (e.g., associated with the additional server(s) 1008). In some examples, such additional service providers can offer additional or alternative services and the service provider can provide an interface or other computer-readable instructions to integrate functionality of the service provider into the one or more additional service providers.

Turning now to the P2P functionality provided by the environment 1000, the P2P platform 1012 can provide a peer-to-peer payment service that enables peer-to-peer payments between two or more of the users 1016. Two or more of the users 1016 may be considered “peers” in a peer-to-peer interaction, such as a payment. In at least one example, the P2P platform 1012 can communicate with instances of a payment application 1026 (or other access point) installed on end user devices 1006 configured for operation by the users 1016. In an example, an instance of the payment application 1026 executing on a first user device 1006(B) operated by a payor (e.g., one of the users 1016) can send a request to the P2P platform 1012 to transfer an asset (e.g., fiat currency, non-fiat currency, digital assets such as non-fungible tokens (NFTs), cryptocurrency, securities, gift cards, and/or related assets) from the payor to a payee (e.g., a different one of the users 1016) via a peer-to-peer payment. In some examples, assets associated with an account of the payor are transferred to an account of the payee. In some examples, assets can be held at least temporarily in an account of the P2P platform 1012 prior to transferring the assets to the account of the payee.

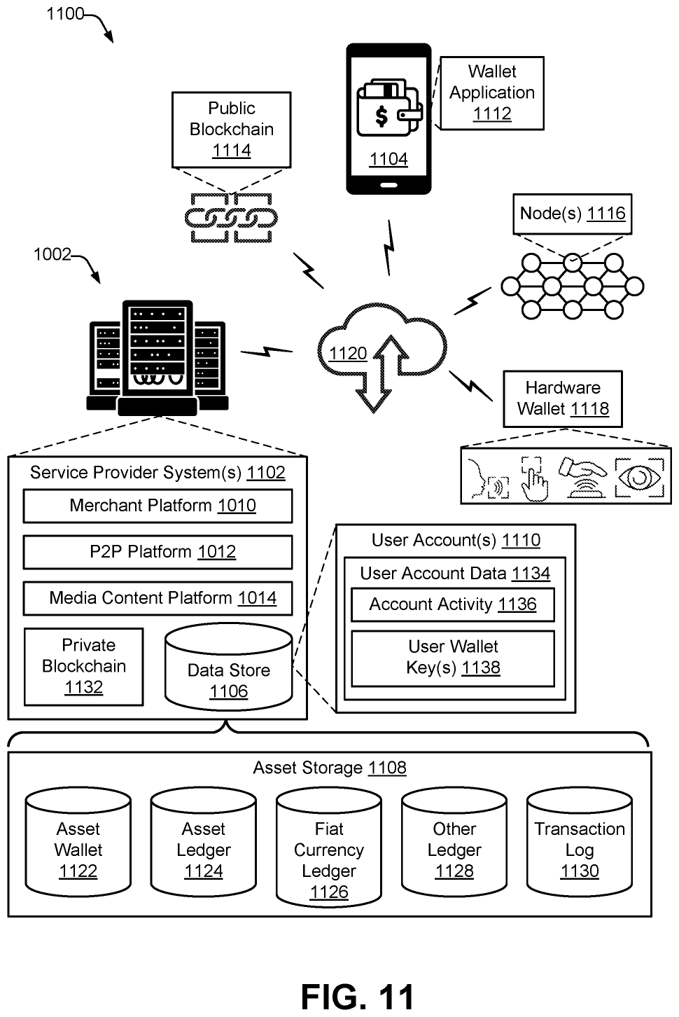

In some examples, the P2P platform 1012 can utilize a ledger system to track transfers of assets between users 1016. FIG. 11, below, provides additional details associated with such a ledger system. The ledger system can enable users 1016 to own fractional shares of assets that are not conventionally available. For instance, a user can own a fraction of a Bitcoin, an NFT, or a stock. Additional details are described herein.

In at least one example, the P2P platform 1012 can facilitate transfers and can send notifications related thereto to instances of the payment application 1026 executing on user device(s) of payee(s). As an example, the P2P platform 1012 can transfer assets from an account of a first user to an account of a second user and can send a notification to the user device 1006(B) of the second user for presentation via a user interface. The notification can indicate that a transfer is in process, a transfer is complete, or the like. In some examples, the P2P platform 1012 can send additional or alternative information to the instances of the payment application 1026 (e.g., low balance to the payor, current balance to the payor or the payee, etc.). In some examples, the payor and/or payee can be identified automatically, e.g., based on context, proximity, prior transaction history, and so on. In other examples, the payee can send a request for funds to the payor prior to the payor initiating the transfer of funds. In some embodiments, the P2P platform 1012 funds the request to payee on behalf of the payor, to speed up the transfer process and compensate for lags that may be attributed to the payor's financial network.

In some examples, the P2P platform 1012 can trigger the peer-to-peer payment process through identification of a “payment proxy” having a particular syntax. The payment proxy is useable in lieu of payment data. That is, payment data and a payment proxy can be linked to, or otherwise associated with, a user account of a user and either can be used for making payments. In an example, the syntax can include a monetary currency indicator prefixing one or more alphanumeric characters (e.g., $Cash). The currency indicator operates as the tagging mechanism that indicates to the server(s) 1002 to treat the inputs as a request from the payor to transfer assets, where detection of the syntax triggers a transfer of assets. The currency indicator can correspond to various currencies including but not limited to, dollar ($) euro (€), pound (£), rupee ( [symbol] ), yuan (¥), etc. Although use of the dollar currency indicator ($) is used herein, it is to be understood that any currency symbol or other symbol could equally be used. In some examples, additional or alternative identifiers can be used to trigger the peer-to-peer payment process. For instance, email, telephone number, social media handles, artist or band names, and/or the like can be used to trigger and/or identify users of a peer-to-peer payment process.

In some examples, the peer-to-peer payment process can be initiated through instances of the payment application 1026 executing on the end user devices 1006. In at least some embodiments, the peer-to-peer process can be implemented within a landing page associated with a user and/or an identifier of a user. The term “landing page,” as used here, refers to a virtual location identified by a personalized location address that is dedicated to collect payments on behalf of a recipient associated with the personalized location address. The personalized location address that identifies the landing page can be a uniform resource locator (URL), which can include a payment proxy discussed above. The P2P platform 1012 can generate the landing page to enable the recipient to conveniently receive one or more payments from one or more senders.

In some examples, the peer-to-peer payment process can be implemented within a forum. The term “forum,” as used here, refers to a content provider's media channel (e.g., a social networking platform, a microblog, a blog, video sharing platform, a music sharing platform, etc.) that enables user interaction and engagement through streaming of content, comments, posts, messages on electronic bulletin boards, messages on a social networking platform, and/or any other types of messages. In some examples, the content provider can be the service provider as described with reference to FIG. 10 or a third-party service provider associated with the server(s) 1008. In examples where the content provider is a third-party service provider, the server(s) 1008 can be accessible via one or more APIs 1018 or other integrations. In some examples, “forum” may also refer to an application or webpage of an e-commerce or retail organization that offers products and/or services. Such websites can provide an online “form” to complete before or after the products or services are added to a virtual cart. Some of these fields may be configured to receive payment information, such as a payment proxy, in lieu of other kinds of payment mechanisms, such as credit cards, debit cards, prepaid cards, gift cards, virtual wallets, etc.

In some embodiments, the peer-to-peer process can be implemented within a communication application, such as a messaging application. The term “messaging application,” as used here, refers to any messaging application that enables communication between users (e.g., sender and recipient of a message) over a wired or wireless communications network, through use of a communication message. The messaging application can be internal to the P2P platform 1012 (e.g., the P2P platform 1012 offers a chat or messaging service that is within the payment application or accessible via the payment application). In some examples, the messaging application can be external to the P2P platform 1012. (e.g., the messaging application is hosted by a third-party service provider associated with the server(s) 1008, which can be accessible via one or more of the APIs 1018 or other integrations). The messaging application can include, for example, a text messaging application for communication between phones (e.g., conventional mobile telephones or smartphones), or a cross-platform instant messaging application for smartphones and phones that use the Internet for communication.

Funds received from payments can be stored in stored balances that are linked to, or otherwise associated with, user accounts. In some examples, the P2P platform 1012 can enable users 1016 to perform banking transactions via instances of the payment application 1026. For example, users can configure direct deposits, recurring deposits, or other deposits (e.g., tax refunds, loans, etc.) for adding assets to their various ledgers/balances. In some examples, users can deposit physical cash via ATMs or other deposit sources, which can include merchants, such as those merchants that utilize the payment processing system described above. In some examples, the P2P platform 1012 can enable users to allocate funds between different accounts, sub-accounts, or balances (e.g., spending, saving, different assets, different currencies), etc. Further, users 1016 can configure bill pay, recurring payments, and/or the like using assets associated with their accounts. In some examples, the P2P platform 1012, with consent of the user, can track individual transactions made using the payment application and can utilize such transaction data to make personalized or customized recommendations, determine creditworthiness, generate tax documentation, and/or the like.

In addition to sending and/or receiving assets via peer-to-peer transactions, the P2P platform 1012 enables users to buy and/or sell assets via asset networks such as cryptocurrency networks, securities networks, and/or the like. In some examples, acquisition of such assets can be in whole or fractional shares. The ledger system described below with reference to FIG. 11 can enable such assets to be acquired in fractional shares and/or in real-time or near real-time (by delaying or omitting the need to buy/sell assets via asset networks or exchanges). In some examples, users can “gift” assets to other users, for example, by transferring cryptocurrency, stocks, or the like to one another.

In some examples, the P2P platform 1012 can enable users to link payment instruments to their user accounts. As a result, users can use their linked payment instruments to access funds in their accounts or balances. In some examples, the payment instrument can be a credit card, debit card, card linked to multiple accounts or balances via software or hardware, a fob or other object having payment data stored thereon, or the like. In some examples, the payment instrument can be a virtual payment instrument or a physical payment instrument. In some examples, the virtual payment instrument can be issued in real-time or for temporary usage. In some examples, the virtual payment instrument can have the same or different payment data as a corresponding physical payment instrument. Payment instruments can be customizable using a design user interface of the payment application. Such customization can enable users to select colors, stamps, images, text, or the like for surface(s) of their payment instruments. In some examples, users can draw or otherwise interact with the design user interface to personalize surface(s) of their payment instruments.

In some examples, users can associate incentives with their payment instruments. Incentives can be recommended to users based on user preferences (inferred or explicitly identified), geolocation, propensity to redeem, value, and/or the like. In some examples, incentives can be particular to individual merchants, types of merchants, types of transactions, and/or the like. In at least one example, when a user uses their payment instrument at a merchant or type of merchant associated with an incentive, or for a transaction type associated with an incentive, the P2P platform 1012 can automatically apply the incentive to the transaction. In some examples, users can gift other users “gift cards” that can be associated with payment instruments. That is, a user can transfer an amount of funds to another user and such funds can be associated with a condition (e.g., merchant, merchant type, transaction type, location, etc.) that, upon satisfaction, enables the amount of funds, or a portion thereof, to be applied to a transaction. In at least one example, when a user uses their payment instrument for a transaction that satisfies the condition, the P2P platform 1012 can automatically apply the amount of funds associated with the gift card to the transaction.

In some examples, users can configure their account such that when they use their payment instruments, the P2P platform 1012 can deposit an amount of funds into a savings account, investing account, bitcoin account, or the like.

In some examples, users can search for or browse other users, merchants, items, or the like via the payment application. In some examples, search results can be personalized and/or customized for the user (e.g., based on user data collected with consent of the user). In some examples, users can shop or otherwise purchase items from other users, merchants, or the like from within the payment application or via a deep link to a merchant application or website.

The P2P platform 1012 can offer primary and secondary accounts, wherein a primary account is a sponsor or other delegate of one or more secondary accounts. Such accounts can be useful for families, wherein a parent or other guardian is a sponsor or delegate to one or more child accounts, or where a child is a sponsor or delegate of an elderly parent's account. In some examples, primary accounts can establish limits on secondary accounts, such as spending limits, or the like. In some examples, the primary account owner is the user legally responsible for the account and their identity may be verifiable for secondary user accounts to perform certain transactions, such as buying/selling cryptocurrency or stocks. In some examples, one or more primary accounts and one or more secondary accounts can form a “group” with shared goals, such as saving, investing, or the like.

The P2P platform 1012 can present activity data via an activity user interface of the payment application. In some examples, activity can be presented by merchant, date, time, amount, or the like. In some examples, interactions between entities can be represented in conversational communications such that each interaction or transaction is represented as a message. In some examples, users can interact with individual messages and/or send/request funds from within such a conversational communication. In some examples, such conversational communications can represent conversations of a group of two or more users. Groups can be used to pool funds, obtain group discounts or incentives, or enable multiple users to participate in financial transactions together (e.g., group investing, group savings, etc.).

The P2P platform 1012 can offer a variety of financial training or learning opportunities. In some examples, such training or learning can be personalized for individual users, for example, based on user data and/or transaction data of the user that is obtained with consent of the user. In some examples, such user data and/or transaction data can be analyzed to make actionable recommendations with respect to optimizing financial health of users of the P2P platform 1012.

In some examples, components of the environment 1000 may be integrated to enable payments at the point-of-sale using assets associated with user accounts of the P2P platform 1012. As illustrated in the environment 1000, the components can communicate with one another via the network 1004, where one or more APIs 1018 or other functional components can be used to facilitate such communication.

In at least one example, an integration can enable a customer to participate in a transaction via their own computing device (e.g., user device 1006(13)) instead of interacting with a merchant device of a merchant, such as the seller device 1006(A). In such an example, the POS application 1020, associated with a payment processing platform and executable by the seller device 1006(A) of the merchant, can present a Quick Response (QR) code, or other code that can be used to identify a transaction (e.g., a transaction code), in association with a transaction between the customer and the merchant. The QR code, or other transaction code, can be provided to the POS application 1020 via an API 1018 associated with the peer-to-peer payment platform. In an example, the customer can utilize their own computing device, such as the user device 1006(B), to capture the QR code, or the other transaction code, and to provide an indication of the captured QR code, or other transaction code, to server(s) 1002.

Based at least in part on the integration of the peer-to-peer payment platform and the payment processing platform (e.g., via the API 1018), the server(s) 1002 of the merchant platform 1010 can exchange communications with a payment application 1026 associated with the P2P platform 1012 and/or the POS application 1020 to process payment for the transaction using a peer-to-peer payment where the customer is a first “peer” and the merchant is a second “peer.”

Based at least in part on receiving an indication of which payment method a user (e.g., customer or merchant) intends to use for a transaction, techniques described herein utilize an integration between the P2P platform 1012 and merchant platform 1010 (which can be a first- or third-party integration) such that a QR code, or other transaction code, specific to the transaction can be used for providing transaction details, location details, customer details, or the like to a computing device of the customer, such as the user device 1006(B), to enable a contactless (peer-to-peer) payment for the transaction, and transferring funds from an account of the customer to an account of the merchant.

In at least one example, techniques described herein can offer improvements to conventional payment technologies at both brick-and-mortar points of sale and online points of sale. For example, at brick-and-mortar points of sale, techniques described herein can enable customers to “scan to pay,” by using their computing devices to scan QR codes, or other transaction codes, encoded with data as described herein, to remit payments for transactions. In such a “scan to pay” example, a customer computing device, such as the user device 1006(B), can be specially configured as a buyer-facing device that can enable the customer to view cart building in near real-time, interact with a transaction during cart building using the customer computing device, authorize payment via the customer computing device, apply coupons or other incentives via the customer computing device, add gratuity, loyalty information, feedback, or the like via the customer computing device, etc. In another example, merchants can “scan for payment” such that a customer can present a QR code, or other transaction code, that can be linked to a payment instrument or stored balance. Funds associated with the payment instrument or stored balance can be used for payment of a transaction.

As described above, techniques described herein can offer improvements to conventional payment technologies at online points of sale, as well as brick-and-mortar points of sale. For example, multiple applications can be used in combination during checkout. That is, the POS application 1020 and the payment application 1026, as described herein, can process a payment transaction by routing information input via the merchant application to the payment application for completing a “frictionless” payment.

Returning to the “scan to pay” examples described herein, QR codes, or other transaction codes, can be presented in association with a merchant web page or ecommerce web page. In at least one example, techniques described herein can enable customers to “scan to pay,” by using their computing devices to scan or otherwise capture QR codes, or other transaction codes, encoded with data, as described herein, to remit payments for online/ecommerce transactions. A customer computing device, such as the user device 1006(B), can be specially configured as a buyer-facing device having functionality similar to the functionality described above in the brick-and-mortar example.

In some examples, based at least in part on capturing the QR code, or other transaction code, the merchant platform 1010 can provide transaction data to the P2P platform 1012 for presentation via the payment application 1026 on the computing device of the customer, such as the user device 1006B(B), to enable the customer to complete the transaction via their own computing device. In some examples, in response to receiving an indication that the QR code, or other transaction code, has been captured or otherwise interacted with via the customer computing device, the P2P platform 1012 can determine that the customer authorizes payment of the transaction using funds associated with a stored balance of the customer that is managed and/or maintained by the P2P platform 1012, Such authorization can be implicit such that the interaction with the transaction code can imply authorization of the customer. Alternatively or additionally, the P2P platform 1012 can request express authorization to process payment for the transaction using the funds associated with the stored balance and the customer can interact with the payment application to expressly authorize the settlement of the transaction. In some examples, such an authorization (implicit or express) can be provided prior to a transaction being complete and/or initialization of a conventional payment flow. That is, in some examples, such an authorization can be provided during cart building (e.g., adding item(s) to a virtual cart) and/or prior to payment selection. In some examples, such an authorization can be provided after payment is complete (e.g., via another payment instrument). Based at least in part on receiving an authorization to use funds associated with the stored balance (e.g., implicitly or explicitly) of the customer, the P2P platform 1012 can transfer funds from the stored balance of the customer to the merchant platform 1010. In at least one example, the merchant platform 1010 can deposit the funds, or a portion thereof, into a stored balance of the merchant that is managed and/or maintained by the merchant platform 1010. In such an example, the merchant platform 1010 can be a “peer” to the customer in a peer-to-peer transaction.

In some examples, techniques described herein can enable the customer to interact with the transaction after payment for the transaction has been settled. For example, in at least one example, the merchant platform 1010 can cause a total amount of a transaction to be presented via a user interface associated with the payment application 1026 such that the customer can provide gratuity, feedback, loyalty information, or the like, via an interaction with the user interface. In another example, the merchant platform 1010 can adjust a total amount of a transaction based on events during a shopping experience, such as adding or removing a charge to the total amount based on whether a media content item requested by the customer to be played during a shopping experience was in fact played. In some examples, because the customer has already authorized payment via the P2P platform 1012, if the customer inputs a tip and/or an event affecting the total amount of the transaction is triggered, the P2P platform 1012 can transfer additional funds, associated with the tip or event, to the merchant platform 1010. This pre-authorization (or maintained authorization) of sorts can enable faster, more efficient payment processing when the tip is received and/or the event initiates the trigger. Further, the customer can provide feedback and/or loyalty information via the user interface presented by the payment application, which can be associated with the transaction. Using the pre-authorization techniques described herein results in fewer data transmissions and thus, techniques described herein can conserve bandwidth and reduce network congestion. Moreover, as described above, funds associated with tips can be received faster and more efficiently than with conventional payment technologies.

In addition to the improvements described above, techniques described herein can provide enhanced security in payment processing. In some examples, if a camera, or other sensor, used to capture a QR code, or other transaction code, is integrated into a payment application 1026 (e.g., instead of a native camera, or other sensor), techniques described herein can utilize an indication of the QR code, or other transaction code, received from the payment application for two-factor authentication to enable more secure payments.

It should be noted that, while techniques described herein are directed to contactless payments using QR codes or other transaction codes, in additional or alternative examples, techniques described herein can be applicable for contact payments. That is, in some examples, a customer can swipe a payment instrument (e.g., a credit card, a debit card, or the like) via a reader device associated with a merchant device, dip a payment instrument into a reader device associated with a merchant computing device, tap a payment instrument with a reader device associated with a merchant computing device, or the like, to initiate the provisioning of transaction data to the customer computing device. In some examples, the payment instrument can be associated with the P2P platform 1012 as described herein (e.g., a debit card linked to a stored balance of a customer) such that when the payment instrument is caused to interact with a payment reader, the merchant platform 1010 can exchange communications with the P2P platform 1012 to authorize payment for a transaction and/or provision associated transaction data to a computing device of the customer associated with the transaction.

Turning now to media content functionality provided by the environment 1000, the media content platform 1014 can provide digital media to a content consumption device 1006(D) where playback may occur using “streaming.” In examples, “streaming” media content involves encoding the media content and transmitting the encoded media content over the network 1004 to a media player or a media application executing on a device (e.g., via a speaker). The device then decodes and plays the media content while data is being received. In some cases, a buffer queues some of the data of the media content (e.g., audio data, video data, etc.) ahead of the media being played. During moments of network congestion, which leads to lower available bandwidth, less media content data is added to the buffer, which drains down as media content is being dequeued during streaming playback. However, during moments of high network bandwidth, the buffer is replenished, adding media content data to the buffer.

In at least one example, the media content platform 1014 can provide a digital media streaming service (e.g., subscription-based, non-subscription-based) that enables a content consumption device 1006(D) to stream and/or download digital media content via a listener application 1028 installed on the content consumption device 1006(D). For instance, the media content platform 1014 may comprise a digital audio streaming service (e.g., for music, podcasts, audiobooks, etc.), a digital video streaming service, and/or a streaming service that provides streaming of various different types of digital media content or multimedia. In such cases where digital media content items are downloaded and stored locally on the content consumption devices 1006(D), the listener application 1028 may verify access rights to the digital media content items at time intervals, for instance intermittently (e.g., when the content consumption device 1006(D) has a network connection with the media content platform 1014 via the network(s) 1004), and/or at regular intervals (e.g., daily, weekly, monthly, etc.). In examples, access rights to the digital media content items may be provided when a subscription to the media content platform 1014 is active, while access rights to the digital media content items may be withheld when the subscription to the media content platform 1014 is terminated. Enabling storage on the end user devices 1006 and subsequent access to digital media content items via the listener application 1028 provides the users 1016 with the ability to access the digital media content items “offline” such as when a connection to the media content platform 1014 via the network(s) 1004 is unavailable or unreliable.

In some examples, the media content platform 1014 may additionally or alternatively provide an artist management service that enables the users 1016 to manage aspects of artist business via an artist application 1030 installed on the artist user device 1006(E), such as data analytics and management (e.g., listener data, consumer data, etc.), marketing, regulatory obligations, cash flow management, publishing, customer relationship management (CRM), social media, event coordination, industry communications, digital media content ingestion and storage, and so forth. In some cases, the users 1016 can have graduated access to the services, which can be based on a user type (e.g., artist, group member, personal manager, business manager, attorney, agent, etc.), risk tolerance, artist verification status, listener and/or viewer analytics (e.g., number of streams in a month), and so on. In some cases, multiple users 1016 may have access to a single user account via respective end user devices 1006, with the various users having different access privileges to services provided by the artist management service. In various scenarios, an artist can designate functions provided by the artist management service to different members of the team associated with the artist, thus granting the respective team members access to services suited to the skills of the individual team members.

In some cases, the artist application 1030 and the listener application 1028 may be distinct applications having differing user experiences and verification processes for access, such as illustrated in the environment 1000. For instance, the media content platform 1014 may request additional verification, such as a link to an artist website, a sample of an artist's work, a verified credential supplied by a third party, etc. to grant access to the artist application 1030 in addition to information requested to access the listener application 1028. Further, the artist application 1030 may provide the artist management services described herein, without the subscription-based digital media streaming services described herein, and vice versa. However, examples are also considered in which functionality provided by the artist application 1030 and the listener application 1028 partially or fully overlap, and/or where verification processes for access are substantially similar.

In at least some examples, the media content platform 1014 enables interaction between the users 1016 utilizing the listener application 1028 installed on the content consumption devices 1006(D), and the users 1016 utilizing the artist application 1030 installed on the artist user devices 1006(E). For example, the media content platform 1014 may provide interconnectivity between the subscription-based digital media streaming service and the artist management service. Functionality provided by the media content platform 1014 in such instances may include a communication channel between one or more of the users 1016 (e.g., a listener, fan, music supervisor, publisher, etc.) utilizing the listener application 1028 and another user (e.g., an artist) of the users 1016 utilizing the artist application 1030. The communication channel may include, for instance, a messaging platform (also referred to as a “messaging application” herein), a live streaming platform, a videoconferencing or teleconferencing platform, and/or a combination of these.

Additionally, in some cases, the media content platform 1014 may facilitate a resource transfer between the listener application 1028 and the artist application 1030. In an example, the media content platform 1014 may direct a resource, such as a portion of a subscription fee paid by one of the users 1016 designated as a listener, to one or more of the users 1016 designated as artists based on a number of instances that the listening user consumed (e.g., streamed, downloaded, etc.) content created by respective ones of the artist users. Alternatively or additionally, the media content platform 1014 may direct a resource, such as funds, from an account associated with a listening user to an account associated with an artist user (or vice versa), in accordance with transfers between accounts as described herein. The media content platform 1014 may facilitate resource transfers in examples such as merchandise purchases, event ticket purchases, “tipping” an artist, payments for royalties or other fees, and so forth.

In some examples, the media content platform 1014 enables interaction between individual ones of the users 1016 with one another via the listener application 1028 installed on the content consumption device 1006(D) and other of the content consumption devices 1006(D) via a communication channel as described above. In an example, the listener application 1028 may provide functionality via a communication channel for a user to stream an individual digital media item, a playlist, or the like to an audience comprising other ones of the content consumption devices 1006(D). Alternatively or additionally, the communication channel may facilitate sharing of individual digital media items, playlists, user and/or artist profiles, and the like between the users 1016 via messages, uniform resource locators (URLs), quick response (QR) codes, and so forth.

In some cases, the media content platform 1014 enables interaction between individual ones of the users 1016 with one another via the artist application 1030 installed on the artist user device 1006(E) and other of the artist devices 1006(E) via a communication channel as described above. In some instances, the media content platform 1014 may provide recommendations for a particular user indicating which of the other users 1016 to communicate with. Such a recommendation may be based on a similarity (or dissimilarity) of content created by two or more of the users 1016, an overlap (or lack thereof) of audience members of the users 1016, a geographic location of the users 1016, a coinciding event location of the users 1016, and so forth. In some examples, a user may input parameters for a desired connection via the artist application 1030, and the media content platform 1014 may filter which of the users 1016 to surface for recommendations to the user based on the input parameters. Alternatively or additionally, the media content platform 1014 may implement one or more machine learning models to filter which of the users 1016 to surface for recommendations to the user. The recommendations provided by the media content platform 1014 may be data driven and thus increase relevance of communications presented to the users 1016 and reduce unsolicited communications that ray be received by the users 1016.

The media content platform 1014 may interact with the server(s) 1008 associated with the third-party service providers to, for instance, ingest digital media items, report digital media consumption data, pay royalties, and the like. In some examples, the server(s) 1008 may be accessible by the media content platform 1014 via one or more APIs 1018 or other integrations. In some cases, the third-party service provider may be a digital media content provider (e.g., a record label, a performance rights organization (PRO), an independent artist, etc.). In such cases, the media content platform 1014 may receive digital media content items from the server(s) 1008, along with metadata associated with the digital media content items. The metadata, in some instances, may indicate individual contributors to a digital media content item such as an artist or artists, a songwriter (e.g., a composer, lyricist, author, etc.), a producer (which may further include a co-producer, a mastering engineer, a mixing engineer, a recording engineer, an arranger, a programmer, etc.), a musician (e.g., instrumentalist, vocalist, etc.), a visual artist, and so forth, with an indication of the role of the individual contributor. Alternatively or additionally, the metadata may indicate information such as release date, track title, track duration, clean or explicit version, jurisdiction information, and the like. The media content platform 1014 may use the metadata to associate the digital media content item as being created by a particular user, to provide search results to the users 1016, to generate playlists, and so forth. Further, the media content platform 1014 may provide payments (e.g., royalties) to the third-party service provider based on a number of streams and/or downloads of individual digital media content items by the users 1016 via the listener application 1028.

Techniques described herein are directed to services provided via a distributed system of end user devices 1006 that are in communication with server(s) 1002 of the service provider. That is, techniques described herein are directed to a specific implementation—or, a practical application—of utilizing a distributed system of end user devices 1006 that are in communication with server(s) 1002 of the merchant platform 1010, the P2P platform 1012, and/or the media content platform 1014 to perform a variety of services, as described above. The unconventional configuration of the distributed system described herein enables the server(s) 1002 that are remotely-located from end-users (e.g., users 1016) to intelligently offer services based on aggregated data associated with the end-users, such as the users 1016 (e.g., data associated with multiple, different merchants and/or multiple, different buyers; data associated with multiple different listeners and/or multiple different artists, etc.), in some examples, in near-real time. Accordingly, techniques described herein are directed to a particular arrangement of elements that offer technical improvements over conventional techniques for performing payment processing services, P2P payment services, media content services, and the like. For small business owners and artists in particular, the business environment is typically fragmented and relies on unrelated tools and programs, making it difficult for an owner or an artist to manually consolidate and view such data. The techniques described herein constantly or periodically monitor disparate and distinct user accounts, e.g., accounts within the control of the merchant platform 1010, the P2P platform 1012, and/or the media content platform 1014, and those outside of the control of these service providers, to track the standing (payables, receivables, payroll, invoices, appointments, capital, balances, collaborations, etc.) of the users 1016. The techniques herein provide a consolidated view of a user's cash flow, predict needs, preemptively offer recommendations or services, such as capital, coupons, etc., and/or enable money movement between disparate accounts (merchant's, another merchant's, or even payment service's) in a frictionless and transparent manner.

As described herein, artificial intelligence, machine learning, and the like can be used to dynamically make determinations, recommendations, and the like, thereby adding intelligence and context-awareness to an otherwise one-size-fits-all scheme for providing payment processing services, P2P payment services, media content services, and/or additional or alternative services described herein. In some implementations, the distributed system is capable of applying the intelligence derived from an existing user base to a new user, thereby making the onboarding experience for the new user personalized and frictionless when compared to traditional onboarding methods. Further, models or algorithms that are used to implement techniques described herein may be retrained over time to improve outcomes for subsequent scenarios based on outcomes of previous scenarios. Thus, techniques described herein improve existing technological processes.

As described above, various graphical user interfaces (GUIs) can be presented to facilitate techniques described herein. Some of the techniques described herein are directed to user interface features presented via GUIs to improve interaction between users 1016 and end user devices 1006. Furthermore, such features are changed dynamically based on the profiles of the users involved interacting with the GUIs. As such, techniques described herein are directed to improvements to computing systems.

The merchant platform 1010, the P2P platform 1012, and/or the media content platform 1014 are capable of providing additional or alternative services, and the services described above are offered as a sampling of services. In at least one example, the merchant platform 1010, the P2P platform 1012, and/or the media content platform 1014 can exchange data with the server(s) 1008 associated with third-party service providers. Such third-party service providers can provide information that enables the merchant platform 1010, the P2P platform 1012, and/or the media content platform 1014 to provide services, such as those described above. In additional or alternative examples, such third-party service providers can access services of the merchant platform 1010, the P2P platform 1012, and/or the media content platform 1014. That is, in some examples, the third-party service providers can be subscribers, or otherwise access, services of the merchant platform 1010, the P2P platform 1012, and/or the media content platform 1014.

FIG. 11 illustrates an example environment 1100 including a service provider system 1102 which may be associated with the server(s) 1002 of FIG. 10. The environment 1100 may also include a user device 1104, which may correspond to any of the end user devices 1006 described in relation to FIG. 10. In examples, the service provider system 1102 may include one or a combination of the merchant platform 1010, the P2P platform 1012, or the media content platform 1014, as well as one or more data store(s) 1106 that can store assets in an asset storage 1108, as well as data in user account(s) 1110. In some examples, the environment 1100 may also include a public blockchain 1114, one or more nodes 1116, and/or a hardware wallet 1118. The service provider system 1102, the user device 1104, public blockchain 1114, the node(s) 1116, and the hardware wallet 1118 may be connected and able to communicate via one or more networks 1120, which may have the same or similar functionality described in relation to the network 1004 of FIG. 10.

In some examples, user account(s) 1110 can include merchant account(s), customer account(s), media content subscriber account(s), artist account(s), and so forth. In at least one example, the asset storage 1108 can be used to record whether individual assets are registered to a user account 1110. For example, the asset storage 1108 can include asset wallet(s) 1122 for storing records of assets owned by the service provider system 1102, such as cryptocurrency, securities, NFTs, or the like, and communicating with one or more asset networks, such as cryptocurrency networks, NFT networks, securities networks, or the like. In some examples, the asset network can be a first-party network or a third-party network, such as a cryptocurrency exchange or the stock market. In examples where the asset network is a third-party network, the server(s) 1008 of FIG. 10 can be associated therewith.

The asset wallet 1122 can be associated with one or more addresses and can vary addresses used to acquire assets (e.g., from the asset network(s)) so that its holdings are represented under a variety of addresses on the asset network. In examples where the service provider system 1102 has holdings of cryptocurrency (e.g., in the asset wallet 1122), a user can acquire cryptocurrency directly from the service provider system 1102. In some examples, the service provider system 1102 can include logic for buying and selling cryptocurrency to maintain a desired level of cryptocurrency. In some examples, the desired level can be based on a volume of transactions over a period of time, balances of collective cryptocurrency ledgers, exchange rates, or trends in changing of exchange rates such that the cryptocurrency is trending towards gaining or losing value with respect to the fiat currency. In some scenarios, the buying and selling of cryptocurrency, and therefore the associated updating of the public ledger of an asset network can be separate from a customer-merchant transaction or a peer-to-peer transaction, and therefore not necessarily time-sensitive. This can enable batching transactions to reduce computational resources and/or costs. The service provider system 1102 can provide the same or similar functionality for securities or other assets.

The asset storage 1108 may contain ledgers that store records of assignments of assets to users 1016. Specifically, the asset storage 1108 may include asset ledger 1124, fiat currency ledger 1126, and/or other ledger(s) 1128, which can be used to record transfers of assets between users 1016 and/or one or more third-parties (e.g., merchant network(s), payment card network(s), ACH network(s), equities network(s), the asset network, securities networks, etc.). In doing so, the asset storage 1108 can maintain a running balance of assets managed by the service provider system 1102. The ledger(s) of the asset storage 1108 can further indicate some of the running balance for individual ledger(s) stored in the asset storage 1108 are assigned or registered to one or more user account(s) 1110.

In at least one example, the asset storage 1108 can include transaction logs 1130, which can include, as transaction data, records of past transactions involving the service provider system 1102 and/or the user account 1110. In some examples, the data store(s) 1106 can store a private blockchain 1132. A private blockchain 1132 can function to record sender addresses, recipient addresses, public keys, values of cryptocurrency transferred, and/or can be used to verify ownership of cryptocurrency tokens to be transferred. In some examples, the service provider system 1102 can record transactions involving cryptocurrency until the number of transactions has exceeded a determined limit (e.g., number of transactions, storage space allocation, etc.). Based at least in part on determining that the limit has been reached, the service provider system 1102 can publish the transactions in the private blockchain 1132 to the public blockchain 1114 (e.g., associated with the asset network), where miners can verify the transactions and record the transactions to blocks on the public blockchain 1114. In at least one example, the service provider system 1102 can participate as miner(s) at least for transactions to which the respective platform is a party to, to be posted to the public blockchain 1114.

In some cases, the data store(s) 1106 can store and/or manage multiple user accounts, an example of which is described in relation to the user account 1110. In at least one example, the user account 1110 can include user account data 1134, which can include, but is not limited to, data associated with user identifying information (e.g., name, phone number, address, artist or band name, verified credentials, etc.), user identifier(s) (e.g., alphanumeric identifiers, etc.), user preferences (e.g., learned or user-specified), purchase history data (e.g., identifying one or more items purchased (and respective item information), subscription tier information, etc.), linked payment sources (e.g., bank account(s), stored balance(s), etc.), payment instruments used to purchase one or more items, returns associated with one or more orders, statuses of one or more orders (e.g., preparing, packaging, in transit, delivered, etc.), etc.), appointments data (e.g., previous appointments, upcoming (scheduled) appointments, timing of appointments, lengths of appointments, etc.), payroll data (e.g., employers, payroll frequency, payroll amounts, etc.), reservations data (e.g., previous reservations, upcoming (scheduled) reservations, reservation duration, interactions associated with such reservations, etc.), inventory data, user service data, loyalty data (e.g., loyalty account numbers, rewards redeemed, rewards available, etc.), risk indicator(s) (e.g., level(s) of risk), etc.

In at least one example, the user account data 1134 can include account activity 1136 and user wallet key(s) 1138. In some examples, the user wallet key(s) 1138 can include a public-private key-pair and a respective address associated with the asset network or other asset networks. In some examples, the user wallet key(s) 1138 may include one or more key pairs, which can be unique to the asset network or other asset networks.

In addition to the user account data 1134, the user account 1110 can include ledger(s) for account(s) managed by the service provider system 1102, for the user. For example, the user account 1110 may include an asset ledger 1124, a fiat currency ledger 1126, and/or one or more other ledgers 1128. The ledger(s) can indicate that a corresponding user utilizes the service provider system 1102 to manage corresponding accounts (e.g., a cryptocurrency account, a securities account, a fiat currency account, an artist account, etc.). It should be noted that in some examples, the ledger(s) can be logical ledger(s) and the data can be represented in a single database. In some examples, individual ones of the ledger(s), or portions thereof, can be maintained by the service provider system 1102.

In some examples, the asset ledger 1124 can store a balance for each of one or more cryptocurrencies (e.g., Bitcoin, Ethereum, Litecoin, etc.) registered to the user account 1110. In at least one example, the asset ledger 1124 can further record transactions of cryptocurrency assets associated with the user account 1110. For example, the user account 1110 can receive cryptocurrency from the asset network using the user wallet key(s) 1138. In some examples, the user wallet key(s) 1138 may be generated for the user upon request. User wallet key(s) 1138 can be requested by the user in order to send, exchange, or otherwise control the balance of cryptocurrency held by the service provider system 1102 (e.g., in the asset wallet 1122) and registered to the user. In some examples, the user wallet key(s) 1138 may not be generated until a user account requires such. This on-the-fly wallet key generation provides enhanced security features for users, reducing the number of access points to a user account's balance and, therefore, limiting exposure to external threats.

Each account ledger can reflect a positive balance when funds are added to the corresponding account. An account can be funded by transferring currency in the form associated with the account from an external account (e.g., transferring a value of cryptocurrency to the service provider system 1102 and the value is credited as a balance in asset ledger 1124), by purchasing currency in the form associated with the account using currency in a different form (e.g., buying a value of cryptocurrency from the service provider system 1102 using a value of fiat currency reflected in fiat currency ledger 1126, and crediting the value of cryptocurrency in asset ledger 1124), or by conducting a transaction with another user (customer or merchant) of the service provider system 1102 wherein the account receives incoming currency (which can be in the form associated with the account or a different form, in which the incoming currency may be converted to the form associated with the account).

With specific reference to funding a cryptocurrency account, a user may have a balance of cryptocurrency stored in another cryptocurrency wallet. In some examples, the other cryptocurrency wallet can be associated with a third-party unrelated to the service provider system 1102 (i.e., an external account). Such a transaction can request that the user to transfer an amount of the cryptocurrency in a message signed by user's private key to an address provided by the service provider system 1102. In at least one example, the transaction can be sent to miners to bundle the transaction into a block of transactions and to verify the authenticity of the transactions in the block. Once a miner has verified the block, the block is written to the public blockchain 1114 where the service provider system 1102 can then verify that the transaction has been confirmed and can credit the user's asset ledger 1124 with the transferred amount. When an account is funded by transferring cryptocurrency from a third-party cryptocurrency wallet, an update can be made to the public blockchain 1114. In some cases, this update of the public blockchain 1114 need not take place at a time-critical moment, such as when a transaction is being processed by a merchant in store or online.

In some examples, a user can purchase cryptocurrency to fund their cryptocurrency account. In some examples, the user can purchase cryptocurrency through services offered by the service provider system 1102. As described above, in some examples, the service provider system 1102 can acquire cryptocurrency from a third-party source. In examples where the service provider system 1102 has its own cryptocurrency assets, cryptocurrency transferred in a transaction (e.g., data with address provided for receipt of transaction and a balance of cryptocurrency transferred in the transaction) can be stored in an asset wallet 1122 associated with the service provider system 1102. In at least one example, the service provider system 1102 can credit the asset ledger 1124 of the user. Additionally, while the service provider system 1102 recognizes that the user retains the value of the transferred cryptocurrency through crediting the asset ledger 1124, an inspection of the blockchain will show the cryptocurrency as having been transferred to the service provider system 1102. In some examples, the asset wallet 1122 can be associated with many different addresses. In such examples, an inspection of the blockchain may not necessarily associate all cryptocurrency stored in asset wallet 1122 as belonging to the same entity. The presence of a private ledger used for real-time transactions and maintained by the service provider system 1102, combined with updates to the public ledger at other times, allows for extremely fast transactions using cryptocurrency to be achieved. In some examples, the “private ledger” can refer to the asset ledger 1124, which in some examples, can utilize the private blockchain 1132, as described herein. The “public ledger” can correspond to the public blockchain 1114 associated with the asset network.

In at least one example, an asset ledger 1124, fiat currency ledger 1126, or the like associated with the user account 1110 can be credited when conducting a transaction with another user (customer or merchant) wherein the user receives incoming currency. In some examples, a user can receive cryptocurrency in the form of payment for a transaction with another user. In at least one example, such cryptocurrency can be used to fund the asset ledger 1124. In some examples, a user can receive fiat currency or another currency in the form of payment for a transaction with another user. In at least one example, at least a portion of such funds can be converted into cryptocurrency by the service provider system 1102 and used to fund the asset ledger 1124 of the user.

In examples, a user can also have an account in U.S. dollars, which can be tracked, for example, via the fiat currency ledger 1126. Such an account can be funded by transferring money from a bank account at a third-party bank to an account maintained by the service provider system 1102 as is conventionally known. In some examples, a user can receive fiat currency in the form of payment for a transaction with another user. In such examples, at least a portion of such funds can be used to fund the fiat currency ledger 1126.

In some examples, a user can have one or more internal payment cards registered with the service provider system 1102. Internal payment cards can be linked to one or more of the accounts associated with the user account 1110. In some embodiments, options with respect to internal payment cards can be adjusted and managed using an application (e.g., the payment application 1026, a wallet application 1112, etc.).

In at least one example, the user account 1110 can be associated with the asset wallet accessible via a wallet application 1112 of the user device 1104, or a stored balance for use in payment transactions, peer-to-peer transactions, payroll payments, etc. In at least one example, the asset wallet 1122 can store data indicating an address provided for receipt of a cryptocurrency transaction. In at least one example, the balance of the asset wallet 1122 can be based at least in part on a balance of the asset ledger 1124. In at least one example, funds availed via the asset wallet 1122 can be stored in the asset wallet 1122. Funds availed via the asset wallet 1122 can be tracked via the asset ledger 1124. The asset wallet 1122, however, can be associated with additional cryptocurrency funds.

In at least one example, when the service provider system 1102 includes a private blockchain 1132 for recording and validating cryptocurrency transactions, the asset wallet 1122 can be used instead of, or in addition to, the asset ledger 1124. For example, a merchant can provide the address of the asset wallet 1122 for receiving payments. In an example where a customer is paying in cryptocurrency and the customer has their own cryptocurrency wallet account associated with the service provider system 1102, the customer can send a message signed by its private key including its wallet address (i.e., of the customer) and identifying the cryptocurrency and value to be transferred to the merchant's asset wallet 1122. The service provider system 1102 can complete the transaction by reducing the cryptocurrency balance in the customer's cryptocurrency wallet and increasing the cryptocurrency balance in the merchant's asset wallet 1122. In addition to recording the transaction in the respective cryptocurrency wallets, the transaction can be recorded in the private blockchain 1132 and the transaction can be confirmed. A user can perform a similar transaction with cryptocurrency in a peer-to-peer transaction as described above.

While the asset ledger 1124 and/or asset wallet 1122 are each described above with reference to cryptocurrency, the asset ledger 1124 and/or asset wallet 1122 can alternatively be used in association with securities. In some examples, different ledgers and/or wallets can be used for different types of assets. That is, in some examples, a user can have multiple asset ledgers and/or asset wallets for tracking cryptocurrency, securities, or the like.

It should be noted that user(s) having accounts managed by the service provider system 1102 is an aspect of the technology disclosed that enables technical advantages of increased processing speed and improved security.

The description of the environment 1100 above generally relates to a centralized service provider system 1102 that at least partially facilitates storing and managing assets in the data store 1106. However, the environment 1100 may also facilitate decentralized storage and management of assets alternatively or in addition to centralized storage and management as described above. For instance, the environment 1100 may include a decentralized platform implemented using a plurality of nodes (e.g., web nodes), an example of which is illustrated as node 1116. The node 1116 is representative of a computer or other device tasked with validating transactions and/or maintaining a copy of a blockchain ledger, such as a ledger associated with the public blockchain 1114. The decentralized platform may be implemented via the environment 1100 through use of decentralized identifiers and verifiable credentials that are stored and managed by user devices 1104. A decentralized identifier is configured as a self-owned identifier that supports decentralized authentication and routing. A self-owned identifier in a blockchain network is a unique identifier that is owned and controlled by an individual entity on the blockchain, as contrasted with an entity controlled by a centralized authority (e.g., the service provider system 1102). The decentralized identity referenced by a decentralized identifier gives an entity control over what data can be accessed, stored, modified, and so forth by other entities, such as the service provider system 1102.

The node 1116, as representative of one of a plurality of decentralized nodes (e.g., decentralized web nodes), supports data storage and relays that allows entities, service provider systems, individuals, organizations and so forth to send, store, and receive encrypted or public messages and data. The node 1116 is universally addressable and is “crawlable” using data addressing in relation to the decentralized identifiers. The node 1116 is also configured to support decentralized replication of data across the nodes that is consistent across multiple nodes over time through continued data communication between the nodes in the decentralized platform. The node 1116 is configurable to support secure encryption through use of a cryptographic key associated with an individual's decentralized identifier and support semantic discovery to discover different forms of published data.

Verifiable credentials are an open standard for digital credentials, and employ a data format for cryptographic presentation and verification of claims. A verifiable credential represents an indication of trust of a piece of information related to an entity. For example, a verifiable credential indicates that the issuer of the verifiable credential trusts the holder of the verifiable credential; the holder trusts a verifier of the verifiable credential; and that the verifier trusts the issuer. Verifiable credentials may be issued by anyone, about anything, and can be presented to and verified by everyone granted access to the verifiable credential. Accordingly, a user of the user device 1104 may be an issuer, a holder, and/or a verifier, as can the service provider system 1102.

In some examples, the user device 1104 may implement a wallet application 1112 configured to manage decentralized identifiers and/or verifiable credentials. For instance, the wallet application 1112 may provide a user interface for implementation of access controls to various data associated with the decentralized identifier by the service provider system 1102, to other user devices, and so forth. Additionally, the wallet application 1112 may be configured to provide functionality for resource transfers (e.g., cryptocurrency, fiat currency, etc.) with the service provider system 1102, other user devices, and the like, based on techniques described herein.

In some examples, the hardware wallet 1118 may store cryptocurrency assets in combination with the wallet application 1112 and the service provider system 1102. For instance, the hardware wallet 1118, the wallet application 1112, and the service provider system 1102 may each store a respective, different private key, where a transaction with the cryptocurrency assets is signed by at least two of the three private keys. The user interface provided by the wallet application 1112 may allow a user to request a transaction. The wallet application 1112 may then sign the transaction with the private key of the wallet application 1112, have either the hardware wallet 1118 or the service provider system 1102 use a second of the three private keys to sign the transaction, and then provide the transaction with two signatures to the public blockchain 1114 for processing.

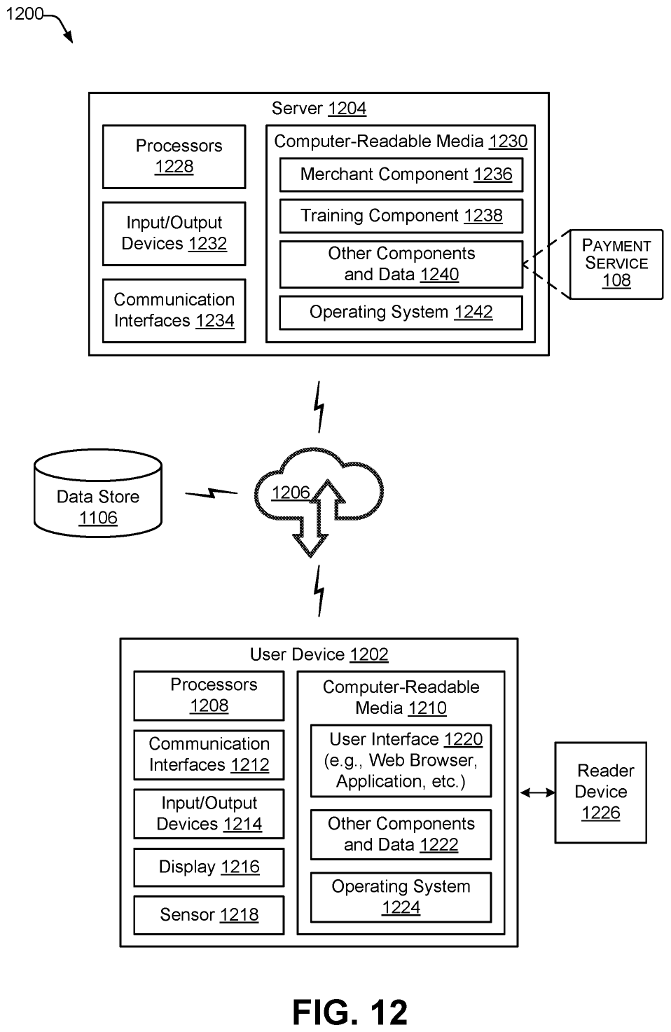

FIG. 12 depicts an illustrative block diagram illustrating a system 1200 for performing techniques described herein. The system 1200 includes a user device 1202, that communicates with server computing device(s) (e.g., server(s) 1204) via network(s) 1206 (e.g., the Internet, cable network(s), cellular network(s), cloud network(s), wireless network(s) (e.g., Wi-Fi) and wired network(s), as well as close-range communications such as Bluetooth®, Bluetooth® low energy (BLE), and the like). While a single user device 1202 is illustrated, in additional or alternate examples, the system 1200 can have multiple user devices, as described above with reference to FIG. 10.

In some examples, the server(s) 1204 may be the same as or similar to the server(s) 110 introduced in FIG. 1, and the server(s) 1204 may implement the payment service 108. Accordingly, the server(s) 1204 may include the transaction data processing component 134, the prompt generator component 136, the AI model(s) 138, the association component 140, the training component 142 (which may be the same as the training component 1238), and/or the fraud and compliance component 144, as described herein. Furthermore, the user device(s) 1202 may be the same as or similar to the user device 104 introduced in FIG. 1, the network(s) 1206 may be the same as or similar to the network(s) 112 introduced in FIG. 1, and/or the data store(s) 1106 may be the same as or similar to the data store(s) 114 introduced in FIG. 1. In addition, the user interface 1220 may be the a user interface of the payment application 106 introduced in FIG. 1.

In accordance with the examples described herein, the server(s) 1204 may process transaction data using AI. For instance, the server(s) 1204 may receive transaction data associated with users of a payment application, wherein the transaction data is received in a computer-readable format, and the server(s) 1204 may provide a prompt to a trained AI model, wherein the prompt includes a portion of the transaction data that represents a transaction associated with a user of the users. The server(s) 1204 may determine, based at least in part on the trained AI model processing the prompt, one or more attributes of the transaction, and cause information indicative of the one or more attributes to be presented via the payment application executing on a user device 1202 of the user, wherein the information is presented (i) in a graphical user interface (e.g., user interface 1220) and (ii) in a user-readable format instead of the computer-readable format.

In at least one example, the user device 1202 can be any suitable type of computing device, e.g., portable, semi-portable, semi-stationary, or stationary. Some examples of the user device 1202 can include, but are not limited to, a tablet computing device, a smart phone or mobile communication device, a laptop, a netbook or other portable computer or semi-portable computer, a desktop computing device, a terminal computing device or other semi-stationary or stationary computing device, a dedicated device, a wearable computing device or other body-mounted computing device, an augmented reality device, a virtual reality device, a speaker device, an automobile or other vehicle type, an Internet of Things (IoT) device, etc. That is, the user device 1202 can be any computing device capable of sending communications and performing the functions according to the techniques described herein. The user device 1202 can include devices, e.g., payment card readers, or components capable of accepting payments, as described below. The user device 1202 may be representative of, and provide functionality for, the user devices 1006 described in relation to FIG. 10.

In the illustrated example, the user device 1202 includes one or more processors 1208, one or more computer-readable media 1210, one or more communication interface(s) 1212, one or more input/output (I/O) devices 1214, a display 1216, sensor(s) 1218, one or more encoders 1246, and one or more decoders 1248.

In at least one example, each processor 1208 can itself comprise one or more processors or processing cores. For example, the processor(s) 1208 can be implemented as one or more microprocessors, microcomputers, microcontrollers, digital signal processors, central processing units, state machines, logic circuitries, and/or any devices that manipulate signals based on operational instructions. In some examples, the processor(s) 1208 can be one or more hardware processors and/or logic circuits of any suitable type specifically programmed or configured to execute the algorithms and processes described herein. The processor(s) 1208 can be configured to fetch and execute computer-readable processor-executable instructions stored in the computer-readable media 1210.

Depending on the configuration of the user device 1202, the computer-readable media 1210 can be an example of tangible non-transitory computer storage media and can include volatile and nonvolatile memory and/or removable and non-removable media implemented in any type of technology for storage of information such as computer-readable processor-executable instructions, data structures, program components or other data. The computer-readable media 1210 can include, but is not limited to, RAM, ROM, EEPROM, flash memory, solid-state storage, magnetic disk storage, optical storage, and/or other computer-readable media technology. Further, in some examples, the user device 1202 can access external storage, such as RAID storage systems, storage arrays, network attached storage, storage area networks, cloud storage, or any other medium that can be used to store information and that can be accessed by the processor(s) 1208 directly or through another computing device or network. Accordingly, the computer-readable media 1210 can be computer storage media able to store instructions, components or components that can be executed by the processor(s) 1208. Further, when mentioned, non-transitory computer-readable media exclude media such as energy, carrier signals, electromagnetic waves, and signals per se.

The computer-readable media 1210 can be used to store and maintain any number of functional components that are executable by the processor(s) 1208. In some implementations, these functional components comprise instructions or programs that are executable by the processor(s) 1208 and that, when executed, implement operational logic for performing the actions and services attributed above to the user device 1202. Functional components stored in the computer-readable media 1210 can include a user interface 1220 to enable users to interact with the user device 1202, and thus the server(s) 1204 and/or other networked devices. In some examples, the user interface 1220 can be the user interface(s) 130, 200B, and/or 300. In at least one example, a user can interact with the user interface via touch input, spoken input, gesture, or any other type of input. The word “input” is also used to describe “contextual” input that may not be directly provided by the user via the user interface 1220. For example, user's interactions with the user interface 1220 are analyzed using, e.g., natural language processing techniques, user movement tracking techniques, eye tracking techniques, etc. to determine context or intent of the user, which may be treated in a manner similar to “direct” user input.

Depending on the type of the user device 1202, the computer-readable media 1210 can also optionally include other functional components and data, such as other components and data 1222, which can include programs, drivers, etc., and the data used or generated by the functional components. In addition, the computer-readable media 1210 can also store data, data structures and the like, that are used by the functional components. Further, the user device 1202 can include many other logical, programmatic and physical components, of which those described are merely examples that are related to the discussion herein.

In at least one example, the computer-readable media 1210 can include additional functional components, such as an operating system 1224 for controlling and managing various functions of the user device 1202 and for enabling user interactions.

The communication interface(s) 1212 can include one or more interfaces and hardware components for enabling communication with various other devices, such as over the network(s) 1206 or directly. For example, communication interface(s) 1212 can enable communication through one or more network(s) 1206, which can include, but are not limited to any type of network known in the art, such as a local area network or a wide area network, such as the Internet, and can include a wireless network, such as a cellular network, a cloud network, a local wireless network, such as Wi-Fi and/or close-range wireless communications, such as Bluetooth®, BLE, NFC, RFID, a wired network, or any other such network, or any combination thereof. Accordingly, network(s) 1206 can include both wired and/or wireless communication technologies, including Bluetooth®, BLE, Wi-Fi and cellular communication technologies, as well as wired or fiber optic technologies. Components used for such communications can depend at least in part upon the type of network, the environment selected, or both. Protocols for communicating over such networks are well known and will not be discussed herein in detail.

Embodiments of the disclosure may be provided to users through a cloud computing infrastructure. Cloud computing refers to the provision of scalable computing resources as a service over a network, to enable convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

The user device 1202 can further include one or more input/output (I/O) devices 1214. The I/O devices 1214 can include speakers, a microphone, a camera, and various user controls (e.g., buttons, a joystick, a keyboard, a keypad, etc.), a haptic output device, and so forth. The I/O devices 1214 can also include attachments that leverage the accessories (audio-jack, USB-C, Bluetooth, etc.) to connect with the user device 1202.

In at least one example, user device 1202 can include a display 1216. Depending on the type of computing device(s) used as the user device 1202, the display 1216 can employ any suitable display technology. For example, the display 1216 can be a liquid crystal display, a plasma display, a light emitting diode display, an OLED (organic light-emitting diode) display, an electronic paper display, or any other suitable type of display able to present digital content thereon. In at least one example, the display 1216 can be an augmented reality display, a virtual reality display, or any other display able to present and/or project digital content. In some examples, the display 1216 can have a touch sensor associated with the display 1216 to provide a touchscreen display configured to receive touch inputs for enabling interaction with a graphic interface presented on the display 1216. Accordingly, implementations herein are not limited to any particular display technology. In some examples, the user device 1202 may not include the display 1216, and information can be presented by other means, such as aurally, haptically, etc.

In addition, the user device 1202 can include sensor(s) 1218. The sensor(s) 1218 can include a global positioning system (“GPS”) device able to indicate location information. Further, the sensor(s) 1218 can include, but are not limited to, an accelerometer, gyroscope, compass, proximity sensor, camera, microphone, and/or a switch.

In some examples, the GPS device can be used to identify a location of a user. In at least one example, the location of the user can be used by the merchant platform 1010, the P2P platform 1012, and/or the media content platform 1014, described above, to provide one or more services. That is, in some examples, the service provider can implement geofencing to provide particular services to users by the merchant platform 1010, the P2P platform 1012, and/or the media content platform 1014.

In examples, the user device 1202 includes a codec system, which may comprise an encoder 1246 and/or a decoder 1248. The encoder 1246 is configured to encode a data stream or signal from an analog signal (e.g., an analog audio signal, an analog video signal, etc.) to a digital signal for transmission or storage. The decoder 1248 is configured to convert the digital signal back to an analog signal, such as for playback or editing. In some cases, the encoder 1246 may be configured to encode the data stream or analog signal in an encrypted format, and the decoder 1248 may accordingly be configured to decrypt the digital signal as part of the decoding process (e.g., using a cryptographic key). Additionally, in some examples, the encoder 1246 may compress data to reduce transmission bandwidth and/or storage space for the digital signal. One example of a compression codec system is a lossless codec, in which the digital data stream is a compressed format of the original data stream, but retains the information present in the original data stream. Another example of a compression codec system is a lossy codec which reduces the quality of the digital data stream but can increase the compression of the data stream relative to lossless codec systems. The codec system comprising the encoder 1246 and/or the decoder 1248 may be specialized to accomplish various different objectives, such as to preserve motion, preserve color, minimize latency, maintain fidelity, minimize bit-rate, optimize for different output device types, maintain synchronization of audio and video (e.g., using a metadata synchronization data stream), and so on. Although not explicitly illustrated in the example system 1200, the server 1204 may include an encoder 1246 and/or a decoder 1248 as well.

Additionally, the user device 1202 can include various other components that are not shown, examples of which include removable storage, a power source, such as a battery and power control unit, a barcode scanner, a printer, a cash drawer, and so forth.

In addition, as described in relation to FIG. 10, the user device 1202 can include, be connectable to, or otherwise be coupled to a reader device 1226, for reading payment instruments and/or identifiers associated with payment objects. The reader device 1226 can include a read head for reading a magnetic strip of a payment card, and further can include encryption technology for encrypting the information read from the magnetic strip. Additionally or alternatively, the reader device 1226 can be an EMV payment reader, which in some examples, can be embedded in the user device 1202. Moreover, numerous other types of readers can be employed with the user device 1202 herein, depending on the type and configuration of the user device 1202.

The reader device 1226 may be a portable magnetic stripe card reader, optical scanner, smartcard (card with an embedded IC chip) reader (e.g., an EMV-compliant card reader or short-range communication-enabled reader), RFID reader, or the like, configured to detect and obtain data from various types of payment instruments. Accordingly, the reader device 1226 may include hardware implementation, such as slots, magnetic tracks, and rails with one or more sensors or electrical contacts to facilitate detection and acceptance of a payment instrument. That is, the reader device 1226 may include hardware implementations to enable the reader device 1226 to interact with a payment instrument via a swipe, a dip, or a tap to obtain payment data associated with a customer. Additionally or optionally, the reader device 1226 may also include a biometric sensor to receive and process biometric characteristics and process them as payment instruments, given that such biometric characteristics are registered with the payment service and connected to a financial account with a bank server. The reader device 1226 may include processing unit(s), computer-readable media, a reader chip, a transaction chip, a timer, a clock, a network interface, a power supply, and so on. That is, the reader device 1226 may include any of the computing components described herein with reference to the user device 1202 to implement the functionality provided by the reader device 1226.

In examples, the reader device 1226 includes a reader chip, which may perform functionality to control the power supply, among other functionality of the reader device 1226. The power supply may include one or more power supplies such as a physical connection to AC power or a battery. Power supply may include power conversion circuitry for converting AC power and generating a plurality of DC voltages for use by components of reader device 1226. When power supply includes a battery, the battery may be charged via a physical power connection, via inductive charging, or via any other suitable method.

The reader device 1226 may also include a transaction chip that may perform functionalities relating to processing of payment transactions, interfacing with payment instruments, cryptography, and other payment-specific functionality. That is, the transaction chip may access payment data associated with a payment instrument and may provide the payment data to a POS terminal, as described above. The payment data may include, but is not limited to, a name of the customer, an address of the customer, a type (e.g., credit, debit, etc.) of a payment instrument, a number associated with the payment instrument, a verification value (e.g., PIN Verification Key Indicator (PVKI), PIN Verification Value (PVV), Card Verification Value (CVV), Card Verification Code (CVC), etc.) associated with the payment instrument, an expiration data associated with the payment instrument, a primary account number (PAN) corresponding to the customer (which may or may not match the number associated with the payment instrument), restrictions on what types of charges/debts may be made, etc. The transaction chip may encrypt the payment data upon receiving the payment data.

It should be understood that in some examples, the reader chip may have its own processing unit(s) and computer-readable media and/or the transaction chip may have its own processing unit(s) and computer-readable media. In other examples, the functionalities of reader chip and transaction chip may be embodied in a single chip or a plurality of chips, each including any suitable combination of processing units and computer-readable media to collectively perform the functionalities of reader chip and transaction chip as described herein.

While the user device 1202, which can be a POS terminal, and the reader device 1226 are shown as separate devices, in additional or alternative examples, the user device 1202 and the reader device 1226 can be part of a single device, which may be a battery-operated device. In some examples, the reader device 1226 can have a display integrated therewith, which can be in addition to (or as an alternative of) the display 1216 associated with the user device 1202.

The server(s) 1204 can include one or more servers or other types of computing devices that can be embodied in any number of ways. For example, in the example of a server, the components, other functional components, and data can be implemented on a single server, a cluster of servers, a server farm or data center, a cloud-hosted computing service, a cloud-hosted storage service, and so forth, although other computer architectures can additionally or alternatively be used.

Further, while the figures illustrate the components and data of the server(s) 1204 as being present in a single location, these components and data can alternatively be distributed across different computing devices and different locations in any manner. Consequently, the functions can be implemented by one or more server computing devices, with the various functionality described above distributed in various ways across the different computing devices. Multiple server(s) 1204 can be located together or separately, and organized, for example, as virtual servers, server banks and/or server farms. The described functionality can be provided by the servers of a single merchant or enterprise, or can be provided by the servers and/or services of multiple different customers or enterprises.

In the illustrated example, the server(s) 1204 can include one or more processors 1228, one or more computer-readable media 1230, one or more I/O devices 1232, and one or more communication interfaces 1234. Each processor 1228 can be a single processing unit or a number of processing units, and can include single or multiple computing units or multiple processing cores. The processor(s) 1228 can be implemented as one or more microprocessors, microcomputers, microcontrollers, digital signal processors, central processing units, state machines, logic circuitries, and/or any devices that manipulate signals based on operational instructions. For example, the processor(s) 1228 can be one or more hardware processors and/or logic circuits of any suitable type specifically programmed or configured to execute the algorithms and processes described herein. The processor(s) 1228 can be configured to fetch and execute computer-readable instructions stored in the computer-readable media 1230, which can program the processor(s) 1228 to perform the functions described herein.

The computer-readable media 1230 can include volatile and nonvolatile memory and/or removable and non-removable media implemented in any type of technology for storage of information, such as computer-readable instructions, data structures, program components, or other data. Such computer-readable media 1230 can include, but is not limited to, RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the server(s) 1204, the computer-readable media 1230 can be a type of computer-readable storage media and/or can be a tangible non-transitory media to the extent that when mentioned, non-transitory computer-readable media exclude media such as energy, carrier signals, electromagnetic waves, and signals per se.

The computer-readable media 1230 can be used to store any number of functional components that are executable by the processor(s) 1228. In many implementations, these functional components comprise instructions or programs that are executable by the processors 1228 and that, when executed, specifically configure the one or more processors 1228 to perform the actions attributed above to the merchant platform 1010, the P2P platform 1012, and/or the media content platform 1014. Functional components stored in the computer-readable media 1230 can optionally include a merchant component 1236, a training component 1238 (e.g., the training component 142 introduced in FIG. 1), and one or more other components and data 1240, such as the transaction data processing component 134, the prompt generator component 136, the association component 140, and/or the fraud and compliance component 144, which were introduced in FIG. 1. The computer-readable media 1230 can additionally include an operating system 1242 for controlling and managing various functions of the server(s) 1204.

The merchant component 1236 can be configured to receive transaction data from POS systems. The merchant component 1236 can transmit requests (e.g., authorization, capture, settlement, etc.) to payment service server computing device(s) to facilitate POS transactions between merchants and customers. The merchant component 1236 can communicate the successes or failures of the POS transactions to the POS systems.

The training component 1238 can be configured to train models using machine-learning mechanisms, as well as retrain the models to improve outputs provided by the models based on feedback received over time. For example, a machine-learning mechanism can analyze training data to train a data model that generates an output, which can be a recommendation, a score, and/or another indication. Machine-learning mechanisms can include, but are not limited to supervised learning algorithms (e.g., artificial neural networks, Bayesian statistics, support vector machines, decision trees, classifiers, k-nearest neighbor, etc.), unsupervised learning algorithms (e.g., artificial neural networks, association rule learning, hierarchical clustering, cluster analysis, etc.), semi-supervised learning algorithms, deep learning algorithms, etc.), statistical models, etc. In at least one example, machine-trained data models can be stored in a datastore associated with the user device(s) 1202 and/or the server(s) 1204 for use at a time after the data models have been trained (e.g., at runtime).

The one or more other components and data 1240 can include the transaction data processing component 134, the prompt generator component 136, the association component 140, and/or the fraud and compliance component 144, the functionality of which is described, at least partially, above. Further, the one or more other components and data 1240 can include programs, drivers, etc., and the data used or generated by the functional components. Further, the server(s) 1204 can include many other logical, programmatic and physical components, of which those described above are merely examples that are related to the discussion herein.

The one or more “components” referenced herein may be implemented as more components or as fewer components, and functions described for the components may be redistributed depending on the details of the implementation. The term “component,” as used herein, refers broadly to software stored on non-transitory storage medium (e.g., volatile or non-volatile memory for a computing device), hardware, or firmware (or any combination thereof) components. Modules are typically functional such that they may generate useful data or other output using specified input(s). A component may or may not be self-contained. An application program (also called an “application”) may include one or more components, or a component may include one or more application programs that can be accessed over a network or downloaded as software onto a device (e.g., executable code causing the device to perform an action). An application program (also called an “application”) may include one or more components, or a component may include one or more application programs. In additional and/or alternative examples, the component(s) may be implemented as computer-readable instructions, various data structures, and so forth via at least one processing unit to configure the computing device(s) described herein to execute instructions and to perform operations as described herein.

In some examples, a component may include one or more application programming interfaces (APIs) to perform some or all of its functionality (e.g., operations). In at least one example, a software developer kit (SDK) can be provided by the service provider to allow third-party developers to include service provider functionality and/or avail service provider services in association with their own third-party applications. Additionally or alternatively, in some examples, the service provider can utilize a SDK to integrate third-party service provider functionality into its applications. That is, API(s) and/or SDK(s) can enable third-party developers to customize how their respective third-party applications interact with the service provider or vice versa.

The communication interface(s) 1234 can include one or more interfaces and hardware components for enabling communication with various other devices, such as over the network(s) 1206 or directly. For example, communication interface(s) 1234 can enable communication through one or more network(s) 1206, which can include, but are not limited to any type of network known in the art, as described herein.

The server(s) 1204 can further be equipped with various I/O devices 1232. Such I/O devices 1232 can include a display, various user interface controls (e.g., buttons, joystick, keyboard, mouse, touch screen, biometric or sensory input devices, etc.), audio speakers, connection ports and so forth.

In at least one example, the system 1200 can include a datastore 1244 that can be configured to store data that is accessible, manageable, and updatable. In some examples, the datastore 1244 can be integrated with the user device 1202 and/or the server(s) 1204. In other examples, as shown in FIG. 12, the datastore 1244 can be located remotely from the server(s) 1204 and can be accessible to the server(s) 1204. The datastore 1244 can comprise multiple databases and/or servers connected locally and/or remotely via the network(s) 1206. In at least one example, the datastore 1244 can store user profiles, which can include merchant profiles, customer profiles, artist profiles, and so on.

Merchant profiles can store, or otherwise be associated with, data associated with merchants. For instance, a merchant profile can store, or otherwise be associated with, information about a merchant (e.g., name of the merchant, geographic location of the merchant, operating hours of the merchant, employee information, etc.), a merchant category classification (MCC), item(s) offered for sale by the merchant, hardware (e.g., device type) used by the merchant, transaction data associated with the merchant (e.g., transactions conducted by the merchant, payment data associated with the transactions, items associated with the transactions, descriptions of items associated with the transactions, itemized and/or total spends of each of the transactions, parties to the transactions, dates, times, and/or locations associated with the transactions, etc.), loan information associated with the merchant (e.g., previous loans made to the merchant, previous defaults on said loans, etc.), risk information associated with the merchant (e.g., indications of risk, instances of fraud, chargebacks, etc.), appointments information (e.g., previous appointments, upcoming (scheduled) appointments, timing of appointments, lengths of appointments, etc.), payroll information (e.g., employees, payroll frequency, payroll amounts, etc.), employee information, reservations data (e.g., previous reservations, upcoming (scheduled) reservations, interactions associated with such reservations, etc.), inventory data, customer service data, etc. The merchant profile can securely store bank account information as provided by the merchant. Further, the merchant profile can store payment information associated with a payment instrument linked to a stored balance of the merchant, such as a stored balance maintained in a ledger by the service provider.

Customer profiles can store customer data including, but not limited to, customer information (e.g., name, phone number, address, banking information, etc.), customer preferences (e.g., learned or customer-specified), purchase history data (e.g., identifying one or more items purchased (and respective item information), payment instruments used to purchase one or more items, returns associated with one or more orders, statuses of one or more orders (e.g., preparing, packaging, in transit, delivered, etc.), etc.), appointments data (e.g., previous appointments, upcoming (scheduled) appointments, timing of appointments, lengths of appointments, etc.), payroll data (e.g., employers, payroll frequency, payroll amounts, etc.), reservations data (e.g., previous reservations, upcoming (scheduled) reservations, reservation duration, interactions associated with such reservations, etc.), inventory data, customer service data, media content consumption data (e.g., number of streams of media content and by which artists, direct artist payouts, playlists generated or “favorited,” durations of listening and/or watching individual media content items, actions performed while consuming media content (e.g., skips, repeats, volume changes, etc.), locations at which media content is consumed, devices used to consume media content, activities during which media content is consumed, etc.), etc.

Artist profiles can store data including, but not limited to, artist information (e.g., artist's performance or stage name, band name, artist's legal name, record label, phone number, address, social media handles, website address, banking information, etc.), artist preferences (e.g., learned or artist-specified), media content (and/or associated data) at least partially attributed to the artist (e.g., songs, videos, artists in a same genre or having shared listeners, etc.), event data (e.g., tour dates, appearance dates, appointments, etc.), financial data (e.g., advance data, recoupment data, royalty data, payouts data, etc.), payroll data (e.g., employees, contractors, venues, payroll frequency, etc.), listening data (e.g., number of streams on media content platform(s), listening trends, etc.), fan data (number of followers on media content platform(s), number of followers on social media platform(s), etc.), reservations data (e.g., venue reservations, studio recording reservations, previous reservations, upcoming (scheduled) reservations, reservation duration, interactions associated with such reservations, etc.), inventory data (e.g., merchandise inventory), customer service data, and so forth.

Furthermore, in at least one example, the datastore 1244 can store inventory database(s) and/or catalog database(s). As described above, an inventory can store data associated with a quantity of each item that a merchant has available to the merchant. Furthermore, a catalog can store data associated with items that a merchant has available for acquisition. The datastore 1244 can store additional or alternative types of data as described herein.

The phrases “in some examples,” “according to various examples,” “in the examples shown,” “in one example,” “in other examples,” “various examples,” “some examples,” and the like generally mean the particular feature, structure, or characteristic following the phrase is included in at least one example of the present invention, and may be included in more than one example of the present invention. In addition, such phrases do not necessarily refer to the same examples or to different examples.

If the specification states a component or feature “can,” “may,” “could,” or “might” be included or have a characteristic, that particular component or feature is not required to be included or have the characteristic.

Further, the aforementioned description is directed to devices and applications that are related to payment technology. However, it will be understood, that the technology can be extended to any device and application. Moreover, techniques described herein can be configured to operate irrespective of the kind of payment object reader, POS terminal, web applications, mobile applications, POS topologies, payment cards, computer networks, and environments.

Various figures included herein are flowcharts showing example methods involving techniques as described herein. The methods illustrated are described with reference to components described in the figures for convenience and ease of understanding. However, the methods illustrated are not limited to being performed using components described in the figures and such components are not limited to performing the methods illustrated herein.

Furthermore, the methods described above are illustrated as collections of blocks in logical flow graphs, which represent sequences of operations that can be implemented in hardware, software, or a combination thereof. In the context of software, the blocks represent computer-executable instructions stored on one or more computer-readable storage media that, when executed by processor(s), perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes. In some embodiments, one or more blocks of the process can be omitted entirely. Moreover, the methods can be combined in whole or in part with each other or with other methods.

What is claimed is:

1. A computer-implemented method comprising:
receiving, by a payment service computing platform, transaction data associated with users of a payment application provided by the payment service computing platform, wherein the transaction data is received in a computer-readable format;
providing, by the payment service computing platform, a prompt to a trained artificial intelligence (AI) model, wherein the prompt includes a portion of the transaction data that represents a transaction associated with a user of the users;
determining, by the payment service computing platform and based on the trained AI model processing the prompt, an entity, other than the user, associated with the transaction and a type of the transaction; and
causing, by the payment service computing platform, information indicative of the entity and the type of the transaction to be presented via the payment application executing on a user device of the user, wherein the information is presented (i) in a graphical user interface associated with an activity feed, a statement, or a receipt and (ii) in a user-readable format instead of the computer-readable format.

2. The computer-implemented method of claim 1, wherein:
the transaction data comprises at least one of:
automated clearing house (ACH) transaction data that represents ACH transactions associated with the users; or
card transaction data that represents card transactions associated with the users;
the computer-readable format comprises at least one of:
a first computer-readable format associated with the ACH transaction data; or
a second computer-readable format associated with the card transaction data;
the first computer-readable format is different than the second computer-readable format; and
the trained AI model is configured to process prompts that include the ACH transaction data in the first computer-readable format and prompts that include the card transaction data in the second computer-readable format.

3. The computer-implemented method of claim 1, further comprising generating, by the payment service computing platform, the prompt by including, in the prompt, requests for the trained AI model to:
determine the entity and the type of the transaction from the portion of the transaction data;
explain steps performed and/or reasoning for determining the entity and the type of the transaction from the portion of the transaction data; and
provide a computer-readable object as output.

4. The computer-implemented method of claim 1, further comprising:
receiving, by the payment service computing platform, a validation of the entity and the type of the transaction determined using the trained AI model are correct; and
determining, by the payment service computing platform and based on the validation, that the entity and the type of the transaction determined using the trained AI model are correct,
wherein the causing of the information to be presented via the payment application executing on the user device is based on the determining that the entity and the type of the transaction determined using the trained AI model are correct.

5. The computer-implemented method of claim 1, further comprising:
extracting, by the payment service computing platform and from the transaction data, a string of alphanumeric characters that represents the transaction; and
transforming, by the payment service computing platform, the string of alphanumeric characters into the portion of the transaction data,
wherein the portion of the transaction data is an embedding that comprises a string of numbers.

6. A system comprising:
one or more processors; and
memory storing computer-executable instructions that, when executed by the one or more processors, cause the one or more processors to perform operations comprising:
receiving transaction data associated with users of a payment application, wherein the transaction data is received in a computer-readable format;
providing a prompt to a trained artificial intelligence (AI) model, wherein the prompt includes a portion of the transaction data that represents a transaction associated with a user of the users;
determining, based at least in part on the trained AI model processing the prompt, one or more attributes of the transaction; and
causing information indicative of the one or more attributes to be presented via the payment application executing on a user device of the user, wherein the information is presented (i) in a graphical user interface and (ii) in a user-readable format instead of the computer-readable format.

7. The system of claim 6, wherein:
the computer-readable format comprises at least one of:
a first computer-readable format; or
a second computer-readable format different than the first computer-readable format; and
the trained AI model is configured to process prompts that include the transaction data in the first computer-readable format and prompts that include the transaction data in the second computer-readable format.

8. The system of claim 6, wherein the one or more attributes comprise an entity other than the user.

9. The system of claim 6, the operations further comprising generating the prompt by including, in the prompt, requests for the trained AI model to:
determine the one or more attributes from the portion of the transaction data; and
provide a computer-readable object as output.

10. The system of claim 9, wherein the computer-readable object comprises a JavaScript Object Notation (JSON) object.

11. The system of claim 6, the operations further comprising:
receiving a validation of the one or more attributes determined using the trained AI model are correct; and
determining, based at least in part on the validation, that the one or more attributes determined using the trained AI model are correct,
wherein the causing of the information to be presented via the payment application executing on the user device is based at least in part on the determining that the one or more attributes determined using the trained AI model are correct.

12. The system of claim 6, the operations further comprising at least one of:
storing, in a data store, an association between the portion of the transaction data and the one or more attributes; or
retraining the trained AI model based at least in part on the association.

13. The system of claim 6, the operations further comprising:
determining, by accessing a data store using the portion of the transaction data, that an association between the portion of the transaction data and the one or more attributes is not stored in the data store,
wherein the providing of the prompt to the trained AI model is based on the determining that the association is not stored in the data store.

14. The system of claim 6, the operations further comprising:
extracting, from the transaction data, a string of alphanumeric characters that represents the transaction; and
transforming the string of alphanumeric characters into the portion of the transaction data,
wherein the portion of the transaction data is an embedding that comprises a string of numbers.

15. The system of claim 6, wherein the one or more attributes comprise a type of the transaction.

16. A computer-implemented method comprising:
receiving, by a payment service computing platform, transaction data associated with users of a payment application, wherein the transaction data is received in a computer-readable format;
providing, by the payment service computing platform, a prompt to a trained artificial intelligence (AI) model, wherein the prompt includes a portion of the transaction data that represents a transaction associated with a user of the users;
determining, by the payment service computing platform and based at least in part on the trained AI model processing the prompt, one or more attributes of the transaction; and
causing, by the payment service computing platform, information indicative of the one or more attributes to be presented via the payment application executing on a user device of the user, wherein the information is presented (i) in a graphical user interface and (ii) in a user-readable format instead of the computer-readable format.

17. The computer-implemented method of claim 16, further comprising:
providing, by the payment service computing platform, the portion of the transaction data as input to a second trained AI model;
determining, by the payment service computing platform and based on the second trained AI model processing the portion of the transaction data, that the transaction is potentially fraudulent; and
causing, by the payment service computing platform, an alert to be presented via a display of a second user device of an authorized user to review the transaction for fraud.

18. The computer-implemented method of claim 16, further comprising:
providing, by the payment service computing platform, the portion of the transaction data as input to a second trained AI model;
determining, by the payment service computing platform and based on the second trained AI model processing the portion of the transaction data, that the transaction is noncompliant with terms of use of the payment application; and
causing, by the payment service computing platform, an alert to be presented via a display of a second user device of an authorized user to review the transaction for noncompliance with the terms of use.

19. The computer-implemented method of claim 16, further comprising generating the prompt by including in the prompt an example prompt and a correct AI-generated answer to the example prompt.

20. The computer-implemented method of claim 16, wherein the transaction data comprises at least one of:
automated clearing house (ACH) transaction data that represents ACH transactions associated with the users; or
card transaction data that represents card transactions associated with the users.
